(19) United States
(12) Patent Application Publication
(10) Pub. No.: US 2024/0124645 A1
(43) Pub. Date: Apr. 18, 2024

(54) COMPOSITION FOR REVERSIBLE POLYMERIZATION OF THIOESTER AND METHODS THEREOF

(71) Applicant: THE REGENTS OF THE UNIVERSITY OF COLORADO, A BODY CORPORATE, Delaware, DE (US)

(72) Inventors: Christopher N. Bowman, Boulder, CO (US); Brady T. Worrell, Englewood, CO (US); Juan J. Hernandez, Longmont, CO (US); Matthew K. McBride, Boulder, CO (US); Sijia Huang, Dublin, CA (US); Maciej Podgorski, Boulder, CO (US)

(21) Appl. No.: 18/267,348

(22) PCT Filed: Dec. 17, 2021
(86) PCT No.: PCT/US2021/064150

§ 371 Date: Jun. 14, 2023

Related U.S. Application Data
(60) Provisional application No. 63/127,908, filed on Dec. 18, 2020.

(51) Int. Cl. C08G 63/688; B33Y 70/00; C08G 63/78; C08J 3/28

(52) U.S. Cl. CPC C08G 63/688; B33Y 70/00; C08G 63/78; C08J 3/28

(57) ABSTRACT

Described herein is a composition for producing a thiol-ene covalent adaptable network (CAN) polymer. The composition includes a first monomer including at least one thiol group; and a second monomer including at least one anhydride functional group and at least one alkene functional group. Also described herein are a polymer produced from the composition, a method of producing the polymer using the composition, a method of fabricating a polymer article using the composition, as well as a method of degrading the polymer.

### CROSS-REFERENCE TO RELATED APPLICATIONS

The present application claims priority under 35 U.S.C. § 119(e) to U.S. Provisional Patent Application No. 63/127,908, filed Dec. 18, 2020, which is incorporated herein by reference in its entirety.

### STATEMENT REGARDING FEDERALLY SPONSORED RESEARCH

This invention was made with government support under DMR 1420739 and DMR 1809841 awarded by the National Science Foundation. The government has certain rights in the invention.

### BACKGROUND

Objects fabricated using conventional fabrication methods such as polymer casting and 3D printing either cannot be reshaped easily or can be reshaped but cannot be fixed to a permanent shape. Furthermore, polymer wastes are a significant issue facing the world.

There is a need for fabrication method that allows the shapes of fabricated polymer objects to be adjusted before the shapes are fixed to a permanent state. There is also a need for method to degrade fabricated polymer objects and recycle components from the polymer objects. The present invention addresses these needs.

### SUMMARY

In some aspects, the instant invention is directed to a composition for producing a polymer, such as a composition for 3D printing or casting a thiol-ene covalent adaptable network (CAN) polymer article. In some embodiments, the composition includes a first monomer having at least one thiol group, and a second monomer having at least one anhydride functional group and at least one alkene functional group.

In some aspects, the instant invention is directed to polymer or an object fabricated therefrom, such as a thiol-ene covalent adaptable network (CAN) polymer. In some embodiments, the polymer includes a first repeating unit and a second repeating unit. In some embodiments, the first repeating unit and the second repeating unit are linked through a reversible thioester group formed by a thiol group from the first repeating unit and an anhydride functional group from the second repeating unit, as well as a thioether group from by a thiol group from the first repeating unit and an alkene functional group from the second repeating unit.

In some aspects, the instant invention is directed to a method of producing a polymer, such as a thiol-ene covalent adaptable network (CAN) polymer. In some embodiments, the method includes providing a composition including a first monomer having at least one thiol group, and a second monomer having at least one anhydride functional group and at least one alkene functional group; and curing the composition.

In some aspects, the instant invention is directed to a method of fabricating a polymer article, such as an article of a thiol-ene covalent adaptable network (CAN) polymer. In some embodiments, the method includes providing a composition including a first monomer having at least one thiol group, and a second monomer having at least one anhydride functional group and at least one alkene functional group; and curing the composition to a predetermined shape.

In some aspects, the instant invention is directed to a method of degrading a polymer, such as a method of degrading a polymer including a thioester network. The method includes subject the polymer to a solution including a free thiol compound and a catalyst.

### BRIEF DESCRIPTION OF THE DRAWINGS

The following detailed description of exemplary embodiments will be better understood when read in conjunction with the appended drawings. For the purpose of illustrating, non-limiting embodiments are shown in the drawings. It should be understood, however, that the instant specification is not limited to the precise arrangements and instrumentalities of the embodiments shown in the drawings.

FIG. 1 depicts the products of 3D printing and 3D reconfiguration in accordance with some embodiments.

FIGS. 2A-2B depict the methodology of thiol-ene CANS preparation in accordance with some embodiments. FIG. 2A is the chemical equations showing products of the thiol-anhydride reaction, thiol-ene polymerization and crosslinking and thioester-anhydride reversion above 80° C. FIG. 2B is a schematic depicting CAN formation and depolymerization. The functional groups shown in FIG. 2B are thiol, double bond, carboxylic group, thioester, anhydride, and sulfide.

FIGS. 3A-3B depict the kinetic characterization of thioester-anhydride resins in accordance with some embodiments. FIG. 3A: Allyl functional group conversion vs time for ASA/PETMP initial formulation and ASA/TMPTMP/DAC optimized formulation (BAPO/PYR 0.5/0.05 wt %). The light intensities were 0.5 mW/cm² in both cases. FIG. 3B: curing depth as a function of dose (E) for ASA/TMPTMP/DAC with two concentrations of PYR and a constant concentration of initiator (0.5 wt %).

FIGS. 4A-4D show 3D prints fabricated using ASA/TMPTMP/DAC formulation in accordance with some embodiments. FIG. 4A: bunny. FIG. 4B: 3D decorative ring. FIG. 4C: 3D plain ring FIG. 4D: 3D square ring. Initiator/inhibitor ratio 0.5/0.05 wt %. masked stereo-lithography (MSLA) light intensity was 0.4 mW/cm².

FIGS. 5A-5B depict the DMA data of the dynamic thioester-anhydride network in accordance with some embodiments. FIG. 5A: Storage moduli and tangent delta plots for the thioester-anhydride neat sample, a sample composed of 50% recycled photopolymer and 50% fresh monomers, and a deactivated sample. FIG. 5B: stress relaxation curves for the original photopolymer network and recycled as well as deactivated analogs. Recycled samples perform comparatively with the original material. Postprocessed, i.e., HCl-deactivated samples exhibit similar thermomechanical characteristics but significantly reduced stress relaxation capability.

FIGS. 6A-6C depict results of creep experiments for the ASA/TMPTMP/DAC dynamic network, in accordance with some embodiments. FIG. 6A: Thirty-minute creep results for samples deformed under 600 kPa stress at the temperatures from 20 to 60° C.; FIG. 6B 10-30 min creep results for samples deformed under 100-200 kPa stress at 80 and 100° C.; FIG. 6C: 30 min creep data for deactivated specimens deformed under 300 kPa stress at the temperatures from 60 to 100° C. The final strains vary for the samples analyzed at different creep temperatures and are dependent on the degree of activity of the dynamic chemistry. When the stress is released, the amount of strain adaptation is also correlated to the creep time. Deactivation of the catalysts inhibits creep that is otherwise very significant above 80° C. in samples with active catalyst.

FIGS. 7A-7B show shape changes and restoration of the 3D printed geometries, in accordance with some embodiments. FIG. 7A show round ring structure deformed and thermally reconfigured into a square-shaped ring following the DCC deactivation and shape fixation; FIG. 7B show square-shaped 3D print reshaped into two consecutive permanent shapes, then fixed by DCC deactivation, and finally restored to its original shape by deformation and heating at 140° C.

FIGS. 8A-8B show ATR-IR spectra for ASA/TMPTMP/DAC resin, in accordance with some embodiments. FIG. 8A: full mid-IR spectral range; FIG. 8B: thioester and anhydride carbonyl and anhydride ring peak signals in the range of 1600-1900 cm⁻¹. Evident is anhydride ring opening reaction resulting in 85% conversion after 1 hour at ambient temperature.

FIG. 9 shows the DMA data (storage moduli and tangent delta) for dynamic thiol-ene materials, in accordance with some embodiments.

FIG. 10 shows the DMA stress relaxation data for dynamic thiol-ene materials collected at two temperatures, in accordance with some embodiments.

FIG. 11 shows stress relaxation data at 140° C. for ASA/TMPTMP/DAC dynamic thiol-ene photopolymer, in accordance with some embodiments.

FIG. 12 shows the stress relaxation data at 120° C. for semi-dynamic materials containing various loadings of recycled CAN resin, in accordance with some embodiments. The nondynamic components were made of a stoichiometric mixture of HDT and TTT. Partial reshaping capabilities are also demonstrated in pictures 1 to 4.

FIG. 13 illustrates the curing, degradation and recovery of a polymer in accordance with some embodiments.

FIGS. 14A-14B illustrate that the addition of excess thiol and base-catalyst triggers degradation of thioester-containing thermosets via thiol-thioester exchange, in accordance with some embodiments. FIG. 14A: Thioester-containing networks were photocured via thiol-ene combination, swelled in acetone, and degraded by exposure to thiol and base. FIG. 14B: Monomers, free thiol, and base-catalyst used to create networks and trigger thiol-thioester exchange.

FIG. 15 is a reaction scheme showing base-catalyzed thiol-thioester exchange swaps the group attached to a free thiol with the group attached to a thioester, in accordance with some embodiments. According to these embodiments, the thioester groups were initially connected to the network and the exchange resulted in dangling ends (highlighted box).

FIG. 16A-16C illustrate the prediction that the degradation of thioester-containing networks proceeds first through a small amount of mass gain and then through net mass loss based on the derived model, in accordance with some embodiments. FIG. 16A: Thioesters (black circles) and thiols (white circles) underwent exchange with free thiol (grey circles). Net mass loss was achieved when all bonds of a repeat unit were cleaved (right). FIG. 16B: Plot comparing predicted mass gain from thiol-thioester exchange versus probability a thioester crosslink cleaves, as was calculated by equation 9. FIG. 16C: Plot comparing predicted net mass loss from thiol-thioester exchange versus probability a thioester crosslink cleaves, based on equation 10.

FIGS. 17A-17B show that Tg and Mc measurements suggested thioester networks underwent bulk degradation, in accordance with some embodiments. FIG. 17A: Plot comparing storage modulus and tan delta with temperature, repeated for various film degradation times, shows increased degradation time lowered Tg and Er′ of films which was typical of bulk degradation. FIG. 17B: Plot comparing Mc with film degradation time shows model prediction (line) matched experimental data (markers) well. The model prediction used equation S4 in the SI, for a Z=4 network where rate constant k=0.0051±0.0001 M⁻¹min⁻¹ including standard error.

FIG. 18 demonstrates that higher concentration of thiol in the degrading solution led to faster mass loss, in accordance with some embodiments. Mass loss plotted versus time shows model predictions (lines with error bands) and experimental data (markers with error bars) matched well for BMP concentrations ranging from 0.0 M to 4.9 M. Rate constant value used for the model fit was k=0.0042±0.0001 M⁻¹min⁻¹ including standard error. Error bands on model predictions are error propagated from standard error on k, and error bars on experimental data are standard deviation.

FIG. 19 demonstrates that higher molar ratio of base to thiol in the degrading solution led to faster mass loss, in accordance with some embodiments. Mass loss plotted versus time shows model predictions (lines with error bands) and experimental data (markers with error bars) matched well as TEA molar ratio increased from 0 to 40 mol %. Rate constant value used for model fit was k=0.0039±0.00006 M⁻¹min⁻¹ including standard error. Error bands on model predictions are error propagated from standard error on k, and error bars on experimental data are standard deviation.

FIG. 20 demonstrates that a greater number of functional groups in the network structure led to slower mass loss, in accordance with some embodiments. Mass loss plotted versus time shows model predictions (lines with error bands) and experimental data (markers with error bars) matched well for monomer functionality Z when it ranged from 3 to 6. Rate constant value used for model fit was k=0.0039±0.00007 M⁻¹min⁻¹ including standard error. Error bands on model predictions are error propagated from standard error on k, and error bars on experimental data are standard deviation.

FIGS. 21A-21B show the selective degradation of a thioester network enabled recovery of fillers in 3-D printed thioester composites, in accordance with some embodiments. FIG. 21A: Predicted time for a thioester network to fully degrade plotted versus network thickness, using bulk and surface degradation models. Below 3 mm degradation time was predicted to be constant. FIG. 21B: SLA 3-D printed rings composed of various polymer networks (top), with part thickness in the bulk degrading regime, were exposed to a degrading solution (bottom). The TEDE-PETMP composite contained 20 weight % of 6-10 μm poly(styrene-co-divinylbenzene) microspheres.

FIGS. 22A-22C depict the EcDp curves used to 3-D print, in accordance with some embodiments. FIG. 22A: thioester (TEDE-PETMP). FIG. 22B: thioester composite (TEDE-PETMP-20wt % PS) FIG. 22C: control (DAA-PETMP) rings.

FIGS. 23A-23C depict the mass swelling ratio, q, as a function of concentration of free thiol BMP (FIG. 23A), TEA mol ratio (FIG. 23B), and monomer functionality Z (FIG. 23C), in accordance with some embodiments. Samples were repeated in triplicate. Mass swelling ratio, q, was calculated by

$$q = \frac{{m}_{deg}}{{m}_{final}} ,$$

where m_{deg} stands for the mass of thin films after the films were removed from degradation solution and patted dry with a Kimwipe, and m_{final} is the mass of thin films after degradation and drying in a vacuum oven.

FIG. 24 show a device used in a degradation procedure in accordance with some embodiments. Five thin films were degraded in a Petri dish at once, with each film sitting atop a steel mesh at a marked location. The Petri dish was covered with parafilm to prevent solvent evaporation. Degradation proceeded in covered 100×50 mm Pyrex Petri dishes shown in FIG. 24. Specifically, a stainless-steel mesh was placed on the bottom of the Petri dishes, allowing for a stir bar to spin at 400 RPM to let degrading solution flow above and below thin films. Acetone was used as a co-solvent as polar solvents stabilize thiol-thioester exchange. The concentration of acetone-BMP solutions for soaking films prior to degradation was the same as degradation conditions studied but omitted TEA (e.g. to test 4.0M BMP with 30 mol % TEA the appropriate volumes of acetone and BMP were added to the dish, while omitting TEA).

FIGS. 25A-25B show results of control experiments for thiol-thioester exchange-facilitated degradation in accordance with some embodiments. The results show that all three components (thioester groups, free thiol, and base catalyst) were required for a network to undergo significant degradation. “DAA” was a DAA-PETMP network degraded in a solution of 4.9M BMP and 30 mol % TEA, “Thiol only” a TEDE-PETMP network degraded in 4.9M BMP without base, and “Base only” a TEDE-PETMP network degraded in 30 mol % TEA (1.5M TEA) without free thiol. FIG. 25A: Mass loss over time for different control scenarios. FIG. 25B: Mass swelling ratio over time for different control scenarios.

FIG. 26 shows the result of surface degradation of 3-D printed slabs composed of TEDE-PETMP, in accordance with some embodiments. The slabs exhibited a linear height decrease of 0.37±0.02 mm/hour, including standard error, when placed in a 2.0M BMP, 30 mol % TEA degrading solution. A surface degradation model for thiol-thioester exchange facilitated degradation was developed by utilizing 1-D slabs. The 1-D slabs experienced mass loss through changes in height, making fractional mass loss:

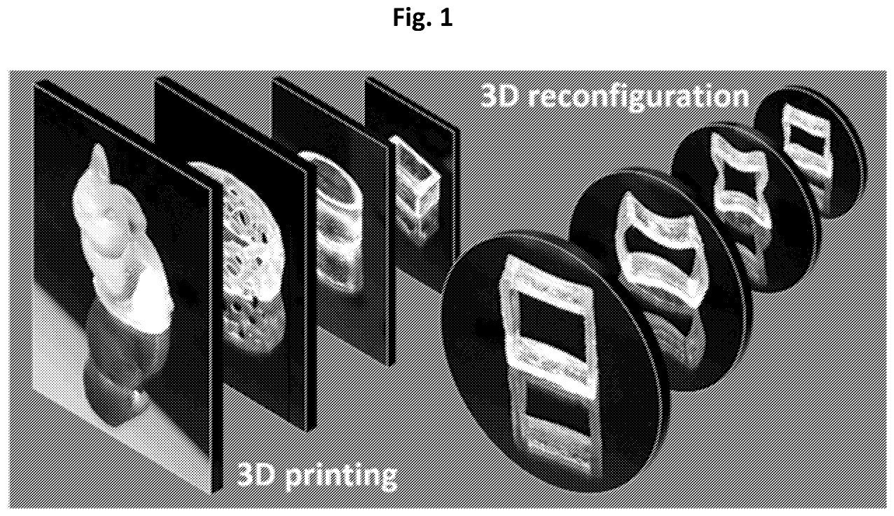

$${ML}_{1 - D} = \frac{{m}_{0} - {m}_{t}}{{m}_{0}} = \frac{{h}_{0} - {h}_{t}}{{h}_{0}} ,$$

where m₀ is initial mass, mₜ is mass at time t, h₀ is initial slab height, and hₜ is slab height at time t. From Hopfenberg, height of a slab as a function of time can be said to be controlled by a zero-order process and thus changes proportionally with time: hₜ=h₀−Ct, where C is an empirically-determined lump sum constant with units of distance/time and depends heavily on degradation conditions. Combining the two equations above, recognizing that when slabs achieved complete degradation ML_{1-D}=1, and rearranging, the time for a 1-D slab to completely degrade via surface degradation was:

$${t}_{degrade} = \frac{{h}_{0}}{C} .$$

To determine the lump sum constant C, which was specific to degrading thioester networks via thiol-thioester exchange, three SLA 3-D printed 5×50×50 mm slabs were degraded in a solution of 2.0M BMP, 30 mol % TEA. The slabs were first swelled in an acetone-BMP bath overnight to reach equilibrium swelling, resulting in a starting height of 6.40 mm. Degradation began by adding TEA. Measuring the height of slabs every hour, and fitting the data to the equation for hₜ yielded a value of 0.37±0.02 mm/hour for C.

FIGS. 27A-27C show the arrangements of networks used to derive q, the fraction of thioesters cleaved but still attached to the network, in accordance with some embodiments. FIG. 27A: All adjacent arms are attached to the network. FIG. 27B: Two adjacent arms are attached to the network. FIG. 27C: One adjacent arm is attached to the network.

FIG. 28 illustrates certain aspects of polymer degradation, in accordance with some embodiments.

FIG. 29 shows that covalent adaptable networks (CANs) allow thermoset degradation, in accordance with some embodiments.

FIG. 30 shows that CANs allow room temperature degradation, in accordance with some embodiments.

FIG. 31 shows the recovery of exemplary 3-D printable thermoset composites in accordance with some embodiments.

FIG. 32 describes some exemplary thioester networks made via thiol-ene reactions, in accordance with some embodiments.

FIG. 33 shows that an exemplary thiol-thioester according to some embodiments undergo degradation. As the gel permeation chromatography (GPC) results show, the thiol-thioester undergoes clean degradation.

FIG. 34 shows illustrates a thin film mass loss procedure in accordance with some embodiments.

FIG. 35 demonstrates that thiol concentration affects degradation rate, in accordance with some embodiments.

FIG. 36 shows Tg and E′_{rubber} shift with degradation in accordance with some embodiments.

FIG. 37 shows some exemplary SLA 3-D printing thioesters composites in accordance with some embodiments.

FIG. 38 shows a filler recovery method using centrifuge in accordance with some embodiments.

FIG. 39 shows that 1,8-Diazabicyclo[5.4.0]undec-7-ene (DBU) directly degrades thioester as shown by gel permeation chromatography (GPC) results, in accordance with some embodiments.

FIG. 40 shows clean thioester degradation as shown by nuclear magnetic resonance (NMR) results, in accordance with some embodiments.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

In the studies described herein (“the present studies”), a method of polymerizing monomers was developed by introducing a thioester-anhydride dynamic reversible chemistry into a thiol-ene photopolymerizable system. The polymerization method is able to produce thiol-ene covalent adaptable networks (CANs) having various desirable features.

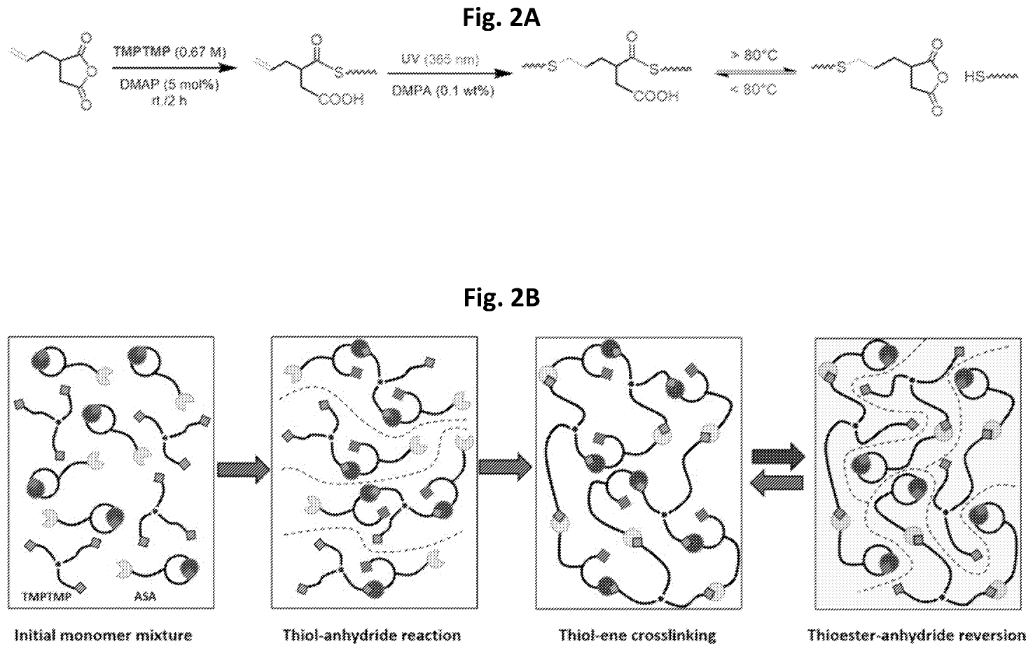

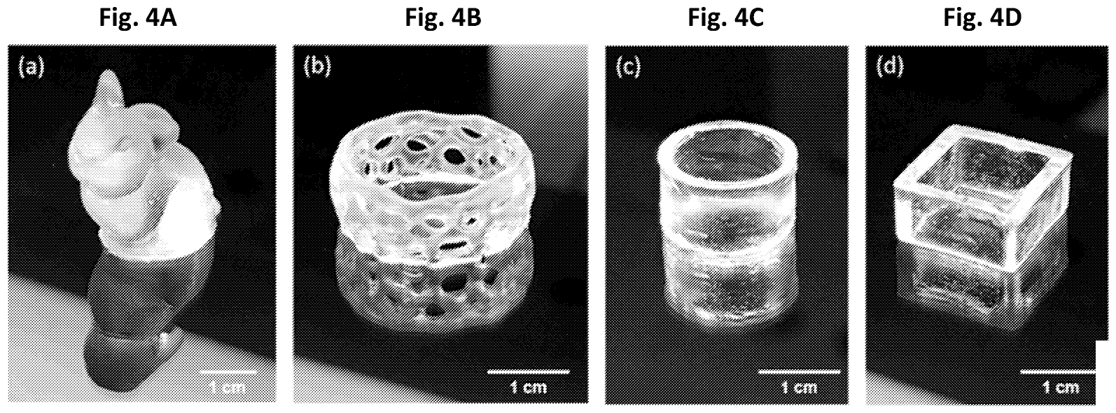

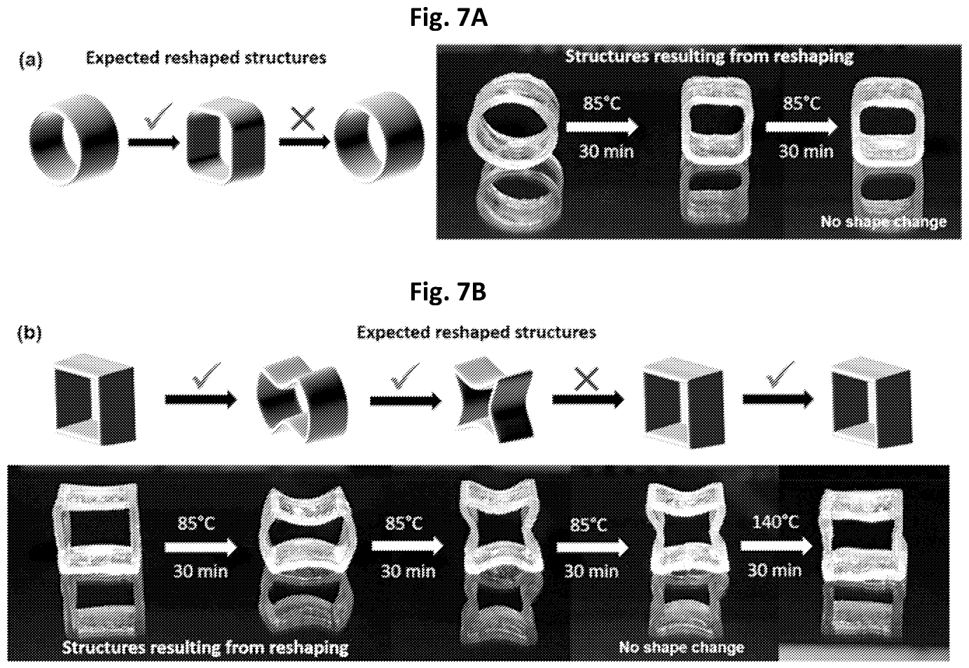

Specifically, in the present studies, an exemplary monomer mix configured for 3D printing was prepared. The monomer mix includes an exemplary first monomer including a thiol group (trimethylolpropane tris(3-mercaptopropionate), or “TMPTMP”), an exemplary second monomer including both an anhydride group and an alkene group (allyl succinic anhydride, or “ASA”), an exemplary first catalyst that catalyzing the reversible reaction between the thiol group of the first monomer and the anhydride group of the second monomer (4-dimethylaminopyridine or “DMAP”), and an exemplary second catalyst catalyzing the reaction between the thiol group of the first monomer and the alkene group of the second monomer (2,2-dimethoxy-2-phenylacetophenone or “DMPA”) (see e.g., FIGS. 2A-2B). Objects were then fabricated using the exemplary monomer mix by a non-limiting 3D printing method (masked stereolithography or MSLA) (see e.g., FIGS. 4A-4D). The fabricated objects were able to be reshaped at a relatively low temperature of about 80° C. or higher due to the reversible nature of the thioester bonds formed by the thiol groups and the anhydride group, as well as to the first catalyst that catalyzes this reversible reaction. Deactivation of the first catalyst significantly hampered the reversible reaction between the thiol group and the anhydride group, thereby rendering the 3D printed object no longer being able to be reshaped the relatively low temperature (which can now only be reshaped at a much higher temperature of about 140° C.) and fixing the 3D printed object to a permanent shape. (See e.g., FIGS. 7A-7B).

The present studies further developed a method for the controlled degradation of thioester group containing polymers, such as the thiol-ene CANS of the present studies. Specifically, the present studies show that thioester group containing polymers can be dissolved in a solution including an exemplary free thiol compound (butyl 3-mercaptopropionate or “BMP”) in the presence of an exemplary base-catalyst (triethylamine or “TEA”).

Accordingly, in some aspects, the instant invention is directed to a composition for producing a polymer, such as a composition for 3D printing or casting a thiol-ene covalent adaptable network (CAN) polymer article. In some embodiments, the composition includes a first monomer having at least one thiol group, and a second monomer having at least one anhydride functional group and at least one alkene functional group.

In some aspects, the instant invention is directed to polymer, such as a thiol-ene covalent adaptable network (CAN) polymer. In some embodiments, the polymer includes a first repeating unit and a second repeating unit. In some embodiments, the first repeating unit and the second repeating unit are linked through a reversible thioester group formed by a thiol group from the first repeating unit and an anhydride functional group from the second repeating unit, as well as a thioether group from by a thiol group from the first repeating unit and an alkene functional group from the second repeating unit.

In some aspects, the instant invention is directed to a method of producing a polymer, such as a thiol-ene covalent adaptable network (CAN) polymer. In some embodiments, the method includes providing a composition including a first monomer having at least one thiol group, and a second monomer having at least one anhydride functional group and at least one alkene functional group; and curing the composition.

In some aspects, the instant invention is directed to a method of fabricating a polymer article, such as an article of a thiol-ene covalent adaptable network (CAN) polymer. In some embodiments, the method includes providing a composition including a first monomer having at least one thiol group, and a second monomer having at least one anhydride functional group and at least one alkene functional group; and curing the composition to a predetermined shape.

In some aspects, the instant invention is directed to a method of degrading a polymer, such as a method of degrading a polymer including a thioester network. The method includes subject the polymer to a solution including a free thiol compound and a catalyst.

### Definitions

As used herein, each of the following terms has the meaning associated with it in this section. Unless defined otherwise, all technical and scientific terms used herein generally have the same meaning as commonly understood by one of ordinary skill in the art to which this disclosure belongs. Generally, the nomenclature used herein and the laboratory procedures are those well-known and commonly employed in the art. It should be understood that the order of steps or order for performing certain actions is immaterial, so long as the present teachings remain operable. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference.

In the application, where an element or component is said to be included in and/or selected from a list of recited elements or components, it should be understood that the element or component can be any one of the recited elements or components and can be selected from a group consisting of two or more of the recited elements or components.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.”

“About” as used herein when referring to a measurable value such as an amount, a temporal duration, and the like, is meant to encompass variations of ±20% or ±10%, in certain embodiments ±5%, in certain embodiments ±1%, in certain embodiments ±0.1% from the specified value, as such variations are appropriate to perform the disclosed methods.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that the composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less. The term “substantially free of” can mean having a trivial amount of, such that a composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The term “organic group” as used herein refers to any carbon-containing functional group. Examples can include an oxygen-containing group such as an alkoxy group, aryloxy group, aralkyloxy group, oxo(carbonyl) group; a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, C(═NOR)R, and substituted or unsubstituted (C₁-C₁₀₀)hydrocarbyl, wherein R can be hydrogen (in examples that include other carbon atoms) or a carbon-based moiety, and wherein the carbon-based moiety can be substituted or unsubstituted.

The term “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbon atoms or, in some embodiments, from 2 to 8 carbon atoms. Examples include, but are not limited to vinyl, —CH═C═CCH₂, —CH═CH(CH₃), —CH═C(CH₃)₂, —C(CH₃)═CH₂, —C(CH₃)═CH(CH₃), —C(CH₂CH₃)=CH₂, cyclohexenyl, cyclopentenyl, cyclohexadienyl, butadienyl, pentadienyl, and hexadienyl among others.

The term “alkynyl” as used herein refers to straight and branched chain alkyl groups, except that at least one triple bond exists between two carbon atoms. Thus, alkynyl groups have from 2 to 40 carbon atoms, 2 to about 20 carbon atoms, or from 2 to 12 carbons or, in some embodiments, from 2 to 8 carbon atoms. Examples include, but are not limited to —C═CH, —C═C(CH₃), —C═C(CH₂CH₃), —CH₂C═CH, —CH₂C═C(CH₃), and —CH₂C═C(CH₂CH₃) among others.

The term “acyl” as used herein refers to a group containing a carbonyl moiety wherein the group is bonded via the carbonyl carbon atom. The carbonyl carbon atom is bonded to a hydrogen forming a “formyl” group or is bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. An acyl group can include 0 to about 12, 0 to about 20, or 0 to about 40 additional carbon atoms bonded to the carbonyl group. An acyl group can include double or triple bonds within the meaning herein. An acryloyl group is an example of an acyl group. An acyl group can also include heteroatoms within the meaning herein. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “cycloalkyl” as used herein refers to cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members, whereas in other embodiments the number of ring carbon atoms range from 3 to 4, 5, 6, or 7. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined herein. Representative substituted cycloalkyl groups can be mono-substituted or substituted more than once, such as, but not limited to, 2,2-, 2,3-, 2,4- 2,5- or 2,6-disubstituted cyclohexyl groups or mono-, di- or tri-substituted norbornyl or cycloheptyl groups, which can be substituted with, for example, amino, hydroxy, cyano, carboxy, nitro, thio, alkoxy, and halogen groups. The term “cycloalkenyl” alone or in combination denotes a cyclic alkenyl group.

The term “aryl” as used herein refers to cyclic aromatic hydrocarbon groups that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, a phenyl group substituted at any one or more of 2-, 3-, 4-, 5-, or 6-positions of the phenyl ring, or a naphthyl group substituted at any one or more of 2- to 8-positions thereof.

The term “aralkyl” as used herein refers to alkyl groups as defined herein in which a hydrogen or carbon bond of an alkyl group is replaced with a bond to an aryl group as defined herein. Representative aralkyl groups include benzyl and phenylethyl groups and fused (cycloalkylaryl)alkyl groups such as 4-ethyl-indanyl. Aralkenyl groups are alkenyl groups as defined herein in which a hydrogen or carbon bond of an alkyl group is replaced with a bond to an aryl group as defined herein.

The term “heterocyclyl” as used herein refers to aromatic and non-aromatic ring compounds containing three or more ring members, of which one or more is a heteroatom such as, but not limited to, N, O, and S. Thus, a heterocyclyl can be a cycloheteroalkyl, or a heteroaryl, or if polycyclic, any combination thereof. In some embodiments, heterocyclyl groups include 3 to about 20 ring members, whereas other such groups have 3 to about 15 ring members. A heterocyclyl group designated as a C₂-heterocyclyl can be a 5-ring with two carbon atoms and three heteroatoms, a 6-ring with two carbon atoms and four heteroatoms and so forth. Likewise a C₄-heterocyclyl can be a 5-ring with one heteroatom, a 6-ring with two heteroatoms, and so forth. The number of carbon atoms plus the number of heteroatoms equals the total number of ring atoms. A heterocyclyl ring can also include one or more double bonds. A heteroaryl ring is an embodiment of a heterocyclyl group. The phrase “heterocyclyl group” includes fused ring species including those that include fused aromatic and non-aromatic groups. For example, a dioxolanyl ring and a benzdioxolanyl ring system (methylenedioxyphenyl ring system) are both heterocyclyl groups within the meaning herein. The phrase also includes polycyclic ring systems containing a heteroatom such as, but not limited to, quinuclidyl. Heterocyclyl groups can be unsubstituted, or can be substituted as discussed herein. Heterocyclyl groups include, but are not limited to, pyrrolidinyl, piperidinyl, piperazinyl, morpholinyl, pyrrolyl, pyrazolyl, triazolyl, tetrazolyl, oxazolyl, isoxazolyl, thiazolyl, pyridinyl, thiophenyl, benzothiophenyl, benzofuranyl, dihydrobenzofuranyl, indolyl, dihydroindolyl, azaindolyl, indazolyl, benzimidazolyl, azabenzimidazolyl, benzoxazolyl, benzothiazolyl, benzothiadiazolyl, imidazopyridinyl, isoxazolopyridinyl, thianaphthalenyl, purinyl, xanthinyl, adeninyl, guaninyl, quinolinyl, isoquinolinyl, tetrahydroquinolinyl, quinoxalinyl, and quinazolinyl groups. Representative substituted heterocyclyl groups can be mono-substituted or substituted more than once, such as, but not limited to, piperidinyl or quinolinyl groups, which are 2-, 3-, 4-, 5-, or 6-substituted, or disubstituted with groups such as those listed herein.

The term “heteroaryl” as used herein refers to aromatic ring compounds containing 5 or more ring members, of which, one or more is a heteroatom such as, but not limited to, N, O, and S; for instance, heteroaryl rings can have 5 to about 8-12 ring members. A heteroaryl group is a variety of a heterocyclyl group that possesses an aromatic electronic structure. A heteroaryl group designated as a C₂-heteroaryl can be a 5-ring with two carbon atoms and three heteroatoms, a 6-ring with two carbon atoms and four heteroatoms and so forth. Likewise a C₄-heteroaryl can be a 5-ring with one heteroatom, a 6-ring with two heteroatoms, and so forth. The number of carbon atoms plus the number of heteroatoms sums up to equal the total number of ring atoms. Heteroaryl groups include, but are not limited to, groups such as pyrrolyl, pyrazolyl, triazolyl, tetrazolyl, oxazolyl, isoxazolyl, thiazolyl, pyridinyl, thiophenyl, benzothiophenyl, benzofuranyl, indolyl, azaindolyl, indazolyl, benzimidazolyl, azabenzimidazolyl, benzoxazolyl, benzothiazolyl, benzothiadiazolyl, imidazopyridinyl, isoxazolopyridinyl, thianaphthalenyl, purinyl, xanthinyl, adeninyl, guaninyl, quinolinyl, isoquinolinyl, tetrahydroquinolinyl, quinoxalinyl, and quinazolinyl groups. Heteroaryl groups can be unsubstituted, or can be substituted with groups as is discussed herein. Representative substituted heteroaryl groups can be substituted one or more times with groups such as those listed herein.

Additional examples of aryl and heteroaryl groups include but are not limited to phenyl, biphenyl, indenyl, naphthyl (1-naphthyl, 2-naphthyl), N-hydroxytetrazolyl, N-hydroxytriazolyl, N-hydroxyimidazolyl, anthracenyl (1-anthracenyl, 2-anthracenyl, 3-anthracenyl), thiophenyl (2-thienyl, 3-thienyl), furyl (2-furyl, 3-furyl) , indolyl, oxadiazolyl, isoxazolyl, quinazolinyl, fluorenyl, xanthenyl, isoindanyl, benzhydryl, acridinyl, thiazolyl, pyrrolyl (2-pyrrolyl), pyrazolyl (3-pyrazolyl), imidazolyl (1-imidazolyl, 2-imidazolyl, 4-imidazolyl, 5-imidazolyl), triazolyl 1,2,3-triazol-4-yl, triazol-3-yl), oxazolyl (2-oxazolyl, 4-oxazolyl, 5-oxazolyl), thiazolyl (2-thiazolyl, 4-thiazolyl, 5-thiazolyl), pyridyl (2-pyridyl, 3-pyridyl, 4-pyridyl), pyrimidinyl (2-pyrimidinyl, 4-pyrimidinyl, 5-pyrimidinyl, 6-pyrimidinyl), pyrazinyl, pyridazinyl (3-pyridazinyl, 4-pyridazinyl, 5-pyridazinyl), quinolyl (2-quinolyl, 3-quinolyl, 4-quinolyl, 5-quinolyl, 6-quinolyl, 7-quinolyl, 8-quinolyl), isoquinolyl (1-isoquinolyl, 3-isoquinolyl, 4-isoquinolyl, 5-isoquinolyl, 6-isoquinolyl, 7-isoquinolyl, 8-isoquinolyl), benzo[b]furanyl (2-benzo[b]furanyl, 3-benzo[b]furanyl, 4-benzo[b]furanyl, 5-benzo[b]furanyl, 6-benzo[b]furanyl, 7-benzo[b]furanyl), 2,3-dihydro-benzo[b]furanyl (2-(2,3-dihydro-benzo[b]furanyl), 3-(2,3-dihydro-benzo[b]furanyl), 4-(2,3-dihydro-benzo[b]furanyl), 5-(2,3-dihydro-benzo[b]furanyl), 6-(2,3-dihydro-benzo[b]furanyl), 7-(2,3-dihydro-benzo[b]furanyl), benzo[b]thiophenyl (2-benzo[b]thiophenyl, 3-benzo[b]thiophenyl, 4-benzo[b]thiophenyl, 5-benzo[b]thiophenyl, 6-benzo[b]thiophenyl, 7-benzo[b]thiophenyl), 2,3-dihydro-benzo[b]thiophenyl, (2-(2,3-dihydro-benzo[b]thiophenyl), 3-(2,3-dihydro-benzo[b]thiophenyl), 4-(2,3-dihydro-benzo[b]thiophenyl), 5-(2,3-dihydro-benzo[b]thiophenyl), 6-(2,3-dihydro-benzo[b]thiophenyl), 7-(2,3-dihydro-benzo[b]thiophenyl), indolyl (1-indolyl, 2-indolyl, 3-indolyl, 4-indolyl, 5-indolyl, 6-indolyl, 7-indolyl), indazole (1-indazolyl, 3-indazolyl, 4-indazolyl, 5-indazolyl, 6-indazolyl, 7-indazolyl), benzimidazolyl (1-benzimidazolyl, 2-benzimidazolyl, 4-benzimidazolyl, 5-benzimidazolyl, 6-benzimidazolyl, 7-benzimidazolyl, 8-benzimidazolyl), benzoxazolyl (1-benzoxazolyl, 2-benzoxazolyl), benzothiazolyl (1-benzothiazolyl, 2-benzothiazolyl, 4-benzothiazolyl, 5-benzothiazolyl, 6-benzothiazolyl, 7-benzothiazolyl), carbazolyl (1-carbazolyl, 2-carbazolyl, 3-carbazolyl, 4-carbazolyl), 5H-dibenz[b,f]azepine (5H-dibenz[b,f]azepin-l-yl, 5H-dibenz[b,f]azepine-2-yl, 5H-dibenz[b,f]azepine-3-yl, 5H-dibenz[b,f]azepine-4-yl, 5H-dibenz[b,f]azepine-5-yl), 10,11-dihydro-5H-dibenz[b,f]azepine (10,11-dihydro-5H-dibenz[b,f]azepine-1−yl, 10,11-dihydro-5H-dibenz[b,f]azepine-2-yl, 10,11-dihydro-5H-dibenz[b,f]azepine-3-yl, 10,11-dihydro-5H-dibenz[b,f]azepine-4-yl, 10,11-dihydro-5H-dibenz[b,f]azepine-5-yl), and the like.

The term “heterocyclylalkyl” as used herein refers to alkyl groups as defined herein in which a hydrogen or carbon bond of an alkyl group as defined herein is replaced with a bond to a heterocyclyl group as defined herein. Representative heterocyclyl alkyl groups include, but are not limited to, furan-2-yl methyl, furan-3-yl methyl, pyridine-3-yl methyl, tetrahydrofuran-2-yl ethyl, and indol-2-yl propyl.

The term “heteroarylalkyl” as used herein refers to alkyl groups as defined herein in which a hydrogen or carbon bond of an alkyl group is replaced with a bond to a heteroaryl group as defined herein.

The term “alkoxy” as used herein refers to an oxygen atom connected to an alkyl group, including a cycloalkyl group, as are defined herein. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include but are not limited to cyclopropyloxy, cyclobutyloxy, cyclopentyloxy, cyclohexyloxy, and the like. An alkoxy group can include about 1 to about 12, about 1 to about 20, or about 1 to about 40 carbon atoms bonded to the oxygen atom, and can further include double or triple bonds, and can also include heteroatoms. For example, an allyloxy group or a methoxyethoxy group is also an alkoxy group within the meaning herein, as is a methylenedioxy group in a context where two adjacent atoms of a structure are substituted therewith.

The terms “halo,” “halogen,” or “halide” group, as used herein, by themselves or as part of another substituent, mean, unless otherwise stated, a fluorine, chlorine, bromine, or iodine atom.

The term “haloalkyl” group, as used herein, includes mono-halo alkyl groups, poly-halo alkyl groups wherein all halo atoms can be the same or different, and per-halo alkyl groups, wherein all hydrogen atoms are replaced by halogen atoms, such as fluoro. Examples of haloalkyl include trifluoromethyl, 1,1-dichloroethyl, 1,2-dichloroethyl, 1,3-dibromo-3,3-difluoropropyl, perfluorobutyl, and the like.

The term “hydrocarbon” or “hydrocarbyl” as used herein refers to a molecule or functional group that includes carbon and hydrogen atoms. The term can also refer to a molecule or functional group that normally includes both carbon and hydrogen atoms but wherein all the hydrogen atoms are substituted with other functional groups.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof. Hydrocarbyl groups can be shown as (Cₐ-C_{b})hydrocarbyl, wherein a and b are integers and mean having any of a to b number of carbon atoms. For example, (C₁-C₄)hydrocarbyl means the hydrocarbyl group can be methyl (CO, ethyl (C₂), propyl (C₃), or butyl (C₄), and (C₀-C_{b})hydrocarbyl means in certain embodiments there is no hydrocarbyl group.

The terms “covalent adaptable network” or “CAN,” as used herein, refer to polymer network that includes dynamic covalent bonds (DCB) or involves dynamic covalent chemistry (DCC).

The terms “dynamic covalent bond” or “DCB,” as used herein, refer to covalent bonds that are reversible under certain conditions but are stable when under other conditions. Exemplary DCBs include those that are reversible at elevated temperature but stable at ambient temperatures. The chemistry involving DCBs are referred to as DCC herein.

The term “thioester,” as used herein, refers to an organic compound including the “thioester group” or “thioester functional group,” which has the chemical structure R—S—(C═O)—R′.

The term “thiol,” as used herein, refers to an organic compound including the “thiol group” or “thiol functional group,” which has the chemical structure R—SH.

The term “anhydride,” as used herein, refers to an organic compound including the “anhydride group” or “anhydride functional group,” which has the chemical structure R(C═O)O(C═O)R′.

The term “thioether,” as used herein, refers to an organic compound including the “thioether group” or “thioether functional group,” which has the chemical structure R—S—R′.

As used herein, the term “alkene monomer” or “alkene-based substrate” refers to a small molecule or a polymeric molecule comprising at least one reactive alkenyl group. An “alkenyl group” is an unsaturated, linear or branched or cyclic hydrocarbon group consisting at least one carbon-carbon double bond. In certain embodiments, the ene-based substrate comprises at least one alkenyl group (C═C).

As used herein, the term “alkyne monomer” or “alkyne-based substrate” refers to a small molecule or a polymeric molecule comprising at least one reactive alkynyl group. An “alkynyl group” is an unsaturated, linear or branched or cyclic hydrocarbon group consisting at least one carbon-carbon triple bond. In certain embodiments, the alkyne-based substrate comprises at least one terminal alkynyl group (—C≡CH).

As used herein, the term “ene monomer” refers to a monomer comprising at least one reactive alkene group, or a reactive alkene equivalent, such as but not limited to an oxirane group.

As used herein, the term “depolymerization” refers to the reaction wherein a polymer is at least partially converted to at least one oligomer and/or a monomer, or an oligomer is at least partially converted to at least one smaller oligomer and/or a monomer.

The term “monomer” refers to any discreet chemical compound of any molecular weight.

As used herein, the term “nucleophilicity value” is defined as those obtained from the equation: log k_{20oC}=s_{N}(N+E), wherein E=electrophilicty parameter, N=nucleophilicty parameter (solvent dependent), s_{N}=nucleophile-specific sensitivity parameter (solvent dependent). All nucleophilicity values were taken from Baidya, et al., 2007, Angew. Chem. Int. Ed. 46:6176, and are values obtained in MeCN.

As used herein, the term “Type I photoinitiator” refers to a compound that undergoes a unimolecular bond cleavage upon irradiation to yield free radicals. Non-limiting examples of Type I photoinitiators are benzoin ethers, benzyl ketals, α-dialkoxy-acetophenones, α-hydroxy-alkylphenones, α-amino-alkylphenones and acyl-phosphine oxides.

As used herein, the term “Type II photoinitiator” refers to a combination of compounds that undergo a bimolecular reaction where the excited state of the photoinitiator interacts with a second molecule (often known as “co-initiator”) to generate free radicals.

As used herein, the term “pKa” refers to the −log of the acid dissociation constant (Ka) of a compound. All pKa values referred to herein are pKa values for a compound dissolved in water.

As used herein, the term “polymer” refers to a molecule composed of repeating structural units typically connected by covalent chemical bonds. The term “polymer” is also meant to include the terms copolymer and oligomers. In certain embodiments, a polymer comprises a backbone (i.e., the chemical connectivity that defines the central chain of the polymer, including chemical linkages among the various polymerized monomeric units) and a side chain (i.e., the chemical connectivity that extends away from the backbone).

As used herein, the term “polymerization” or “crosslinking” refers to at least one reaction that consumes at least one functional group in a monomeric molecule (or monomer), oligomeric molecule (or oligomer) or polymeric molecule (or polymer), to create at least one chemical linkage between at least two distinct molecules (e.g., intermolecular bond), at least one chemical linkage within the same molecule (e.g., intramolecular bond), or any combinations thereof. A polymerization or crosslinking reaction may consume between about 0% and about 100% of the at least one functional group available in the system. In certain embodiments, polymerization or crosslinking of at least one functional group results in about 100% consumption of the at least one functional group. In other embodiments, polymerization or crosslinking of at least one functional group results in less than about 100% consumption of the at least one functional group.

As used herein, the term “reaction condition” refers to a physical treatment, chemical reagent, or combination thereof, which is required or optionally required to promote a reaction. Non-limiting examples of reaction conditions are electromagnetic radiation (such as, but not limited to visible light), heat, a catalyst, a chemical reagent (such as, but not limited to, an acid, base, electrophile or nucleophile), and a buffer.

As used herein, the term “reactive” as applied to thiol, isocyanate, oxirane, alkyne or alkene groups indicate that these groups under appropriate conditions may take part in one or more reactions as defined in this application.

As used herein, the term “thiol-ene reaction” refers to an organic reaction between a thiol monomer and an ene/yne monomer. In certain embodiments, the ene monomer is an α,β-unsaturated ester, acid, sulfone, nitrile, ketone, amide, aldehyde, or nitro compound (Hoyle, et al., Angew. Chem. Intl Ed., 2010, 49(9):1540-1573); the thiol-ene reaction involving such reactants is known as “thiol-Michael reaction.”

As used herein, the term “thiol-ene polymerization” refers to polymerization wherein at least one thiol-ene reaction takes place.

As used herein, the term “alkyl”, by itself or as part of another substituent means, unless otherwise stated, a straight or branched chain hydrocarbon having the number of carbon atoms designated (i.e., C₁-C₁₀ means one to ten carbon atoms) and includes straight, branched chain, or cyclic substituent groups. Examples include methyl, ethyl, propyl, isopropyl, butyl, isobutyl, tert-butyl, pentyl, neopentyl, hexyl, and cyclopropylmethyl. In various embodiments, the alkylis (C₁-C₆)alkyl, such as, but not limited to, ethyl, methyl, isopropyl, isobutyl, n-pentyl, n-hexyl and cyclopropylmethyl.

As used herein, the term “cycloalkyl”, by itself or as part of another substituent means, unless otherwise stated, a cyclic chain hydrocarbon having the number of carbon atoms designated (i.e., C₃-C₆ means a cyclic group comprising a ring group consisting of three to six carbon atoms) and includes straight, branched chain or cyclic substituent groups. Examples include cyclopropyl, cyclobutyl, cyclopentyl, cyclohexyl, cycloheptyl, and cyclooctyl. In various embodiments, the cycloalkyl is (C₃-C₆)cycloalkyl, such as, but not limited to, cyclopropyl, cyclobutyl, cyclopentyl and cyclohexyl.

As used herein, the term “alkenyl”, employed alone or in combination with other terms, means, unless otherwise stated, a stable mono-unsaturated or di- unsaturated straight chain or branched chain hydrocarbon group having the stated number of carbon atoms. Examples include vinyl, propenyl (or allyl), crotyl, isopentenyl, butadienyl, 1,3-pentadienyl, 1,4-pentadienyl, and the higher homologs and isomers. A functional group representing an alkene is exemplified by —CH₂—CH═CH₂.

As used herein, the term “alkynyl”, employed alone or in combination with other terms, means, unless otherwise stated, a stable straight chain or branched chain hydrocarbon group with a triple carbon-carbon bond, having the stated number of carbon atoms. Non-limiting examples include ethynyl and propynyl, and the higher homologs and isomers.

As used herein, the term “alkylene” by itself or as part of another substituent means, unless otherwise stated, a straight or branched hydrocarbon group having the number of carbon atoms designated (i.e., C₁-C₁₀ means one to ten carbon atoms) and includes straight, branched chain, or cyclic substituent groups, wherein the group has two open valencies. Examples include methylene, 1,2-ethylene, 1,1-ethylene, 1,1-propylene, 1,2-propylene and 1,3-propylene. Heteroalkylene substituents can a group consisting of the stated number of carbon atoms and one or more heteroatoms selected from the group consisting of O, N, and S, and wherein the nitrogen and sulfur atoms may be optionally oxidized and the nitrogen heteroatom may be optionally quaternized. The heteroatom(s) may be placed at any position of the heteroalkyl group, including between the rest of the heteroalkyl group and the fragment to which it is attached, as well as attached to the most distal carbon atom in the heteroalkyl group.

As used herein, the term “alkenylene”, employed alone or in combination with other terms, means, unless otherwise stated, a stable mono-unsaturated or di-unsaturated straight chain or branched chain hydrocarbon group having the stated number of carbon atoms wherein the group has two open valencies.

As used herein, the term “alkynylene”, employed alone or in combination with other terms, means, unless otherwise stated, a stable straight chain or branched chain hydrocarbon group with a triple carbon-carbon bond, having the stated number of carbon atoms wherein the group has two open valencies.

As used herein, the term “substituted alkyl”, “substituted cycloalkyl”, “substituted alkenyl”, “substituted alkynyl”, “substituted alkylene”, “substituted alkenylene” or “substituted alkynylene” means alkyl, cycloalkyl, alkenyl, alkynyl, alkylene, alkenylene, alkynylene as defined above, substituted by one, two or three substituents selected from the group consisting of C₁-C₁₀ alkyl, halogen, ═O, —OH, alkoxy, tetrahydro-2-H-pyranyl, —NH₂, —N(CH₃)₂, (1-methyl-imidazol-2-yl), pyridin-2-yl, pyridin-3-yl, pyridin-4-yl, —C(═O)OH, trifluoromethyl, —C(═O)O(C₁-C₄)alkyl, —C(═O)NH₂, —C(═O)NH(C₁-C₄)alkyl, —C(═O)N((C₁-C₄)alkyl)₂, —SO₂NH₂, —C(═NH)NH₂, and —NO₂, preferably containing one or two substituents selected from halogen, —OH, alkoxy, —NH₂, trifluoromethyl, —N(CH₃)₂, and —C(═O)OH, more preferably selected from halogen, alkoxy and —OH. Examples of substituted alkyls include, but are not limited to, 2,2-difluoropropyl, 2-carboxycyclopentyl and 3-chloropropyl.

As used herein, the term “alkoxy” employed alone or in combination with other terms means, unless otherwise stated, an alkyl group having the designated number of carbon atoms, as defined above, connected to the rest of the molecule via an oxygen atom, such as, for example, methoxy, ethoxy, 1-propoxy, 2-propoxy (isopropoxy) and the higher homologs and isomers. In various embodiments, the alkoxy is (C₁-C₃)alkoxy, such as, but not limited to, ethoxy and methoxy.

As used herein, the term “halo” or “halogen” alone or as part of another substituent means, unless otherwise stated, a fluorine, chlorine, bromine, or iodine atom, preferably, fluorine, chlorine, or bromine, more preferably, fluorine or chlorine.

As used herein, the term “heteroalkyl” by itself or in combination with another term means, unless otherwise stated, a stable straight or branched chain alkyl group consisting of the stated number of carbon atoms and one or two heteroatoms selected from the group consisting of O, N, and S, and wherein the nitrogen and sulfur atoms may be optionally oxidized and the nitrogen heteroatom may be optionally quaternized. The heteroatom(s) may be placed at any position of the heteroalkyl group, including between the rest of the heteroalkyl group and the fragment to which it is attached, as well as attached to the most distal carbon atom in the heteroalkyl group. Examples include —O—CH₂—CH₂—CH₃, —CH₂—CH₂—CH₂—OH, —CH₂—CH₂—NH—CH₃, —CH₂—S—CH₂—CH₃, and —CH₂CH₂—S(═O)—CH₃. Up to two heteroatoms may be consecutive, such as, for example, —CH₂—NH—OCH₃, or —CH₂—CH₂—S—S—CH₃.

As used herein, the term “heteroalkenyl” by itself or in combination with another term means, unless otherwise stated, a stable straight or branched chain monounsaturated or di-unsaturated hydrocarbon group consisting of the stated number of carbon atoms and one or two heteroatoms selected from the group consisting of O, N, and S, and wherein the nitrogen and sulfur atoms may optionally be oxidized and the nitrogen heteroatom may optionally be quaternized. Up to two heteroatoms may be placed consecutively. Examples include —CH═CH—O—CH₃, —CH═CH—CH₂—OH, —CH₂—CH═N—OCH₃, —CH═CH—N(CH₃)—CH₃, and —CH₂—CH═CH—CH₂—SH.

As used herein, the term “aromatic” refers to a carbocycle or heterocycle with one or more polyunsaturated rings and having aromatic character, i.e. having (4n+2) delocalized π (pi) electrons, where n is an integer.

As used herein, the term “aryl”, employed alone or in combination with other terms, means, unless otherwise stated, a carbocyclic aromatic system containing one or more rings (typically one, two or three rings) wherein such rings may be attached together in a pendent manner, such as a biphenyl, or may be fused, such as naphthalene. Examples include phenyl, anthracyl, and naphthyl.

As used herein, the term “heterocycle” or “heterocyclyl” or “heterocyclic” by itself or as part of another sub stituent means, unless otherwise stated, an unsubstituted or substituted, stable, mono- or multi-cyclic heterocyclic ring system that consists of carbon atoms and at least one heteroatom selected from the group consisting of N, O, and S, and wherein the nitrogen and sulfur heteroatoms may be optionally oxidized, and the nitrogen atom may be optionally quaternized. The heterocyclic system may be attached, unless otherwise stated, at any heteroatom or carbon atom that affords a stable structure. A heterocycle may be aromatic or non-aromatic in nature. In one embodiment, the heterocycle is a heteroaryl.

As used herein, the term “heteroaryl” or “heteroaromatic” refers to a heterocycle having aromatic character. A polycyclic heteroaryl may include one or more rings that are partially saturated. Examples include tetrahydroquinoline and 2,3-dihydrob enzofuryl.

Examples of non-aromatic heterocycles include monocyclic groups such as aziridine, oxirane, thiirane, azetidine, oxetane, thietane, pyrrolidine, pyrroline, imidazoline, pyrazolidine, dioxolane, sulfolane, 2,3-dihydrofuran, 2,5-dihydrofuran, tetrahydrofuran, thiophane, piperidine, 1,2,3,6-tetrahydropyridine, 1,4-dihydropyridine, piperazine, morpholine, thiomorpholine, pyran, 2,3-dihydropyran, tetrahydropyran, 1,4-dioxane, 1,3-dioxane, homopiperazine, homopiperidine, 1,3-dioxepane, 4,7-dihydro-1,3-dioxepin and hexamethyleneoxide.

Examples of heteroaryl groups include pyridyl, pyrazinyl, pyrimidinyl (such as, but not limited to, 2- and 4-pyrimidinyl), pyridazinyl, thienyl, furyl, pyrrolyl, imidazolyl, thiazolyl, oxazolyl, pyrazolyl, isothiazolyl, 1,2,3-triazolyl, 1,2,4-triazolyl, 1,3,4-triazolyl, tetrazolyl, 1,2,3-thiadiazolyl, 1,2,3-oxadiazolyl, 1,3,4-thiadiazolyl and 1,3,4-oxadiazolyl.

Examples of polycyclic heterocycles include indolyl (such as, but not limited to, 3-, 4-, 5-, 6- and 7-indolyl), indolinyl, quinolyl, tetrahydroquinolyl, isoquinolyl (such as, but not limited to, 1- and 5-isoquinolyl), 1,2,3,4-tetrahydroisoquinolyl, cinnolinyl, quinoxalinyl (such as, but not limited to, 2- and 5-quinoxalinyl), quinazolinyl, phthalazinyl, 1,8-naphthyridinyl, 1,4-benzodioxanyl, coumarin, dihydrocoumarin, 1,5-naphthyridinyl, benzofuryl (such as, but not limited to, 3-, 4-, 5-, 6- and 7-benzofuryl), 2,3-dihydrobenzofuryl, 1,2-benzisoxazolyl, benzothienyl (such as, but not limited to, 3-, 4-, 5-, 6-, and 7-benzothienyl), benzoxazolyl, benzothiazolyl (such as, but not limited to, 2-benzothiazolyl and 5-benzothiazolyl), purinyl, benzimidazolyl, benztriazolyl, thioxanthinyl, carbazolyl, carbolinyl, acridinyl, pyrrolizidinyl, and quinolizidinyl.

The aforementioned listing of heterocyclyl and heteroaryl moieties is intended to be representative and not limiting.

As used herein, the term “substituted” means that an atom or group of atoms has replaced hydrogen as the substituent attached to another group.

For aryl, aryl-(C₁-C₃)alkyl and heterocyclyl groups, the term “substituted” as applied to the rings of these groups refers to any level of substitution, namely mono-, di-, tri-, tetra-, or penta-substitution, where such substitution is permitted. The substituents are independently selected, and substitution may be at any chemically accessible position. In one embodiment, the substituents vary in number between one and four. In another embodiment, the substituents vary in number between one and three. In yet another embodiment, the substituents vary in number between one and two. In yet another embodiment, the substituents are independently selected from the group consisting of C₁₋₆ alkyl, —OH, C₁₋₆ alkoxy, halo, amino, acetamido and nitro. As used herein, where a substituent is an alkyl or alkoxy group, the carbon chain may be branched, straight or cyclic.

“Instructional material” as that term is used herein includes a publication, a recording, a diagram, or any other medium of expression that can be used to communicate the usefulness of the composition and/or compound of the invention in a kit. The instructional material of the kit may, for example, be affixed to a container that contains the compound and/or composition of the invention or be shipped together with a container that contains the compound and/or composition.

The terms “room temperature,” as used herein, refers to a temperature ranging from about 20° C. to about 25° C.

The term “solvent” as used herein refers to a liquid that can dissolve a solid, liquid, or gas. Non-limiting examples of solvents are silicones, organic compounds, water, alcohols, ionic liquids, and supercritical fluids.

The abbreviations of compound names used herein include the follows: DMPA: 2,2-dimethoxy-2-phenylacetophenone; BAPO: phenylbis(2,4,6-trimethylbenzoyl)phosphine oxide; PYR: pyrogallol (PYR); ASA: allyl succinic anhydride; TMPTMP: trimethylolpropane tris(3-mercaptopropionate); HDT: 1,6-hexanedithiol; TTT: 1,3,5-triallyl-1,3,5-triazyne-2,4,6-trione; DAC: diallyl carbonate; AE: allyl ether; DATP: diallyl terephthalate; HCl: hydrochloric acid (37%); HCl_{g}: gaseous HCl; DCM: methylene chloride; DMAP: 4-dimethylaminopyridine; 3-MPA: 3-mercaptopropionic acid; AA: allyl alcohol; BMP: butyl 3-mercaptopropionate (BMP); pTsOH: p-toluenesulfonic acid; PETMP: pentaerythritol tetrakis(3-mercaptopropionate); DAA: diallyl adipate; SA: succinic anhydride; diPETMP: dipentaerythritol hexakis(3-mercaptopropionate).

### Composition for Producing Polymer

In some embodiments, the instant specification is directed to a composition for producing a polymer. In some embodiments, the polymer is a thiol-ene covalent adaptable network (CAN) polymer.

In some embodiments, the composition includes a first monomer and a second monomer. The first monomer includes at least one thiol group. The second monomer includes at least one anhydride functional group and at least one alkene functional group.

In some embodiments, a compound of Formula I is provided. The compound of Formula I includes:
a first monomer of Formula (I):

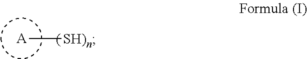

and
a second monomer of Formula (II) selected from the group consisting of:

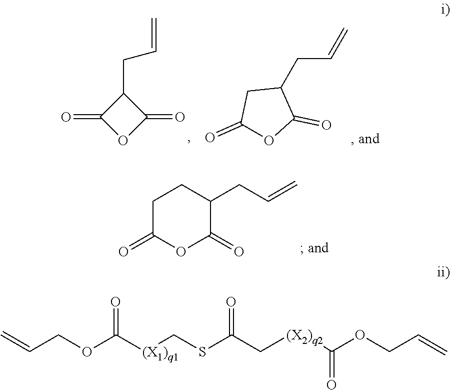

wherein:
   [symbol] is C₃₋₂₀ alkyl, C₃₋₂₀ heteroalkyl, C₃₋₂₀ cycloalkyl, C₆₋₁₄ aryl, or combinations thereof, each of which is optionally substituted by 1 to 5 groups independently selected from the group consisting of F, Cl, Br, I, OR, OC(O)N(R)₂, CN, NO₂, CF₃, OCF₃, R, N(R)₂, SR, SOR, SO₂R, SO₂N(R)₂, and SO₃R, wherein each occurrence of R is independently hydrogen, C₁-C₁₀ alkyl, or C₆₋₁₀ aryl,
n is an integer ranging from 2 to 6;
X₁ is independently at each occurrence —CH₂—, —O—, —OCH₂CH₂—, or —CH₂CH₂O—
X₂ is independently at each occurrence —CH₂, —O—, —OCH₂CH₂—, or —CH₂CH₂O—
q1 is an integer from 1 to 20; and
q2 is an integer from 1 to 20.
In some embodiments, a molar ratio between the first monomer and the second monomer in the composition ranges from about 1:5 to about 5:1, such as from about 1:4 to about 4:1, from about 1:3 to about 3:1, from about 1:2 to about 2:1, or about 1:1. In various embodiments, q1 is 1, 2, 3, 4, 5, 6, 7, 8, 9, 10, 11, 12, 13, 14, 15, 16, 17, 18, 19, or 20. In various embodiments, q2 is 1, 2, 3, 4, 5, 6, 7, 8, 9, 10, 11, 12, 13, 14, 15, 16, 17, 18, 19, or 20. In various embodiments, n is 2, 3, 4, 5, or 6.

In some embodiments, the first monomer includes two or more thiol groups, such as three or more, four or more, five or more thiol groups. In some embodiments, the first monomer includes about 2, about 3, about 4, about 5, about 6, about 7, about 8, about 9, or about 10 thiol groups.

In some embodiments, except for the one or more thiol group, the first monomer does not include a functional group substantially reactive with the anhydride functional group or the alkene functional group of the second monomer, such as under the reaction conditions described in the “Method of Producing Polymer” section below. The term “substantially reactive with,” as used in this paragraph, means the two functional groups that react with each other at a level 20% or more, such as 10% or more, 5% or more, 2% or more, or 1% or more of the level the thiol group reacts with the anhydride functional group or the alkene functional group.

Examples of the first monomer include:

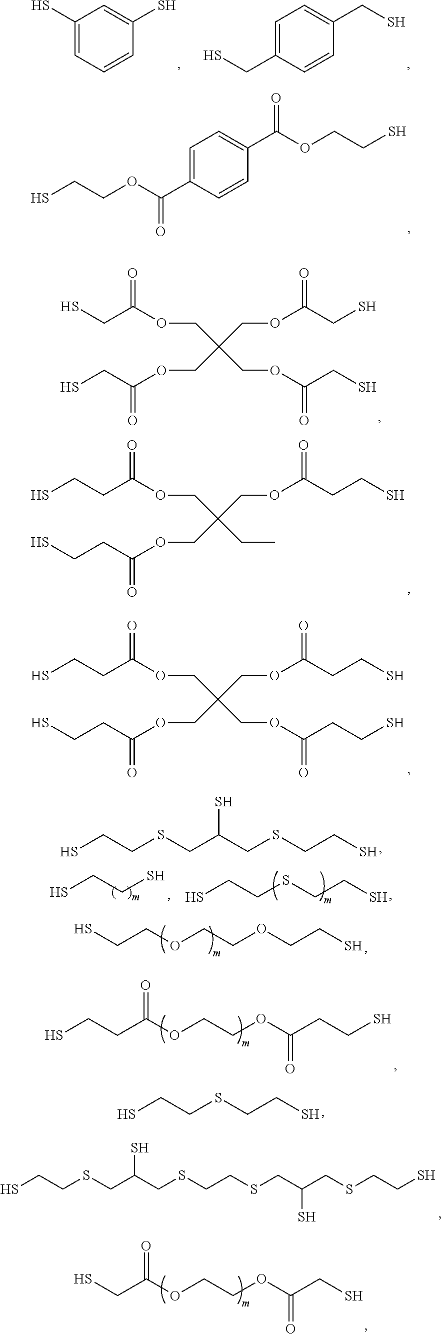

wherein m is an integer between 1 and 20, and the like. In various embodiments, m is 1, 2, 3, 4, 5, 6, 7, 8, 9, 10, 11, 12, 13, 14, 15, 16, 17, 18, 19, or 20.

In some embodiments, the second monomer includes two or more anhydride functional groups, such as three or more, four or more, five or more anhydride functional groups. In some embodiments, the second monomer includes about 2, about 3, about 4, about 5, about 6, about 7, about 8, about 9, or about 10 anhydride functional groups. In some embodiments, the second monomer includes two or more alkene functional groups, such as three or more, four or more, five or more alkene functional groups. In some embodiments, the second monomer includes about 2, about 3, about 4, about 5, about 6, about 7, about 8, about 9, or about 10 alkene functional groups.

In some embodiments, except for the at least one anhydride functional group and at least one alkene functional group, the second monomer does not include a functional group substantially reactive with the at least one thiol group of the first monomer, such as under the conditions described in the “Method of Producing Polymer” section below. The term “substantially reactive with,” as used in this paragraph, means the two functional groups that react with each other at a level 20% or more, such as 10% or more, 5% or more, 2% or more, or 1% or more of the level the thiol group reacts with the anhydride functional group or the alkene functional group.

Examples of the second monomer include

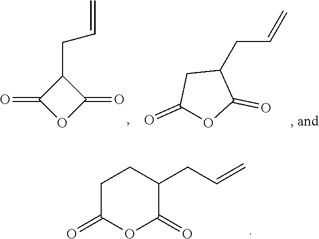

In some embodiments, the second monomer is

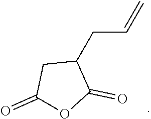

In some embodiments, the second monomer is

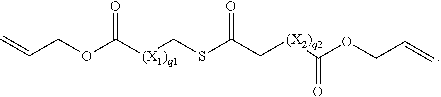

In some embodiments, the thiol group of the first monomer and the anhydride functional group of the second monomer form at least one thioester group, such as under room temperature. In some embodiments, reversible reaction between the thiol group and the anhydride functional group is catalyzed by a catalyst, such as the second catalyst described elsewhere herein.

In some embodiments, the thiol group of the first monomer and the alkene functional group of the second monomer form at least one thioether group via the thiol-ene reaction. In some embodiments, the reaction between the thiol group and the alkene functional group is driven by a initiator, such as a thermal initiator, a photo initiator, a radical initiator or the like.

It is worth noting that even if a portion or all of the monomers in the instant composition are reacted to form thioesters and/or thioethers, the composition is stilled considered within the scope of the instant section, as long as the composition is still able to be subjected to further curing and suitable for purposes such as 3D printing, casting or the like.

In some embodiments, the composition further includes a first catalyst catalyzing the reaction between the thiol group of the first monomer and the anhydride functional group of the second monomer. In some embodiments, the fist catalyst is a nucleophilic catalyst. In some embodiments, the first catalyst reduces the activation energy of the reversible reaction, and allows the thioester groups in the curing product (also described in the “Polymer” section below) to revert back to thiol groups and anhydride groups at relatively low temperatures (such as about 100° C. or lower, about 95° C. or lower, about 90° C. or lower, about 85° C. or lower, about 80° C. or lower, about 75° C. or lower, about 70° C. or lower, about 65° C. or lower, or about 60° C. or lower). In some embodiments, when the thioester groups in the curing product of the composition is reverted back to thiol groups and anhydride groups as catalyzed by the fist catalyst, the curing product of the composition is able to be reshaped. In some embodiments, the first catalyst in the curing product is able to be deactivated by, for example, acid treatment of the curing product. When the first catalyst is deactivated in the curing product, the shape of the curing product is considered fixed as the thioester groups in the curing product are no longer able to revert back to thiol groups and anhydride groups unless the curing product is heated to an alleviated temperature of about 100° C. or higher, such as 110° C. or higher, about 120° C. or higher, about 130° C. or higher, about 140° C. or higher, about 150° C. or higher, or about 160° C. or higher. Examples of fist catalyst includes 4-dimethylaminopyridine (DMAP) and the like. In some embodiments, an amount of the first catalyst ranges from about 0.1 mol % to about 20 mol %, such as about 0.5 mol % to about 15 mol %, about 1 mol % to about 10 mol %, about 2.5 mol % to about 7.5 mol %, or about 5 mol % with respect to a total amount of the first monomer and the second monomer.

In some embodiments, the composition further includes a second catalyst catalyzing the reaction between the thiol group of the first monomer and the anhydride functional group of the second monomer. In some embodiments, the second catalyst is able to generate a free radical, thereby promoting the polymerization reaction. In some embodiments, the second catalyst includes a polymerization initiator, such as a thermal initiator, a photo initiator, a radical initiator, or the like. Although some polymerization initiators are not conventional catalysts, all the polymerization initiators that promotes the reaction between the thiol group and the alkene functional group are considered within the scope of the term “second catalyst” as used herein. Examples of second catalyst includes 2,2-dimethoxy-2-phenylacetophenone (DMPA), and phenylbis(2,4,6-trimethylbenzoyl)phosphine oxide (BAPO), and the like. In some embodiments, the composition does not include the second catalyst, as the polymerization reaction can be initiated by other means, such as by ionizing radiation or electrochemical means. In some embodiments, an amount of the second catalyst ranges from about 0.01 wt % to about 1 wt %, such as about 0.02 wt % to about 0.8 wt %, about 0.05 wt % to about 0.5 wt %, about 0.075 wt % to about 0.2 wt %, about 0.1 wt % with respect to a total amount of the first monomer and the second monomer.

In some embodiments, the second catalyst include photo initiator. Examples of photo initiator include: acetophenone, benzophenone, 2-phenylacetophenone, 2,2-dimethoxy-2-phenylacetophenone, Bis(2,4,6-trimethylbenzoyl)-phenylphosphine oxide, 2-Hydroxy-4′-(2-hydroxyethoxy)-2-methylpropiophenone, 2-methyl-(4-methylthienyl)-2-morpholinyl-1-propan-1-one, Diphenyl(2,4,6-trimethylbenzoyl)phosphine oxide, Ethyl (2,4,6-trimethylbenzoyl) phenyl phosphinate, lithium phenyl-2,4,6-trimethylbenzoylphosphinate,

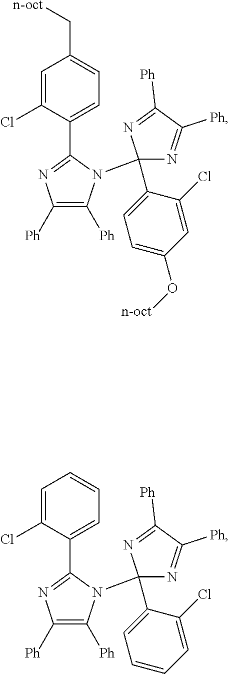

and the like.

In some embodiments, the composition further comprises a radical inhibitor that inhibits the radicals that exist in the composition. In some embodiments, the radical inhibitor increases the stability of the composition. In some embodiments, the radical inhibitor makes the composition more desirable for using in 3D printing as the inhibitor prevents the locally generated radicals (by, for example, heat, light, ionizing radiation or the like) from causing widespread curing of the composition. Examples of the radical inhibitor includes pyrogallol (PYR) or the like. In some embodiments, an amount of the radical inhibitor ranges from about 0.005 wt % to about 0.5 wt %, such as about 0.01 wt % to about 0.2 wt %, about 0.02 wt % to about 0.1 wt %, or about 0.003 wt % to about 0.006 wt %, with respect to a total amount of the first monomer and the second monomer.

In some embodiments, a weight ratio between the second catalyst and the radical inhibitor ranges from about 1:1 to about 100:1, such as from about 2:1 to about 50:1, or from about 5:1 to about 20:1.

In some embodiments, a viscosity of the composition is about 50 mPa s or lower, such as about 40 mPa s or lower, about 30 mPa s or lower, about 20 mPa s or lower, about 15 mPa s or lower, about 10 mPa s or lower, about 5 mPa s or lower, about 4 mPa s or lower, about 3 mPa s or lower, about 2 mPa s or lower, or about 1.5 mPa s or lower. In some embodiments, the composition is a resin for 3D printing (such as stereolithography), and the viscosity of the composition is about 5 mPa s or lower, as it is desirable for the resins to flow freely in certain 3D printing applications. In some embodiments, the composition is a resin for polymer casting, and the viscosity can be higher. One of ordinary skill in the art would understand what viscosity ranges are desirable based on the application.

In some embodiments, the composition further includes a third monomer. In some embodiments, the inclusion of the third monomer reduces the viscosity of the composition. In some embodiments, the third monomer includes at least one alkene functional group.

In some embodiments, the third monomer is represented by Formula (III):

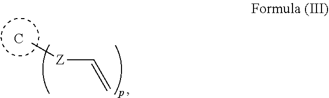

wherein
   [symbol] is C₃₋₂₀ alkyl, C₃₋₂₀ heteroalkyl, C₃₋₂₀ cycloalkyl, C₃₋₂₀ heterocycloalkyl, C₆₋₁₄ aryl, or combinations thereof, each of which is optionally substituted by 1 to 5 groups independently selected from the group consisting of F, Cl, Br, I, OR, OC(O)N(R)₂, CN, NO₂, CF₃, OCF₃, R, N(R)₂, SR, SOR, SO₂R, SO₂N(R)₂, SO₃R, C(O)R, C(O)C(O)R, C(O)CH₂C(O)R, C(O)OR, OC(O)R, C(O)N(R)₂, OC(O)N(R)₂, (CH₂)₀₋₂N(R)C(O)R, (CH₂)₁₋₂COOR, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(O)N(R)₂, N(COR)COR, N(OR)R, C(═NH)N(R)₂, C(O)N(OR)R, and C(═NOR)R;
   each occurrence of R is independently hydrogen, C₁-C₁₀ alkyl, or C₆₋₁₀ aryl;
   Z is a bond, CH₂, or —C(═O)—O*, wherein the O* is attached to the vinyl group; and
   p is an integer ranging from 2 to 10.
   In various embodiments, p is 2, 3, 4, 5, 6, 7, 8, 9, or 10.

In some embodiments, the third monomer does not include an anhydride functional group. In some embodiments, except for the at least one alkene functional group, the third monomer does not include a functional group substantially reactive with the thiol group in the first monomer, such as under the conditions as described in the “Method of Producing Polymer” section herein.” The term “substantially reactive with,” as used in this paragraph, means the two functional groups that react with each other at a level 20% or more, such as 10% or more, 5% or more, 2% or more, or 1% or more of the level the thiol group reacts with the alkene functional group. In some embodiments, the third monomer comprises a diallyl monomer.

Examples of third monomers include:

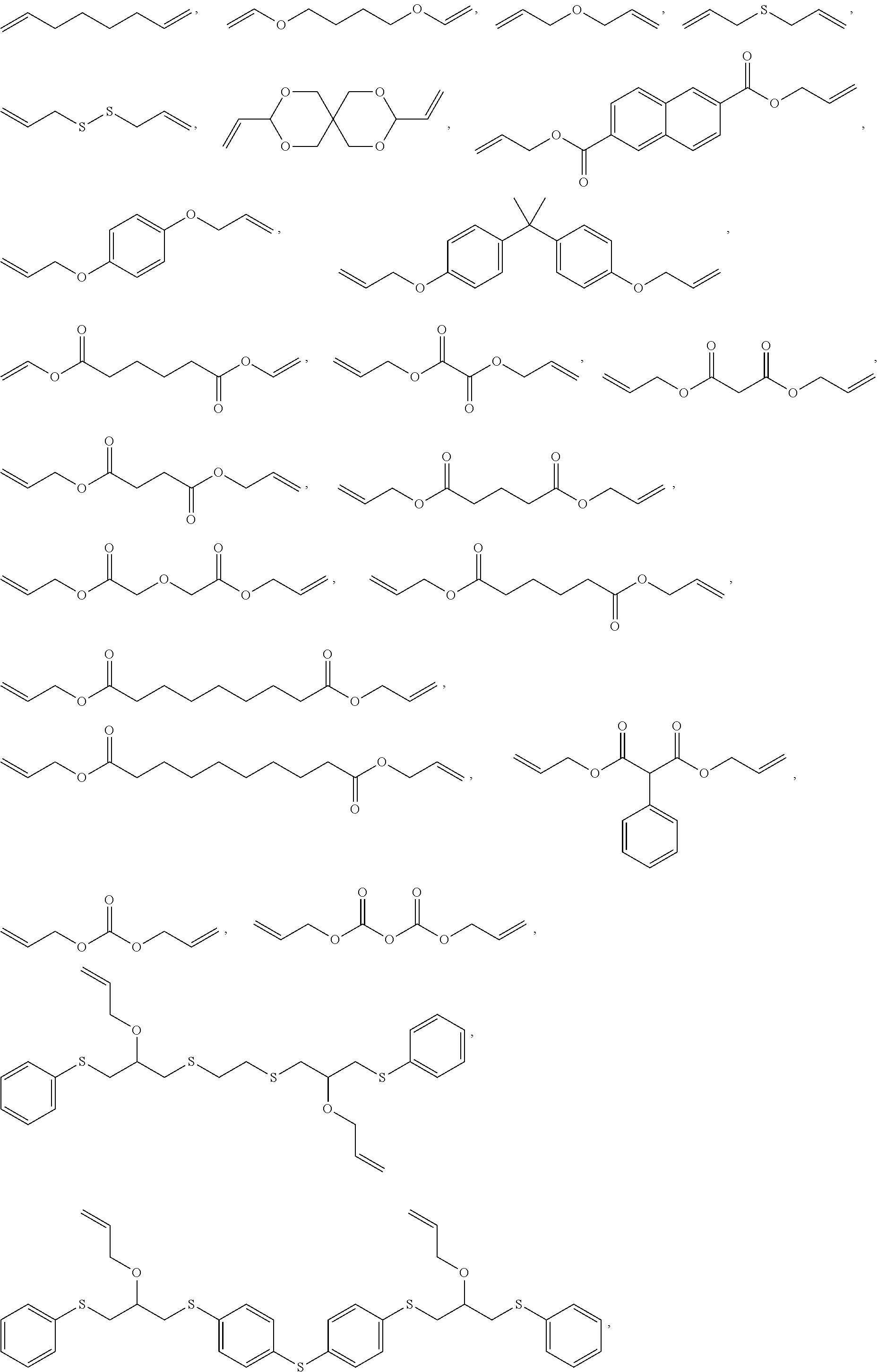

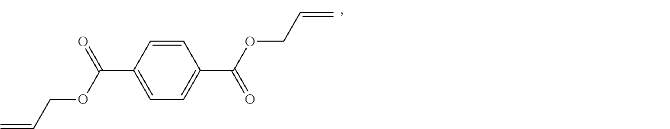 [SMILES: C=CCOC(=O)c1ccc(C(=O)OCC=C)cc1]

and the like.

In some embodiments, an amount of the third monomer ranges from about 10 mol % to about 200 mol %, such as about 15 mol % to about 150 mol %, about 25 mol % to about 100 mol %, about 50 mol % to about 80 mol %, with respect to a total amount of the first monomer and the second monomer.

In some embodiments, the composition further comprises a filler.

### Kits

In some aspects, the disclosure provides a kit comprising the composition described herein and an instructional material comprising instructions for using the composition. In certain aspects, the composition can be any of the compositions described herein.

### Polymer and Object Fabricated from the Polymer

In some embodiments, the instant specification is directed to a polymer or an object fabricated therefrom. In some embodiments, the polymer is a thiol-ene covalent adaptable network (CAN) polymer.

In some embodiments the polymer includes a first repeating unit and a second repeating unit. In some embodiments, the first repeating unit and the second repeating unit are linked through a reversible thioester group formed by a thiol group from the first repeating unit and an anhydride functional group from the second repeating unit, as well as a thioether group from by a thiol group from the first repeating unit and an alkene functional group from the second repeating unit.

In some embodiments, the polymer is a polymer formed by curing a composition the same as or similar to the composition as described in the “Composition for Producing Polymer” section above. In some embodiments, the first repeating unit is derived from the first monomer of the composition. In some embodiments, the second repeating unit is derived from the second monomer of the composition.

In some embodiments, the polymer further includes a third repeating unit. In some embodiments, the third repeating unit bonds with the first repeating unit by a thioether linkage, which is formed by an alkene functional group from the third repeating unit and a thiol group from the first repeating unit. In some embodiments, the third repeating unit bonds with the second repeating unit by an alkyl linkage, which is formed by an alkene functional group from the third repeating unit and an alkene functional group from the second repeating unit. In some embodiments, the third repeating unit is derived from the third monomer of the composition described elsewhere herein, or a similar monomer.

In some embodiments, the polymer further includes a first catalyst, such as as described in the “Composition for Producing Polymer” section or a similar catalyst. As detailed elsewhere herein, the first catalyst allows the formation of the thioester linkage between the first repeating unit and the second repeating unit to be reversed at a relatively low temperature. Therefore, according to these embodiments, the polymer as well as objected fabricated therefrom can be geometrically reconfigured at the relatively low temperature.

In some embodiments, the polymer further includes a deactivated first catalyst. According to these embodiments, if reshaping is not required or no longer required, the first catalyst can be deactivated, such by treating the polymer with acid, to fix the shape of the fabricated object into a permanent one. It should be noted that the term “permanent,” as used herein, does not indicate that the shape of the object cannot be changed again; rather, the term “permanent” merely indicates that the shape of the fabricated object can no longer be easily changed at the relatively low temperature (such as about 60° C. or lower, about 70° C. or lower, about 80° C. or lower, about 90° C. or lower, or about 100° C. or lower) due to the deactivation of the first catalyst. In some embodiments, after first catalyst deactivation, the shape of the fabricated object is able to substantially return to the shape after curing when subjecting the fabricated object to an alleviated temperature (such as about 100° C. or higher, about 110° C. or higher, about 120° C. or higher, about 130° C. or higher, about 140° C. or higher, about 150° C. or higher). In some embodiments, after first catalyst deactivation, the shape of the fabricated object is able to be further reshaped when subjecting the fabricated object to the alleviated temperature.

In some embodiments, the polymer further includes a filler.

### Method of Producing Polymer

In some aspects, the instant invention is directed to a method of producing a polymer, such as a thiol-ene covalent adaptable network (CAN) polymer.

In some embodiments, the method includes providing a composition including a first monomer having at least one thiol group, and a second monomer having at least one anhydride functional group and at least one alkene functional group; and curing the composition.

In some embodiments, the composition is the same as or similar to those as described in the “Composition for Producing Polymer” section herein.

In some embodiment, curing the composition includes reacting the thiol group of the first monomer and the alkene functional group of the second monomer to form the thioether linkages.

In some embodiments, the composition includes a thermal initiator and curing the composition includes applying a heat to the composition. In some embodiments, the composition includes a photo initiator and curing the composition includes irradiates the composition with light. In some embodiments, the light is a visible light or a UV light. In some embodiments, curing the composition comprises exposing the composition to a light having wavelength ranging from about 300 nm to about 500 nm, such as from about 320 nm to about 450 nm, or from about 350 nm to about 410 nm. In some embodiments, curing the composition comprises exposing the composition to a light having an intensity ranging from about 0.1 mW/cm² to about 5 mW/cm², such as from about 0.2 mW/cm² to about 4 mW/cm², from about 0.5 mW/cm² to about 3 mW/cm², or from about 1 mW/cm² to about 2 mW/cm².

In some embodiments, curing the composition includes converting 80% or more, such as 85% or more, 90% or more, 95% or more, 98% or more, or 99% or more of the alkene functional groups in the composition. In some embodiments, a depth of cure of the composition in the polymer is 50 μm or higher, such as 100 μm or higher, 200 μm or higher, 300 μm or higher, 400 μm or higher, 500 μm or higher, 750 μm or higher, or 1 mm or higher. The instant specification describes some examples on how to control the conversion percentage and the depth of cure (see e.g., “Example 1” section). As such, one of ordinary skill in the art would be able achieve conversion percentages and/or cure depths suitable for specific applications by, e.g., modifying the types and/or amounts of the monomers in the composition, modifying the type and/or amount of the second catalyst and radical inhibitor, and/or (in the case that the second catalyst includes a photo initiator,) modifying the wavelength and intensity of the irradiating light without undue experimentation.

### Method of Fabricating Polymer Article

In some aspects, the instant invention is directed to a method of fabricating a polymer article, such as an article of a thiol-ene covalent adaptable network (CAN) polymer.

In some embodiments, the method includes providing a composition including a first monomer having at least one thiol group, and a second monomer having at least one anhydride functional group and at least one alkene functional group; and curing the composition to a predetermined shape.

In some embodiments, the composition is the same as or similar to those as described in the “Composition for Producing Polymer” section herein.

In some embodiments, curing the composition is performed the same as or similar to those as described in the “Method of Producing Polymer” section herein.

In some embodiments, the polymer article is formed to the predetermined shape by a 3D printing technique, such as a stereolithography 3D printing technique, such as a masked stereolithography (MSLA) 3D printing technique. In some embodiments, the polymer article is formed to the predetermined shape by casting.

In some embodiments, the method of fabricating the polymer article further includes heating the cured article to a temperature of about 60° C. or higher, such as about 70° C. or higher, about 80° C. or higher, about 90° C. or higher or about 100° C. or higher, and reshape the cured article.

In some embodiments, the method of fabricating the polymer article further includes deactivating the first catalyst in the polymer article. In some embodiments, deactivating the first catalyst remain in the polymer article fixes the shape of the polymer article in a permanent state. As described elsewhere herein, the term “permanent” does not indicate that the shape of the polymer article cannot be further changed. The term means that further reshaping the polymer article requires subjecting the polymer article to an alleviated temperature (such as 100° C. or higher, 110° C. or higher, 120° C. or higher, 130° C. or higher, 140° C. or higher, 150° C. or higher, 160° C. or higher, or 180° C. or higher).

### Method of Degrading Polymer

In some aspects, the instant invention is directed to a method of degrading a polymer, such as a method of degrading a polymer including a thioester network. The method includes subject the polymer to a solution including a free thiol compound and a catalyst.

Examples of the free thiol compound includes butyl 3-mercaptopropionate (BMP) or the like. Examples of the catalyst include base catalysts, such as triethylamine (TEA) or the like.

In some embodiments, a concentration of the free thiol compound in the solution ranges from about 0.1 M to about 10 M, such as about 0.2 M to about 9 M, about 0.5 M to about 7.5 M, about 1 M to about 5 M, or about 2 M to about 4 M.

In some embodiments, an amount of the catalyst in the solution ranges from about 5 mol % to about 60 mol %, such as about 10 mol % to about 50 mol %, about 20 mol % to about 40 mol %, or about 30 mol % based on a molarity of a solvent of the solution.

In some embodiments, the solvent of the solution includes water. In some embodiments, the solvent of the solution includes an organic solvent. Examples of the organic solvent include acetone or the like.

In some embodiments, the polymer is the same as or similar to those as described in the “Polymer and Object Fabricated from the Polymer” section herein. In some embodiments, the polymer is a polymer that includes thioester functional groups, but lack one or more features as described in the “Polymer and Object Fabricated from the Polymer” section.

In some embodiments, the method further includes recovering a filler from the polymer. In some embodiments, recovering the filler from the polymer includes removing insoluble matters from the degraded polymer and the solution.

### EXAMPLES

The instant specification further describes in detail by reference to the following experimental examples. These examples are provided for purposes of illustration only, and are not intended to be limiting unless so specified. Thus, the instant specification should in no way be construed as being limited to the following examples, but rather, should be construed to encompass any and all variations which become evident as a result of the teaching provided herein.

### Example 1: Photo-Printable Thiol-ene Resin

In the study described in Example 1, an exemplary photo-printable dynamic thiol-ene resin was developed based on commercially available anhydride, thiol, and ene monomers. The dynamic chemistry chosen for this study relied on the thermal reversibility of the in situ generated thioester-anhydride links. The resin's rheological and curing properties were optimized to enable 3D printing using the masked stereo-lithography (MSLA) technique. To achieve a desirable depth of cure of 200 μm a combination of radical photoinitiator (BAPO) and inhibitor (pyrogallol) were used at a weight ratio of 0.5 to 0.05, resulting in more than 90% thiol-ene conversion within 12 s curing time. In a series of stress relaxation and creep experiments, the dynamic reversible exchange was characterized and yielded rapid exchange rates ranging from minutes to seconds at temperatures of 80-140° C. Little to no exchange was observed at temperatures below 60° C. Various 3D geometries were 3D printed, and the printed objects were shown to be reconfigurable above 80° C. and depolymerizable at or above 120° C. By deactivation of the exchange catalyst (DMAP), the stimuli responsiveness was demonstrated to be erasable, allowing for a significant shift in the actuation threshold. These highly enabling features of the dynamic chemistry open up new possibilities in the field of shape memory and 4D printable functional materials.

### Example 1-1: Related Technologies

Fabricating covalent adaptable networks (CANs) with the use of additive manufacturing techniques effectively combines the beneficial features of the two rapidly growing disciplines of materials science and engineering. Such close association of concepts gives rise to a new quality where the creation of complex three-dimensional geometries is achieved with an inherent ability for subsequent changes in shape, functionality, and properties, typically upon application of an external stimulus. In a broader context, achieving new functionality post-printing is referred to as 4D printing as there exists a “fourth dimension”, i.e., the time postponed material activation or actuation step.

The concept of 4D printing involves a wide range of active polymers, including shape memory polymers, hydrogels, and liquid crystal elastomers. The existence of dynamic covalent bonds has implications well beyond these fields and applications. It is in accordance with sustainability demands that are compromised in most nondynamic thermosets. Direct reprocessing and end-of-life depolymerization and recycling, not to mention extended life cycles achieved by self-repair or self-healing, are the attributes of immeasurable impact on the environment. To this end, the reprocessing and self-healing of printed structures can be realized with, for example, the use of transesterification, imine exchange, or Diels-Alder reactions. Many of the transformations of the printed structures can be done with noncovalent interactions, e.g., by introducing ureido-pyrimidinone motifs (UPyMA) capable of hydrogen bonding or by physical phenomena such as stress-driven reshaping resulting from gradient material heterogeneities, or selective removal of monomer from the printed structures. The incorporation of dynamic covalent chemistries (DCCs) is particularly enabling in tuning of the properties and actuation methods. In biomedical fields, the 3D printing of dynamic hydrogels provides opportunities in designing of responsive scaffolds for tissue engineering applications. For example, the dynamic hydrazone chemistry and coumarin [2+2] reversible photoadditions fit the purpose well. Other CANs can be printed incorporating dynamic exchange of imine bonds, urea bonds, trithiocar-bonates, or allyl sulfides. Intricate post-printing transformations are demonstrated with the incorporation of liquid crystal domains to enable dramatic shape-morphing characteristics.

Three-dimensional printing technologies continually evolve to bring innovations to the printing process itself and to the final characteristics of the material and device. These includes the photo-3D printing methods. Digital light processing (DLP) and stereolithography (SLA) are the two 3D photopolymerization techniques, and either one offers advantages for specific printing needs as well as commercially available, low-cost printers. Other methods for the fabrication of complex 3D systems with controllable optical, chemical, and mechanical properties include continuous liquid interface production (CLIP), which achieves high printing speeds as well as eliminates the anisotropy in properties typically seen in layer-by-layer fabricating methods. Two-photon polymerization approaches further allow for high precision in printing of micro- and nanosized objects. The techniques of the photo-printing processes often limit the applicability of photocurable resins to only a particular resin type or affect the achievable resolution of the printed geometries. The majority of photo-printed materials are based on (meth)acrylate or epoxy photopolymerizations.

To further expand the scope of photo-printable and stimuli-responsive resins, the present study as described in the rest portions of Example 1 introduced a thioester-anhydride dynamic reversible chemistry into a thiol-ene photopolymerizable system. The rheological and photocuring properties of elastomeric thiol-ene materials were optimized for masked SLA 3D photopolymerization with visible light. The temperature responsiveness of the dynamic elastomers with introduced compositional variations is quantified in thermally induced stress relaxation and creep experiments. Further, various decorative and functional 3D geometries were printed, and the existence of reversible exchange was explored for material depolymerization and recycling as well as thermal reshaping and shape fixation by the deactivation of the exchange catalysts in the printed objects. Through the catalyst deactivation, the shift in the DCC activation threshold was also demonstrated.

### Example 1-2: Materials and Methods

All chemicals were purchased from common suppliers (Sigma-Aldrich, Fisher Scientific, Bruno Bock, Alpha Aesar) and used as received. Radical photoinitiators and inhibitors: 2,2-dimethoxy-2-phenylacetophenone (DMPA), phenylbis(2,4,6-trimethylbenzoyl)phosphine oxide (BAPO), and pyrogallol (PYR). Reactants and monomers: (99%) allyl succinic anhydride (ASA) (98%), trimethylolpropane tris(3-mercaptopropionate) (TMPTMP), 1,6-hexanedithiol (HDT), 1,3,5-triallyl-1,3,5-triazyne-2,4,6-trione (TTT), diallyl carbonate (DAC), allyl ether (AE), diallyl terephthalate (DATP), hydrochloric acid (37%), and sulfuric acid (98%). Organic catalysts and solvents: methylene chloride (DCM), acetone, and 4-dimethylaminopyridine (DMAP).

### Sample Casting and Depolymerization

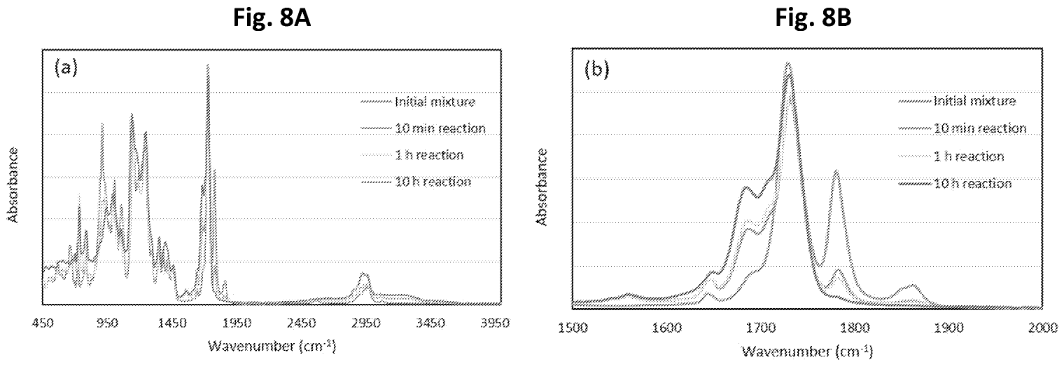

The reactants (allyl anhydride, thiol, and/or diallyl) were mixed at room temperature and the catalyst/photoinitiator/inhibitor mixture was added in a DCM solution. After 10-30 min of initial reaction, the solvent was removed in vacuo, and the mixture casted between glass slides separated by spacers (typically 250 μm thick). After 1 h of the thiol-anhydride reaction, the mixtures were exposed to UV irradiation at 0.5 mW/cm² (365 nm) or visible light irradiation (0.5 mW/cm², 405 nm) to form cross-linked dynamic networks. The first-step thiol-anhydride reaction was carried out for an extended time prior to photocuring to allow for maximum attainable thioester formation. The initially rapid ring opening reaction decelerates significantly with increasing viscosity and reaches around 85% conversion in 1 h reaction time (FIGS. 8A-8B). The extent of anhydride ring opening reaction was monitored by ATR-IR spectroscopy. Depolymerization was achieved by gradually reacting the dynamic polymer with a fresh mixture of excess monomers (typically equivalent amount/weight in respect to the amount of recycled material) at 120° C. for up to 30 min. After complete solubilization, additional amounts of DMAP, and photoinitiator were added in DCM. The total DMAP concentration in the recycled samples was 5 mol % with respect to the thioester content.

### DCC Deactivation

Photopolymerized samples and/or the printed objects were swollen in acetone for 10 min. After swelling, which resulted in around 10 wt % sample mass increase, the samples were kept in a hydrogen chloride atmosphere for 30 min. The HCl_{(g)} was generated by adding dropwise hydrochloric acid into sulfuric acid. After 30 min of contact with HCl_{(g)}, the samples were directly used for testing. The 3D prints were dried for another 30 min at 60° C.

### Shape Reconfiguration

The 3D prints were deformed to the desired new shapes, and while at constrained configurations exposed to elevated temperatures (85, 120, and 140° C.) for a given amount of time (30 min.). After the constraint was removed, the final shapes in the new configurations were obtained.

### Fourier Transform Infrared Spectroscopy

Sample conversions were analyzed using an FT-IR spectrometer (Nicolet 8700) equipped with an ATR accessory. Monomer mixtures were deposited on the ATR crystal window, whereas the 250 μm thick films were pressed against it before scanning. Uncured resin mixtures and photocured samples of fixed geometries (5 mm/15 mm/0.25 mm) were surface-analyzed in ATR-IR where the highest peak absorbance was set to 0.6. Real time conversion analysis was performed in a horizontal transmission apparatus where the liquid samples were continually scanned during UV and visible light exposures at 0.5 mW/cm² (365 and 405 nm) for 5 min. The final double bond conversions were calculated from the absorbance peak area of the vinyl functional group, around 6120 cm⁻¹ in the near-infrared spectrum.

### Dynamic Mechanical Analysis (DMA), Stress Relaxation, and Creep

The glass transition temperature (T_{g}), storage modulus (E′), loss modulus (E″), and tangent δ were determined on a Q800 DMA (TA Instruments) using a ramp rate of 3° C./min and a frequency of 1 Hz, with a fixed oscillatory strain of 0.01% and a preload force of 0.002 N. Stress relaxation experiments were performed in tensile elongation mode using a Q800 DMA instrument. The built-in stress relaxation DMA setting was used, with a 5-8% maximal strain and an initial strain rate of 1%/s at a fixed temperature. Rectangular samples of the dimensions 10/4/0.20 were used. Creep tests were performed in tensile elongation mode. A constant stress was applied at fixed temperatures, and the strain was monitored for 10-30 min. Depending on the temperature, a stress of 100 to 600 kPa was applied which resulted in 2-15% initial sample elongation. The resin viscosities were measured using ARES G2 Rheometer (TA Instruments) with a 200 s⁻¹ shear rate and operating gap of 0.2 mm.

### 3D Printing

A Prusa SL1 3D printer was used to create the layer-by-layer projected geometries. It utilizes the masked SLA technique with an LED array as its light source and an LCD photomask to shape the light image from the LED array. The image is digitally displayed across the platform and is similar to single image projections from a DLP-SLA technique. The nominal light intensity was 0.4 mW/cm² at the surface of the window, whereas the wavelength was 405 nm. The photo-printed objects were washed with acetone and subsequently flood-cured at 10 mW/cm² with a broad range UV light for 5 min.

### Example 1-3: Results

Thioester-anhydride based CANs were fabricated with the use of various commercial and synthetic anhydrides and multifunctional mercaptopropionates. This new dynamic chemistry has been shown to have highly tunable reversible exchange characteristics. The thioester-anhydride networks were synthesized by a direct ring opening reaction of the anhydride and thiol reactants. The process was facilitated by inclusion of catalysts (bases and nucleophiles) and was found to be reversible at elevated temperatures, typically above 80° C. Among various types of thioester-anhydride materials examples of thiol-ene photopolymers were also shown. Herein, the thioester-anhydride photopolymer CANs were developed for additive manufacture using the masked stereo-lithography (MSLA) photo-printing technique. Allyl succinic anhydride (ASA) was initially reacted with trimethylolpropane tris(3-mercaptopropionate) (TMPTMP) in a mixture with a 2:1:1 stoichiometry of thiol to ene to anhydride functional groups (FIGS. 2A-2B).

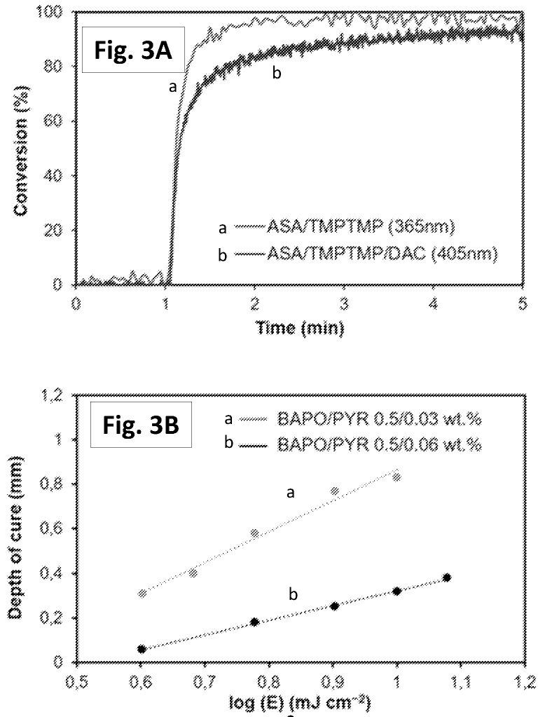

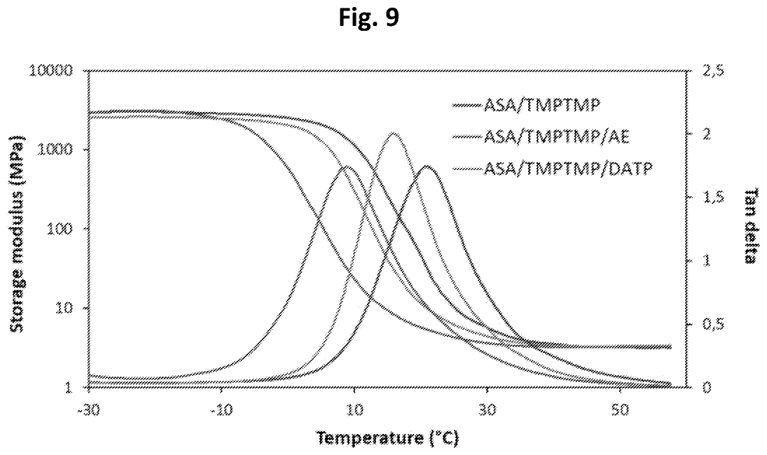

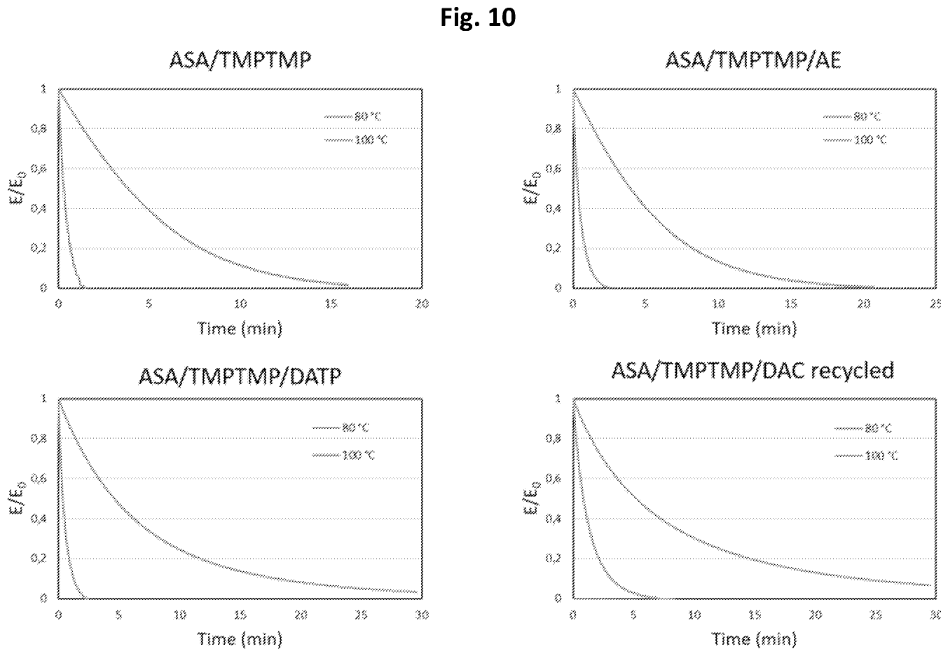

The initial resin mixture was characterized for its reaction kinetics (FIG. 3A), and the resultant CAN was analyzed in DMA (FIGS. 9 and 10, Table 1). Inherently necessary in 3D photopolymerizations, the thiol-ene resin requires relatively low viscosity (<5 mPa s) and rapid reaction kinetics, even at low light intensities (0.5 mW/cm²). However, the anhydride ring opening increases the mixture viscosity due to the formation of oligomeric species as well as the release of free carboxylic groups (FIGS. 2A-2B). To facilitate 3D printing, an attempt was made to modify the viscosity by inclusion of less viscous diallyl monomers. Accordingly, diallyl carbonate, allyl ether, and diallyl terephthalate were preselected and used with ASA and TMPTMP at a molar ratio of 2:2:1 of TMPTMP, ASA, and diallyl monomer, respectively. As predicted by the Flory—Stockmayer gelation theory, the gel point conversion of TMPTMP and diallyl at a molar ratio of 2 to 1 would be 1.22. Thus, no gelation would be expected. As such, in the presence of ASA, complete depolymerization, and in consequence, 100% stress relaxation, will be enabled. The inclusion of low viscosity alkenes reduced the viscosity by close to 1 order of magnitude (Table 1).

TABLE 1

| | | | Relaxation |
|---|---|---|---|
| | Viscosity | Tg | time at e⁻¹ |
| Resin | (mPa s) | (° C.) | (100° C.) |
| ASA/TMPTMP | 11.8 (0.5) | 21 (2) | 26 s (—) |
| ASA/TMPTMP/AE | 1.2 (0.1) | 9 (1) | 30 s (—) |
| ASA/TMPTMP/DATP | 1.6 (0.1) | 16 (1) | 32 s (—) |
| ASA/TMPTMP/DAC | 0.6 (0.1) | 12 (2) | 55 s−1 min 10 s |

^{a}SD values are in parentheses.

Although all three monomer modifications meet the initial viscosity criteria, the one with diallyl carbonate exhibited the lowest viscosity, and consequently, this resin was chosen for further optimization and 3D printing. There are examples of thiol-ene and thiol-yne photo-polymerizations adapted for additive manufacture techniques. Thiol-ene resins are characterized by rapid kinetics, which makes them excellent precursor components for photopolymer materials. The downside is that such resins tend to react spontaneously and therefore show poor storage stability. In photo-3D printing methodologies, to achieve a desired curing depth, researchers typically use light absorbers or radical inhibitors. While enabling a controllable depth of cure, the inhibitors also improve the stability. The shelf life of thiol-ene systems is effectively extended in mixtures with secondary mercaptopropionates, and by adding radical inhibitors such as pyrogallol (PYR), often used with phosphoric acid coadditives. Another consideration is the extent of cure, which can be compromised in stabilized mixtures, even to the point of entirely disabled gelation. Consequently, a kinetic and depth of cure vs. photodosage (E) study was conducted to optimize the curing behavior required in a specific MSLA printer (PRUSA SL1, visible light 0.4 mW/cm²). BAPO (0.5 wt %) and pyrogallol were used as the visible light initiator and the inhibitor, respectively. In FIG. 3B, the depth of cure as a function of dose is plotted for the two concentrations of the inhibitor (0.03 and 0.06 wt %). It is evident that different curing depths are reached with the same doses of light depending on the inhibitor loading. For example, to achieve a desired depth of cure of 200 μm, a dose of 6 mJ cm⁻² is required at 0.06 wt % PYR loading which corresponds to 15 s irradiance time. To reduce further the exposure time from 15 to about 11-12 s for the targeted depth of cure, so as to avoid an overexposure, the pyrogallol amount was reduced from 0.06 to 0.05 wt %. This initiator/inhibitor ratio allowed for acceptable conversion (90%), which is well above the gelation point of the cross-linked system, at low light intensities as evidenced by the relevant kinetic profile in FIG. 3A.

Having adjusted the resin curing parameters for the masked stereo-lithography (MSLA) printer of choice, various decorative objects and functional shapes were conveniently photo-printed as displayed in FIGS. 4A-4D. Relatively small objects were printed with the purpose to shorten the printing time and reduce the resin volumes required. For example, the time required to print the structure in FIG. 4A was 46 min (250 layers), whereas it took 28 min to print the ring in FIG. 4B (160 layers). No visible shape distortions resulting from the volumetric shrinkage were noticed in the printed objects, which was attributed to the relatively low concentrations of photopolymerizable groups (1 mol of allyl per 407.1 g of resin) and the step-growth polymerization mechanism.

The dynamic behavior of the thioester-anhydride CANs depends on the catalyst type and loading and that selected catalysts differently affect the exchange mode. It was argued that bases in systems with excessive thiol functionalities may additionally enable associative thiol-thioester exchange, whereas nucleophiles would bias dissociative ring closure and thiol regeneration in stoichiometric systems (FIG. 2A). Herein, DMAP was used as the reversible exchange catalyst because of its favorable characteristics, i.e., good solubility, nonvolatility, catalytic effectiveness, and stable response over time. Having a nucleophilic character and relatively low pKa (˜9.6), DMAP would be primarily dictating the reversible exchange mode.

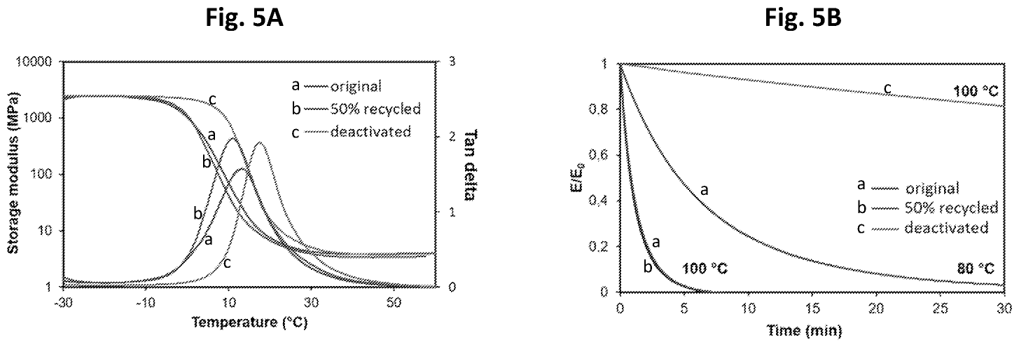

The dynamic properties of the 3D printable material were assessed in thermomechanical and stress relaxation experiments. In FIGS. 5A-5B, the DMA data and stress relaxation curves are presented for the optimized formulation after curing.

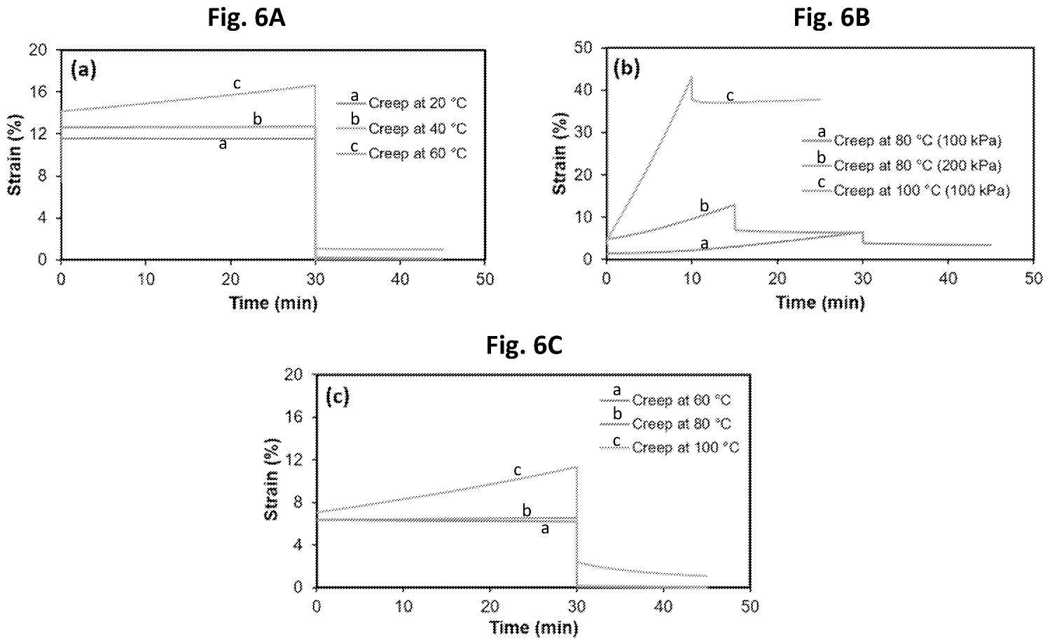

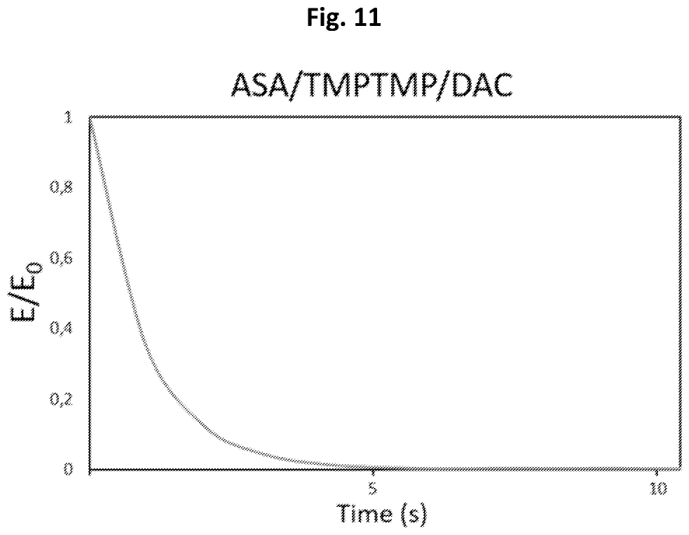

There are three DMA profiles in FIG. 5A that correspond to originally made, fresh CAN sample; a photopolymer sample that has been recycled and contains 50% of the recycled material; and a sample where the catalyst was deactivated by treatment with HCl gas (see Example 1-2 section for details). It is evident that the original and partially recycled samples are almost identical in their thermomechanical characteristics. Also, the samples with the deactivated catalyst exhibit similar DMA profiles, i.e., the glassy storage modulus, the rubbery storage modulus, and Tg are all close to other samples where the catalyst remains active. The DMAP, being mildly basic, is assumed to be deactivated through the acid-base association with HCl_{g} because of the significant differences in pKa values. The presence of ionic or ion pair species in the network after deactivation seems to reinforce its structure to an extent as seen in the narrowing of the tan delta and a slight shift in the Tg. DMAP can have a plasticizing effect on the polymethacrylate thioester-based networks. However, when its nucleophilic attraction toward thioester carbonyls is broken down by deactivation, some reinforcing of the network would be expected. More importantly, the fabricated photopolymer was highly dynamic and capable of 100% stress relaxation in around 6 min at 100° C. (FIG. 5B). This relaxation time still be reduced to seconds at higher temperatures (FIG. 11). As seen from FIG. 5B, the recycled material exhibits an identical stress relaxation rate, pointing to a stable response over time and overall good repeatability. On the other hand, the catalyst deactivation resulted in drastic reduction of the material's dynamic response and stress relaxation capabilities. After deactivation the thioester-anhydride CAN dissipates only around 20% of the externally imposed stresses in 30 min at 100° C. Such means of control over the dynamic responsiveness is a very useful feature as is demonstrated further in the present study. Before the demonstration of the thermally induced responsiveness of the functional 3D prints, the creep data were collected and compared, especially between the dynamically active and inactive materials (FIGS. 6A-6C).

As shown in FIG. 6A, there is little to no creep observed in the CAN system studied at temperatures below 60° C. This is a temperature range where the network is constantly above its glass transition with no mobility restrictions on the functional groups or network chains and dynamic links. Yet, in the time scale of the experiments, at up to 40° C., the material completely recovers its original shape (length). There is, however, close to 2% permanent deformation seen after 30 min at a constant stress at 60° C. Above 80° C. the material becomes highly dynamic, and at 100° C. creep is so significant that the material rapidly adapts to nearly any stress induced deformation (FIG. 6B). Finally, the process of exchange deactivation shifts the network rearrangement activation threshold up by around 40° C. Such a conclusion is made by comparing the creep profiles at 60 and 100° C. in FIG. 4A and 4C. In either case, similar strain loss is observed after the stress is released. Importantly, there is no visible activity of the DCC at 80° C., where 100% of stress-induced strain is recovered.

Having determined the full potential for reversible exchange of the thioester-anhydride CANs, the 3D printed structures were then used for shape reconfiguration to illustrate the effectiveness and usefulness of such thermal responsiveness in these materials. Round and square-shaped objects were deformed at 85° C. for 30 min, resulting in new permanent shapes as illustrated in FIGS. 7A-7B. Once formed, the new shapes were geometrically reconfigured again as shown in a second reshaping cycle in FIG. 7B. Importantly, when the DCC is deactivated, subsequent reconfiguration in shape is no longer possible at temperatures below 100° C., and thus the fixed geometries remain stable and permanent. However, by increasing the temperature activation threshold to 140° C., a complete shape restoration to its initial geometry was rendered within the 30 min of thermal annealing. The current approach appears to be one rare example of behavior where the DCC thermal activation is conveniently changed without any significant or detrimental effects on the network properties. The geometries of printed materials are facilely remodeled while having the ability to readily change the thermal activation threshold.

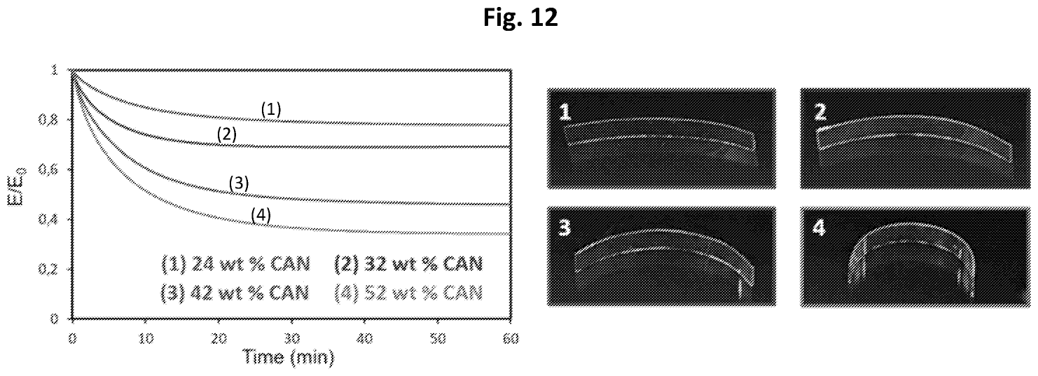

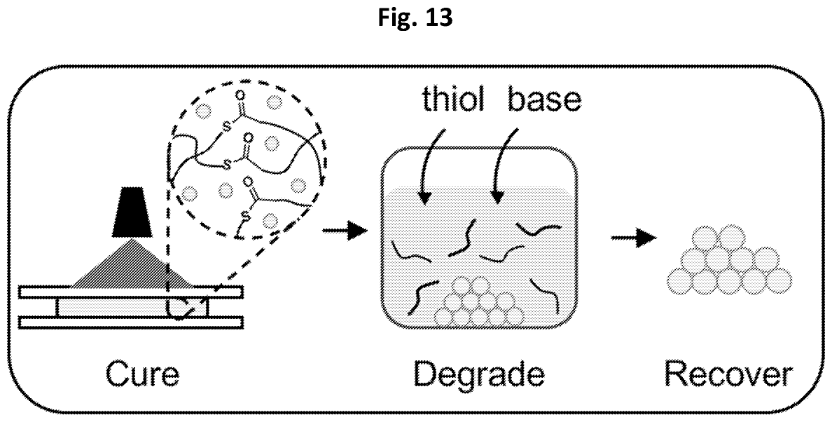

Partial shape reconfiguration was also demonstrated in semi-dynamic materials that were made by recycling the dynamic 3D printed components in a nondynamic thiol-ene resin (FIG. 12). Prior to photocuring, the dynamic material was depolymerized in a dithiol followed by thiol-ene reaction with stoichiometric amount of the triene (TTT). Depending on the weight ratio of the dynamic CAN in a recycled photopolymer, various degrees of shape reconfigurations were thus achieved. This last demonstration serves as an example of convenient reprocessing of the 3D printed CAN through depolymerization and subsequent reuse in a form of mechanically distinct material with a varied degree of thermal responsiveness.

### Example 1-4: Summary of Example 1

A thioester-anhydride thiol-ene photopolymer resin was developed from commercially available monomers and the resin's rheological and curing properties were optimized for masked stereo-lithography (MSLA) printing under visible light. The stimuli responsiveness of the CAN material was tested in DMA stress relaxation and creep experiments providing rapid response at elevated temperatures (above 80° C.) and little to no response at temperatures below 60° C. The activation threshold of the reversible exchange was shown to be controllable allowing for the shift in the actuation temperature by up to 40° C. Such a degree of modulation or change in accessible activation mode resulted in 3D printed structures with variable thermal stabilities of their geometries depending on whether the DCC catalyst remained active or was rendered inactive.

### Example 2: Controlled Degradation of Thiol-ene Resin

The study as described in Example 2 examined and quantitatively predicted degradation of thioester-containing networks facilitated by base-catalyzed thiol-thioester exchange. A statistical model was developed that incorporated polymer structure, thiol-thioester exchange reaction kinetics, and mass gain resulting from dynamic bond exchange and this model was compared to mass loss studies. Experimental results matched model predictions, showing degradation times could be controlled from 2.5 to 12 hours with optimal conditions by varying the free thiol butyl 3-mercaptopropionate concentration from 0.0 M to 4.9 M and the base-catalyst triethylamine molar ratio from 0 to 40 mol %. Furthermore, thioester-based composite materials were formed by SLA 3-D printing and subsequently degraded, achieving 91% recovery of the composite filler. This work provides insight into thioester facilitated degradation and its future use in selective material release or encapsulated filler recovery applications.

### Example 2-1: Related Technologies

Waste from slowly-degrading polymers requires considering the wholistic lifecycle of manufactured plastics. Polymers which cannot degrade rapidly or be recycled pollute the environment, leading to an increased focus on designing multi-use or on demand degradable plastics. Polymer composites that cannot degrade must be scrapped, leading to the loss of both specially synthesized chemical components and valuable fillers used to make these composites.

One subset of polymers, thermosets, are particularly difficult to degrade but have advantageous material properties. Thermosets are composed of covalent chemical crosslinks that enable dimensional stability, solvent resistance, and temperature resistance. However, the non-reconfigurability of these permanent crosslinks limits recyclability or reuse and further inhibits degradation. Covalent adaptable networks (CANs) offer an effective way to reuse thermoset polymers by having crosslinks with triggerable, dynamic bonds. Rearrangement of these dynamic bonds allows reprocessing of thermosets, and different dynamic chemistries use different stimuli to induce network rearrangement, for example, by exposure to heat or light. CANs enable thermoset degradation. However, it remains a challenge to quantitatively predict degradation behavior, limiting their application in larger scale processes such as stereolithography (SLA) additive manufacturing. SLA uses light to cure liquid monomers layer-by-layer to form a 3-D object. While a variety of dynamic chemistries, such as transesterification, disulfide metathesis, and trithiocarbonate addition-fragmentation have been SLA 3-D printed, little work has been done to explore the degradation process of these printed CAN-based polymers.

Degradation in CANs refers to the permanent cleavage of crosslinks in a network, which leads to the formation of detached monomers and a reduction in mass as the increasing sol fraction comprised of monomers and oligomers leaves the network. This degradation process has two limiting extremes: surface and bulk degradation. Surface degradation is a diffusion-limited process where crosslinks are cleaved only on the surface of a bulk polymeric object, gradually shrinking the material from the outside until the entire network dissolves into solution. Conversely, bulk degradation is a reaction-limited process where crosslinks are cleaved throughout the entire polymer network simultaneously, until the reverse gelation point is reached and the material depolymerizes and fully dissolves into solution. Often, degradation of a polymer network is a combination of both surface and bulk mechanisms.

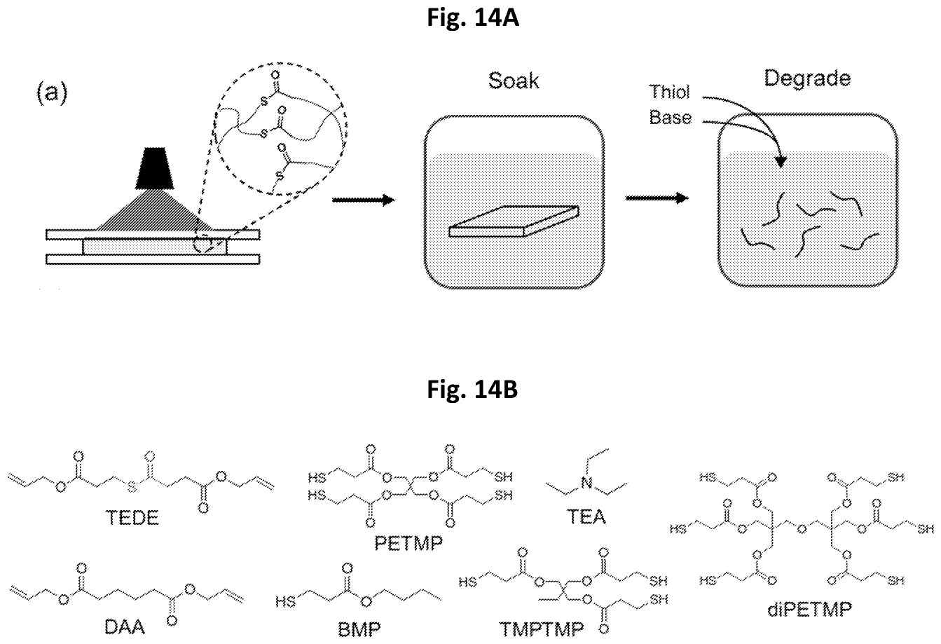

Of the various dynamic chemistries, degradation studies on thioester-containing networks offer wider understanding of network architectures due to thioesters being compatible with existing thiol-x chemistries. Dynamic bond rearrangement in thioester-containing CANs comes from the thiol-thioester exchange reaction, which may occur through either a base- or a nucleophile-mediated pathway. While other thiol-based dynamic chemistries have been used to create dynamic networks, such as Meldrum's acid systems and thiol-yne systems, thiol-thioester exchange is attractive due to its highly selective reactivity with thiols, efficiency with mild bases, stability in aqueous solutions, and inherent biocompatibility as a common biosynthetic pathway. While thioester networks degrade efficiently (FIGS. 14A-14) and may be SLA 3-D printed, the process and time scale for degradation of these structures is unknown.

A bulk degradation model for CANs is missing, and this model would more accurately capture the relevant degradation processes of CANs with thinner cross-sectional areas, such as those formed in 3-D printed parts. The understanding of bulk degradation of thermosets based on hydrogels provide insightful models, but are not applicable to more hydrophobic or more crosslinked bulk CANs which may experience significantly reduced swelling. To this end, a bulk degradation model of thioester-based CANs would both investigate the degradation processes particular to thiol-thioester exchange and also widen the scope of degradation models applicable to CAN chemistries.

The study as described in Example 2 investigates the degradation process and time scale that thiol-thioester exchange enables in cast and 3-D printed networks. As such, a statistical kinetic model for bulk degradation of thioester networks was generated which combined the thiol-thioester exchange reaction kinetics, mass gain resulting from thiol-thioester exchange, and the structure of the polymer network being degraded. Mass loss experiments verified model predictions for how the concentration of free thiol, relative mol percent of base catalyst, and monomer functionality all impacted mass loss rates. Lastly, 3-D printed and degraded thioester composites matched model predictions for degradation time of 3-D printed samples and showed the effectiveness of using thioester degradation to selectively recover composite fillers. The understanding of thiol-thioester facilitated degradation gained in this work enables the implementation of degradable thioester systems for recycling and selective material recovery applications in additive manufacturing specifically and in composite materials generally.

### Example 2-2: Materials and Methods

### Materials

A previously reported procedure was used to synthesize the thioester monomer TEDE (Worrell et al., Nat. Commun. 2018, 9 (1)). All other materials used were purchased commercially and used without further purification. 3-mercaptopropionic acid (3-MPA), allyl alcohol (AA), butyl 3-mercaptopropionate (BMP), trimethylpropane tris(3-mercaptopropionate) (TMPTMP), p-toluenesulfonic acid (pTsOH), pentaerythritol tetrakis(3-mercaptopropionate) (PETMP), and crosslinked poly(styrene-co-divinylbenzene) microspheres (6-10 um) were purchased from Sigma Aldrich. Diallyl adipate (DAA) and succinic anhydride (SA) were purchased from TCI Chemicals. 4-dimethylamino-pyridine (DMAP) was purchased from Oakwood Chemical, dipentaerythritol hexakis(3-mercaptopropionate) (diPETMP) from Bruno Bock Chemische Fabric, and Irgacure 819 (I819) from IGM Resins.

### Thin Film Preparation and Degradation

To prepare thioester films, one thiol and one ene monomer were combined with 1-819 and pyrogallol in a molar ratio of 1 thiol: 1 ene: 0.5 wt % I819: 0.06 wt % pyrogallol, loaded between glass slides spaced 100 μm apart, and irradiated to complete conversion (405 nm, 30 mW/cm², 5 minutes). Samples were then trimmed to a length and width of 25 mm, with an average weight of 100 mg, and used for further experiments.

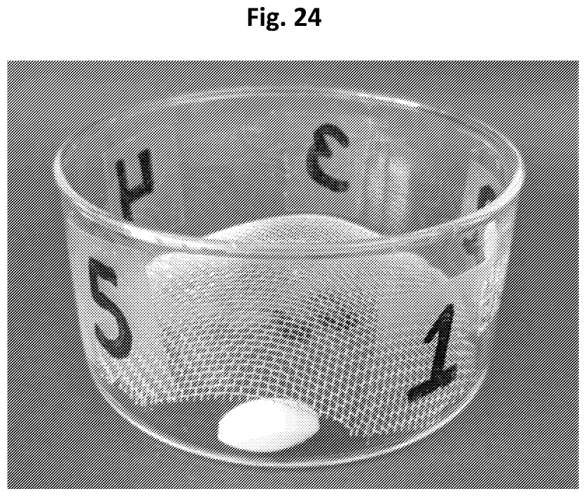

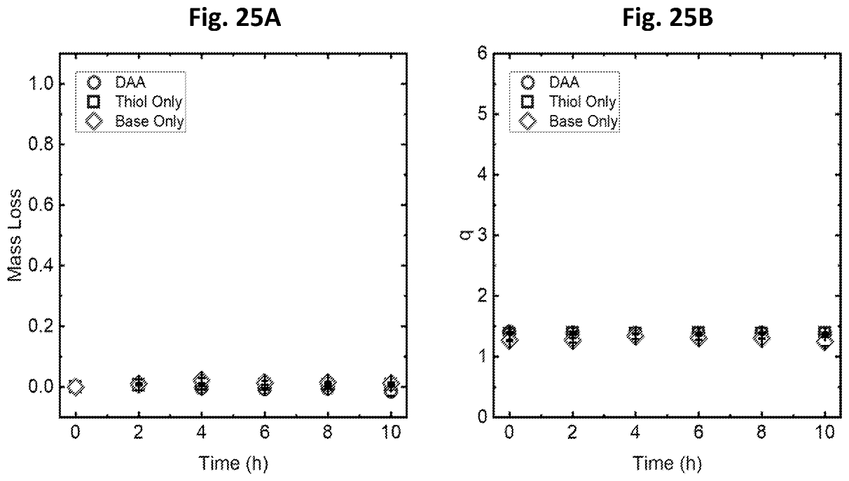

The initial mass of each film was recorded, mₒ, then samples were allowed to swell in a solution of BMP and acetone overnight, with the concentration of BMP set by the degradation conditions. Films were then transferred to a constructed apparatus composed of a covered 100×50 mm Pyrex Petri dish, a stir bar spun at 400 RPM, and a steel grid which let degradation solution flow above and below the films (FIG. 24). TEA was added to initiate degradation, then films were removed at specific times and patted dry with a Kimwipe. Films were then soaked in acetone overnight, dried in a vacuum oven at 50° C. for 24 hours, and weighed again to measure the final dry mass, m_{final}. Experimental mass loss was calculated by

$${ML}_{exp} = \frac{{m}_{o} - {m}_{final}}{{m}_{o}} \qquad ( 1 )$$

### 3-D Printing and Filler Recovery

Samples were 3-D printed on a Prusa SL1 masked-SLA 3-D printer, washed with dichloromethane, and air dried for 30 minutes. Printed resins contained a molar ratio of 1 thiol: 1 ene: 0.5 wt % 1819: 0.06 wt %. Thioester composites contained 80 wt % resin and 20 wt % poly(styrene-co-divinylbenzene) microspheres. Exposure times and EcDp values for 3-D printed parts are listed in Table 2 below:

TABLE 2
3-D printing parameters used to print thioester (TEDE-PETMP),
control (DAA-PETMP), and thioester composite (TEDE-PETMP-20
wt % PS) rings on a Prusa SL1 3-D printer

| Material | Initial layer time (s) | Other layer time (s) | Layer Height (μm) | ${E}_{c} ( \frac{mJ}{{cm}^{2}} )$ | D_{P} (μm) |
|---|---|---|---|---|---|
| Thioester | 35 | 10 | 100 | 1.7 | 335 |
| Control | 35 | 13 | 100 | 1.5 | 453 |
| Composite | 35 | 12 | 100 | 1.6 | 478 |

3-D printed composites were placed in a solution of 2M BMP and 30 mol % TEA in acetone, and allowed to stir overnight to recover the microspheres. Acetone was added at twice the volume of the initial solution, and the mixture was centrifuged at 1000 RPM for 2 minutes. The settled microspheres were then redispersed in pure acetone, centrifuged again at 1000 RPM for 2 minutes, and dried in a vacuum oven at 50° C. for 24 hours.

### Dynamic Mechanical Analysis

An RSA-G2, from TI Instruments, was used for dynamic mechanical analysis (DMA). Samples were heated from −50° C. to 50° C., with a ramp rate of 3° C./minute and a frequency of 1 Hz. Samples were run in tension with a strain of 0.03% and a preload force of 0.34 N. The T_{g} was determined as the peak of the tan delta curve. The molecular weight between crosslinks, M_{c}, was calculated from DMA data via

$${M}_{c} = \frac{3 ρ {RT}_{min}}{{E}_{r , min}} \qquad ( 2 )$$

where ρ stands for polymer density and was assumed to be constant at 1,100 kg/m³, R for the universal gas constant, E_{r,min} for the minimum storage modulus value just as the polymer enters the rubbery plateau, and Tₘᵢₙ for the temperature in Kelvin where E_{r,min} is reached.

### Model Development

Modeling bulk degradation of an ideal step-growth polymer network containing thioester linkages required examination of the step-growth network structure and the reaction kinetics of thiol-thioester exchange. The approach used here was modified from Rydholm et al. (Polymer (Guildf). 2007, 48 (15), 4589-4600) which in turn was based on step-growth network formation equations first proposed by Macosko and Miller (Macromolecules 1976, 9 (2)) .

### Structure Component of Model

For an ideal step-growth network with monomer functionality Z, each arm of the multifunctional monomer unit is detached from or attached to an infinite network with probability y or l-y, respectively. Detachment from the network can occur in two ways. The first is via cleavage of the thioester bond from an adjacent multifunctional monomer unit through the thiol-thioester exchange reaction. This occurs with a probability P, the fraction of thioester bonds that have been cleaved. The second is via detachment of an adjacent monomer unit. Given that the connecting thioester bond is not cleaved, an arm can be detached from the infinite network if the neighboring multifunctional monomer unit has all its remaining arms detached from the network. This provides an equation for the probability of arm detachment as a function of the thiol-thioester exchange and network connectivity: y=P (1−P)y^{Z-1}(3), where y is the probability that an arm of a multifunctional monomer unit is detached from the network; P is the probability that a thioester bond has cleaved which is dictated by the thiol-thioester exchange kinetics; and Z is the number of functional groups on a monomer. Recognizing that y=1 is always a solution to equation 3, the factor y−1 can be removed from the equation, leaving a general equation in y, for Z>2:

$${\sum }_{k = 1}^{Z - 2} {y}^{k} = \frac{P}{1 - P} \qquad ( 4 )$$

The general equation predicts a critical value for P (P_{c}) above which y=1 and the polymer network shifts from an infinite network to finite, soluble components. This value of P_{c} corresponds to the point of reverse gelation, given by:

$${P}_{c} = \frac{Z - 2}{Z - 1} . \qquad ( 5 )$$

The value of P_{c} from equation 5 agrees exactly with the Flory prediction for reverse gelation of a stoichiometric reaction of monomers with functionality Z (See “Comparison of P_{c} With Flory Prediction” section below).

### Comparison of P_{c} With Flory Prediction

### Flory Prediction

According to Flory,¹² for a polymer composed of monomers with functionality f, the critical conversion at which gelation occurs, P_{gel}, is described by:

$${P}_{gel} = \frac{1}{f - 1} = 1 - {P}_{c , rev gel} ,$$

where P_{c, rev gel} is the critical conversion for reverse gelation. Recognizing that f=Z in this study, the equation can bell P_{c}:

$${P}_{c} = \frac{f - 2}{f - 1} = \frac{Z - 2}{Z - 1} .$$

### Model Prediction

From the derived model, equation 4 details y as:

$${\sum }_{k = 1}^{k = Z - 2} {y}^{k} = \frac{P}{1 - P} .$$

Reverse gelation occurs when every arm is detached from the infinite network, or when y=1 and P=P_{c}. Putting y=1 in the left-hand side and summing from 1 to Z−2 provides a simple closed form:

$$Z - 2 = \frac{{P}_{c}}{1 - {P}_{c}} .$$

Solving this equation for P_{c} gives the same prediction for reverse gelation as Flory theory.

### Mass Loss from y, P, and Network Properties

Maximum percent mass loss in such a system is given by the sum of the mass fractions of all degradable units in the network multiplied by the fraction of those units that have separated from the network: MLₘₐₓ=ΣᵢWᵢFᵢ (6), where Wᵢ is the mass fraction of degradable component i in the network and Fᵢ is the fraction of those components that have separated from the network. In the ideal step-growth network examined, the entire mass of the network consists of one type of repeat unit: multifunctional monomer units with thioester linkers between them. This results in the mass fraction of these units in the network to be one, or Wᵢ=1. The fraction of these multifunctional monomer units that have detached from the infinite network is the fraction of units that have all arms, i.e. Z number of arms, detached. This results in a fractional mass loss equation for an ideal step-growth network: MLₘₐₓ=y^{z} (7), where y^{Z} represents Fᵢ, the proportion of multifunctional monomer units that have detached from the network.

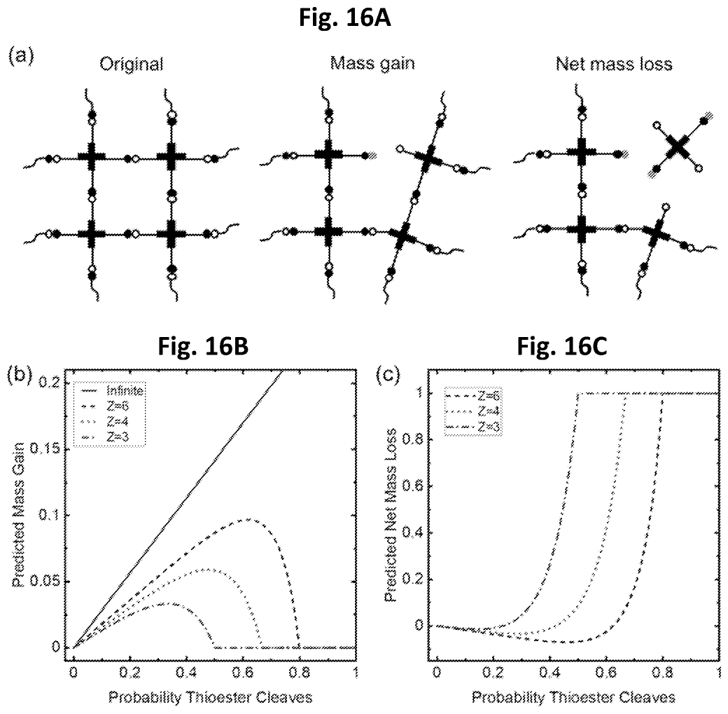

Early in the degradation process, however, mass gain as a function of the degrading thiol molecular weight is expected. As thioesters become cleaved, there is a net mass gain of the excess monofunctional thiol used for degradation as these molecules add to the network (FIG. 16A, middle). This mass adds to the overall network until the arm containing that thioester is detached from the network (FIG. 16A right). To account for this effect, a parameter q is defined to be the fraction of thioesters that have been cleaved but are still attached to the network, where: q=½P(1−y^{Z-1})(8). This relationship represents the probability that a thioester has cleaved (P) and that at least one of the other arms of the multifunctional monomer unit remains attached. The prefactor ½ is necessary because only half of the dangling ends formed via thioester cleavage contribute to the mass gain. A detailed derivation for equation 8 can be found in the “Derivation of q” section below.

From q, the total number of thioester bonds that have been cleaved but are still attached to the network can be calculated from the stoichiometry of network formation and the assumption that one molecule of excess thiol used for degradation reacts with one thioester bond. Combining the expression for q and knowledge of network stoichiometry provides the following equation for fractional mass gain:

$$MG = \frac{ZP ( 1 - {y}^{Z - 1} ) {MW}_{SH}}{2 ( 2 {MW}_{M} + Z \cdot {MW}_{diene} )} , \qquad ( 9 )$$

where MG is fractional mass gain, MW^{SH} is the molecular weight of the excess monofunctional thiol, MW_{diene} is the molecular weight of the thioester-containing diene, and MW_{M} is the molecular weight of the multifunctional monomer (see “Fractional Mass Gain” section below). Combining the mass gain from equation 9 with the mass loss from equation 7 gives an expression for the net fractional mass loss:

$${ML}_{Model} = {y}^{z} - \frac{ZP ( 1 - {y}^{Z - 1} ) {MW}_{SH}}{2 ( 2 {MW}_{M} + Z \cdot {MW}_{diene} )} . \qquad ( 10 )$$

### Derivation of q

To find q, the fraction of thioesters cleaved but still attached to the network, all cases where an individual thioester bond can be cleaved but still attached to the infinite network were considered. In particular, the half of the thioester bond where thiol has added was monitored. For Z=4, there are three distinct cases where thioesters are cleaved but still attached to the network:

Case 1: All adjacent arms are attached to the network (FIG. 27A). In this case, there is a probability P/2 that the thioester in question (left) has cleaved and is oriented so a free thiol adds to this crosslink. Then, there is a probability (1−y) that each of the adjacent arms are attached. This provides a total fraction of (P/2)(1−y)³.

Case 2: Two adjacent arms are attached to the network (FIG. 27B). In this case, there is a probability P/2 that the thioester in question (left) has cleaved and is oriented so a free thiol adds to this crosslink. Then, there is a probability (1−y) that each of the two arms are attached to the network. There is a probability y that the remaining arm is detached. Because there are three arrangements for this scenario, the probability is multiplied by 3. This provides a total fraction of 3(P/2)y(1−y)².

Case 3: One adjacent arm is attached to the network (FIG. 27C). In this case, there is a probability P that the thioester in question (left) has cleaved and is oriented so a free thiol adds to this crosslink. Then, there is a probability y that each of the two arms are detached from the network. There is a probability (1−y) that the remaining arm is attached. Because there are three arrangements for this scenario, the probability is multiplied by 3. This provides a total fraction of 3(P/2)y 2 (1−y).

Therefore, for Z=4, q=(P/2)(1−y)³+3(P/2)y(1−y)²+3(P/2)y²(1−y). This is generalizable to any Z:

$$q = {\sum }_{k = 0}^{Z - 2} ( \frac{P}{2} ) ( \begin{matrix}Z - 1 \\ k\end{matrix} ) {{y}^{k} ( 1 - y )}^{Z - 1 - k} ,$$

where is the

$$( \begin{matrix}Z - 1 \\ k\end{matrix} )$$

combinatorial factor for choosing k elements from Z−1 possibilities. The probability (P/2) is independent of the variable of summation and can be factored out of the sum. Adding the k=Z−1 case to this sum and subtracting it outside the sum to maintain equality allows for a different form of the equation:

$$q = ( \frac{P}{2} ) {\sum }_{k = 0}^{Z - 1} \{ ( \begin{matrix}Z - 1 \\ k\end{matrix} ) {{y}^{k} ( 1 - y )}^{Z - 1 - k} \} - ( \frac{P}{2} ) {y}^{Z - 1} .$$

The summation term can be recognized as the binomial expansion of ((1−y)+y)^{Z-1}. This simply reduces to 1, so q can be simplified and rewritten as:

$$q = ( \frac{P}{2} ) - ( \frac{P}{2} ) {y}^{Z - 1} = \frac{1}{2} P ( 1 - {y}^{Z - 1} ) .$$

### Fractional Mass Gain

With q, the fractional mass gain in the network was derived. The moles of thioesters contributing to mass gain is the fraction of thioesters cleaved but still attached to the network (q) multiplied by the total number of moles of thioesters (n_{TE,0}). Each of these will have reacted with free thiol (SH) to increase the mass of the network by the mass of one thiol molecule. Therefore, total mass gain is given by:

$$Mass Gain ( g ) = q \cdot {n}_{TE , 0} \cdot \frac{1 mol SH}{1 mol TE} \cdot \frac{MW SH ( g )}{1 mol SH} = {qn}_{TE , 0} {MW}_{SH} ,$$

where MW_{SH} is the molecular weight of the free thiol degrading the network. Because thioesters come entirely from the diene crosslinker, the total number of thioester groups present initially is equal to the number of diene molecules (n_{diene}) used in the formulation of the network: Mass Gain (g)=qn_{diene}MW_{SH}.

For fractional mass gain, this expression must be normalized to the initial mass, m₀. Given the stoichiometry of the network formulation, initial mass can be related to functionality of the multifunctional thiol, functionality of the diene, and stoichiometry: m₀=m_{M}+m_{diene}=nMW_{M}+n_{diene}MW_{diene}=2/Z n_{diene}MW_{M}+n_{diene}MW_{diene}. The equation for fractional mass gain is acquired from substituting for q in the mass gain expression, dividing the expression by initial mass m₀, and slightly rearranging:

$$MG = \frac{ZP ( 1 - {y}^{Z - 1} ) {MW}_{SH}}{2 ( 2 {MW}_{M} + Z \cdot {MW}_{diene} )} .$$

### Kinetic Component of Model

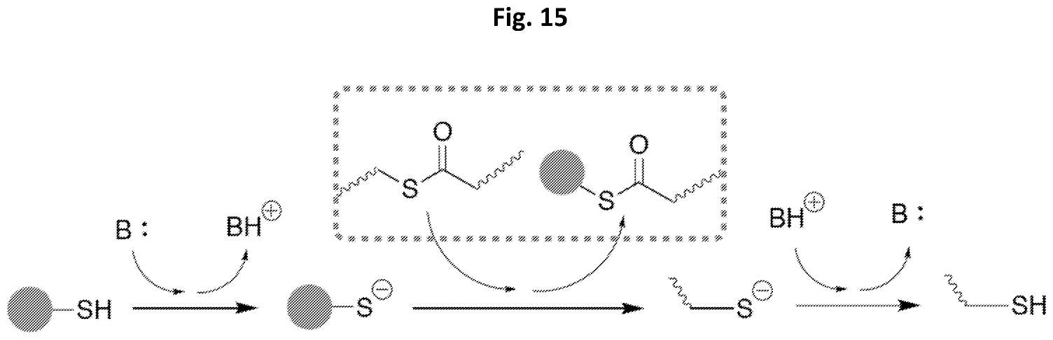

The kinetics of the thiol-thioester exchange reaction drive the degradation rate. As shown in FIG. 15, when thioesters are initially linked to a network, the exchange forms a new thioester with a dangling end, thereby reducing the number of crosslinks.

By setting the initial conditions of the thiol-thioester exchange to use a large excess of free thiol and base catalyst, the exchange can be tuned to behave as a pseudo first-order reaction. The initial concentration of free thiol and base govern the formation of unlinked thiolate (FIG. 15, left). If the unlinked thiolate consumed by the thiol-thioester exchange is minimal (FIG. 15, middle), then the formation of unlinked thiolate can be considered an acid-base reaction in equilibrium. Knowing the initial concentration of free thiol and base catalyst and the pKa of each component, the concentration of thiolate created is calculated using

$${10}^{Δ pKa} = \frac{{[ {S}^{-} ]}^{2}}{( {[ SH ]}_{0} - [ {S}^{-} ] ) ( {[ B ]}_{0} - [ {S}^{-} ] )} , \qquad ( 11 )$$

where ΔpKa stands for the difference in pKa values between the free thiol and base, [SH]₀ stands for the initial concentration of free thiol, [B]₀ stands for the initial concentration of base, and [S⁻] stands for the concentration of unlinked thiolate. This produces a quadratic equation in [S⁻] that is readily solved.

The initial concentration of unlinked thiolate in all experiments of this study was more than 200× the initial concentration of thioesters linked to the network. As such, the consumption of the unlinked thiolate by the thiol-thioester exchange was minimal and equation 11 applied. Furthermore, the large excess of unlinked thiolate drove thiol-thioester exchange toward the reaction products consistent with Le Chatelier's principle. Thus, while the thiol-thioester exchange was a second order reaction, the effectively constant concentration of unlinked thiolate allowed the exchange to be treated as a pseudo-first order reaction modeled by [TE]=[TE]₀e^{-k[S}^{^{−}}^{]t} (12), where [TE] refers to the current concentration of thioesters linked to the network and [TE]₀ refers to the initial concentration of thioesters linked to the network.

The network structure and kinetics portions of the model come together by relating the probability of cleaving a random thioester crosslink, P, to the concentration of linked thioesters via

$$P = \frac{{[ TE ]}_{0} - [ TE ]}{{[ TE ]}_{0}} = 1 - {e}^{- k [ {S}^{-} ] t} . \qquad ( 13 )$$

Equation 13 uses equation 12 to relate the probability P to the second-order rate constant k, the unlinked thiolate concentration [S⁻], and the time t. Combining equations 4, 10 and 13 gives a direct prediction for how the mass of a thioester-containing polymer will decrease with time due to thiol-thioester exchange.

### Example 2-3: Model Results for Mass Loss

The derived model provides insight into how network structure and reaction kinetics impact bulk degradation of thioester networks. Inspection of equation 10 showed that Z, the functionality of the thiol monomer and a vital part of the network structure, impacts the net mass loss and mass gain. For Z=2, a polymer consists entirely of linear polymer chains. In this case, y=1 for all values of P, and the predicted net fractional mass loss is 1, indicating a crosslinked network is never formed. On the other extreme, as Z→∞, the value for net mass loss approaches

$$- \frac{{PMW}_{SH}}{2 {MW}_{diene}}$$

for P<1. This value is a function of excess thiol molecular weight (from MW_{SH}), the number of thioester units in the network (from MW_{diene}), and the time allowed for degradation (from P). The negative sign indicates that only mass gain is expected in such a system, as no monomer unit can leave until all thioester groups have been cleaved.

FIGS. 16B and 16C used model systems of TMPTMP (Z=3), PETMP (Z=4), and di-PETMP (Z=6) with BMP as the excess monothiol and TEDE as the thioester-containing diene to show the extreme and intermediate cases for Z. For the less crosslinked system (Z=3), mass gain was predicted but was nearly balanced by mass loss (FIG. 16C). For the more highly crosslinked systems (Z=4 and Z=6), however, mass gain had a significant overall effect. This outcome arose because a much higher P, which corresponded to a longer degradation time, was required before units could be freed from the network. The result of this was an approximately 3% and 7% net gain in mass for Z=4 and Z=6, respectively, before mass loss could counteract the effect of thiol addition to the network.

### Example 2-4: Verification of Bulk Degradation

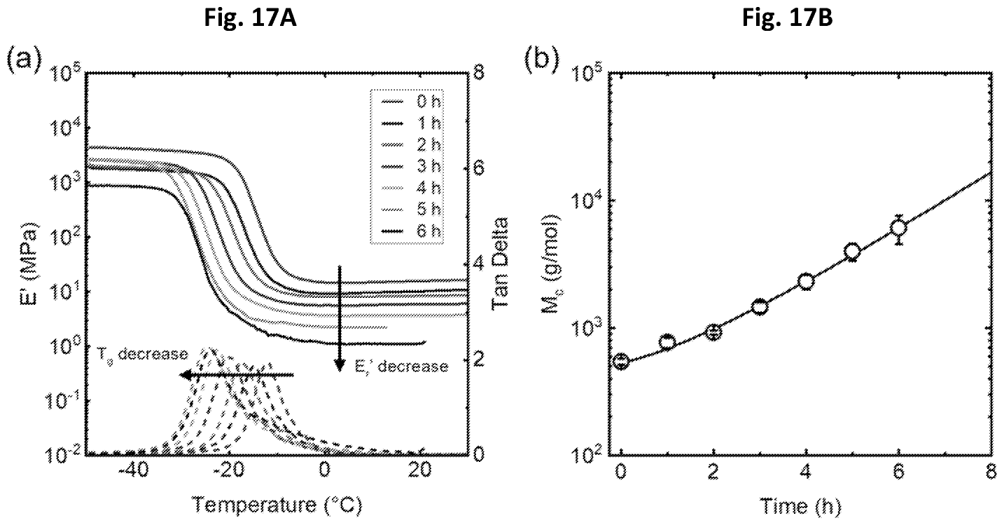

To ensure that the thioester networks experimentally studied in this work underwent bulk rather than surface degradation, the molecular weight between crosslinks, M_{c}, and glass transition temperature, T_{g}, of a model network were probed by DMA throughout the degradation process. Bulk degradation leads to a decrease in network connectivity throughout the entire polymer network, and as such all properties that depend on network connectivity, such as M_{c} and T_{g}, shift during degradation. FIGS. 17A-17B show that as degradation proceeded in photocured TEDE-PETMP films soaked in 2M BMP and 30 mol % TEA degrading solution, T₉ dropped and M_{c} increased in ways that were characteristic of films experiencing bulk degradation. FIG. 3A shows that with increasing degradation time, T_{g} decreased from −12° C. to −26° C., and the rubbery plateau modulus decreased from 14 MPa to 1.5 MPa. FIG. 3B shows that experimental data for M_{c}, as was calculated by equation 2, increased with degradation time and matched bulk degradation model predictions for M_{c} (see Example 2-5 section below for the predictions for M_{c}).

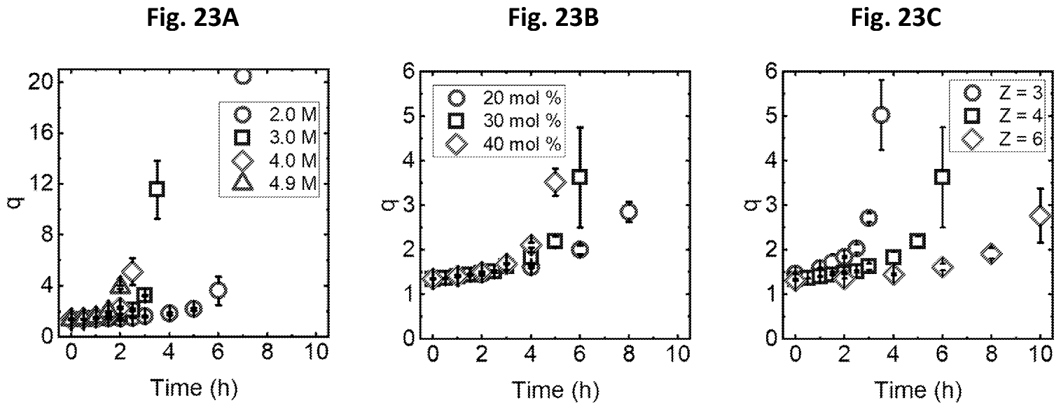

Comparisons of characteristic reaction and diffusion times and mass swelling ratio of thin films also supported the claim that these thioester networks underwent bulk degradation. The characteristic reaction time was ≈100 times larger than diffusion time (420 minutes and 5 minutes, respectively) which suggested a reaction-limited process (see Example 2-6 section). The mass swelling ratio of the thin films increased up to 20 during degradation, which also suggested cleavage of crosslinks within the polymer network as is characteristic of bulk degradation (FIGS. 23A-23C).

### Example 2-5: Molecular Weight Between Crosslinks

Metters and co-workers developed a bulk degradation model that predicts molecular weight between crosslinks, M_{c}, as

$${M}_{c} = \frac{Z * {M}_{c , inilal}}{{\sum }_{i = 3}^{Z} i * {F}_{i , Z}} , \qquad ( S4 )$$

where Z stands for monomer functionality, i the number of arms per crosslink considered to be attached to the network, and F_{i,Z} the fraction of elastically active crosslinks with i number of arms still attached to the network. The sum in equation S4 starts with i=3 because each crosslink needs at least 3 arms still attached to the network to be elastically active. F_{i,Z} is calculated by

$${F}_{i , Z} = \frac{Z !}{( Z - i ) ! i !} {{P}^{( Z - i )} ( 1 - P )}^{i} , \qquad ( S5 )$$

and shows that F_{i,z} depends on P, the probability that a random thioester crosslink has cleaved. Combining equations S4, S5, and 11 allowed M_{c} to be predicted as a function of time.

### Example 2-6: Diffusion and Reaction Times

Characteristic diffusion and reaction times were compared to determine which occurred significantly faster.⁵ Characteristic reaction time was calculated by

$${t}_{r} = \frac{1}{k [ {S}^{-} ]} , \qquad ( S6 )$$

where k is the rate constant of thiol-thioester exchange and [S⁻] is the concentration of unlinked thiolate. Literature values for k range from 10⁻⁵ to 10³ M⁻¹, and model fit to experimental results in this work gave a value of ≈0.004 M⁻¹min⁻for k, fitting within past studies. Using a value of 0.004 M⁻¹min⁻¹ for k and 0.60 M for [S⁻] resulted in tᵣ of ≈420 min. Characteristic diffusion time was calculated by

$${t}_{d} = \frac{{L}^{2}}{{D}_{eff}} , \qquad ( S7 )$$

where L is half the length of degrading films and D_{eff} is the effective diffusivity of free BMP thiolates diffusing into said films. D_{eff} for BMP thiolate (M_{w}=161.3 g/mol) was approximated as 0.0005 mm²/min because its molecular diffusivity is similar to a fluorophore (M_{w}=297 g/mol) diffusing through an identical crosslinked and swollen network. Using a value of 0.05 mm for L and 0.0005 mm²/min for D_{eff} resulted in t_{d} of ≈5 min. Comparing tᵣ and t_{d} showed diffusion occurred ≈100× faster than reaction, justifying the claim that diffusion was significantly faster in the films studied and further supporting the claim that the networks investigated underwent bulk degradation.

### Example 2-7: Verification of Model

To validate the derived bulk-degradation model, the predicted mass loss as a function of three process variables was compared to experiment: the initial free thiol concentration, the initial molar ratio of thiol to base, and the monomer functionality, Z. Changing the multifunctional thiol monomer used to create these networks allowed Z to range from 3-6 (FIG. 14B).

### Free Thiol Concentration

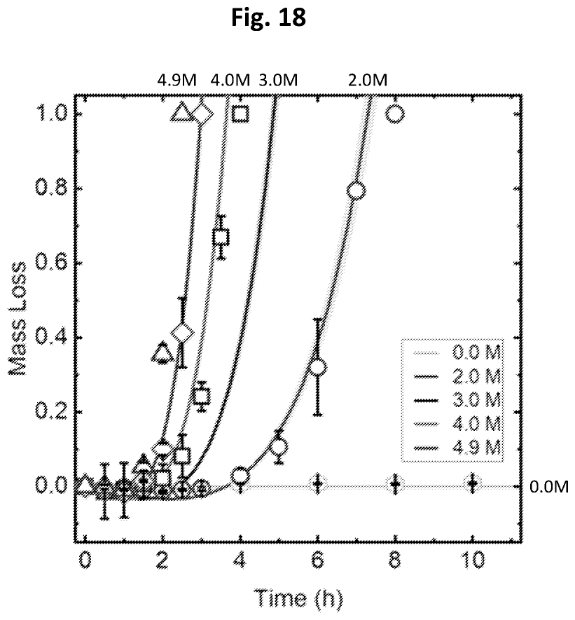

As the initial concentration of free thiol increased, so too did the rate of mass loss. The data in FIG. 18 show how mass loss changed as a function of initial concentration of free thiol BMP, which ranged from 0.0M to 4.9M, at a constant ratio of 30 mol % TEA. The 0.0M sample served as a control with no free thiol added but TEA was included at a concentration that matched the TEA content of the 2.0M BMP sample in acetone. As thiol concentration increased, the total time for mass loss decreased from ≈8 h to ≈2.5 h for the 2.0M to 4.9M samples. Experimental data matched model predictions well, and as predicted at early degradation times, a small amount of mass gain was experimentally observed. Despite having different concentrations of BMP and thus different degradation times, the 2.0M to 4.9M samples all had a Z value of 4 and thus experienced the same net mass loss at the same probability of degradation, P, as shown in FIG. 16C. Furthermore, the critical probability at which total mass loss was achieved, P_{c}, was 0.67 for all samples (equation 5). These model predictions are useful to determine the degradation conditions required to fully degrade a thioester network after a specific amount of time.

The second order reaction rate constant k was used as a fitting parameter to compare model predictions with experimental results. As such, k is not a function of thiolate concentration, and all experimental data were fit to a single value of k. FIG. 18 shows that a k value of 0.0042±0.0001 M⁻¹min⁻¹, including standard error, predicted experimental mass loss well for all of the conditions assessed here. Model predictions for the 3.0-4.9 M samples deviated from experimental results more, likely due to the convolution of the measured reaction rate constant with mass transport limitations of large oligomers diffusing out of the degrading polymer network. Nevertheless, the k value from FIG. 18 was similar to the FIG. 17B value, 0.0042 versus 0.0051 M⁻¹min⁻¹, and was consistent with values for k which range from 10⁻⁵ to 10³ M⁻¹min⁻¹.

### Ratio of Base Catalyst

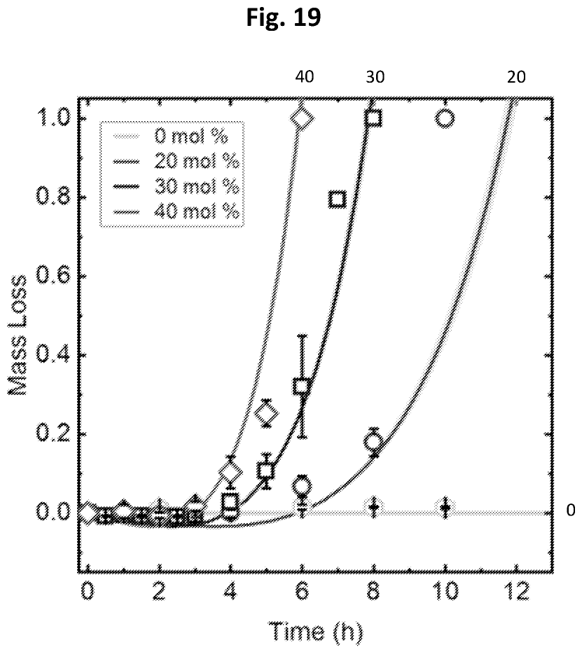

As the ratio of base increased, the mass loss rate also increased. FIG. 19 shows data for how the mass loss changed as a function of the TEA mol ratio, going from 0 mol % to 40 mol %, while keeping the BMP concentration at 2.0M. The 0 mol % sample served as a control: no TEA was added but 2.0M BMP in acetone was still included. As the ratio of base to thiol increased from 20 mol % to 40 mol %, the total time for polymer degradation decreased from ≈10 h to ≈6 h. Experimental data matched model predictions well, and similar to FIG. 18 at early degradation times a small amount of mass gain was observed. Also similar to FIG. 18, even though the 20 to 40 mol % samples had varying amounts of TEA, all were Z=4 networks and followed the same net mass loss profile depicted in FIG. 16C and achieved total mass loss at P_{C}=0.67 (equation 5). Lastly, fitting the model prediction to experimental data in FIG. 19 resulted in a rate constant k of 0.0039±0.00006 M⁻¹min⁻¹ including standard error, which was similar in value to experiments as changing the molar ratio of base catalyst to free thiol should not impact the intrinsic reaction rate constant of thiol-thioester exchange.

### Monomer Functionality

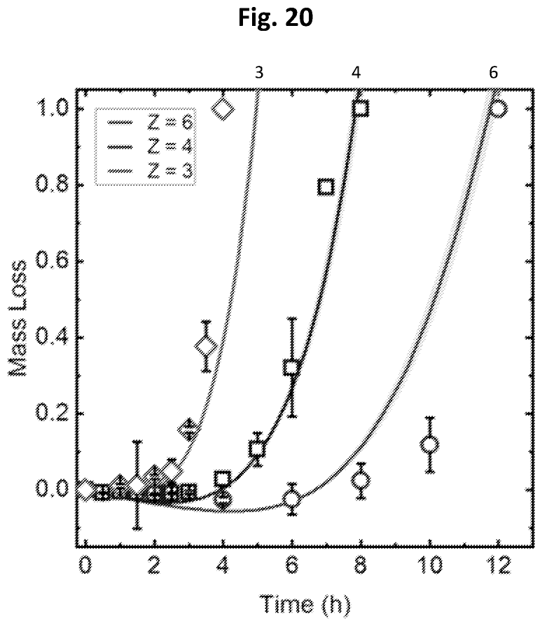

Increasing monomer functionality, Z, resulted in slower mass loss. The data in FIG. 20 show how the mass loss changed as a function of Z, where Z ranged from 3 to 6, while using 2.0M BMP and 30 mol % TEA for the degradation solution. Each value of Z came from a different thiol-ene network, where TMPTMP (Z=3), PETMP (Z=4), or diPETMP (Z=6) were reacted with TEDE to make these networks. As Z increased from 3 to 6, the total time for the polymer network to degrade increased from ≈4 h to ≈12 h. Experimental data matched model predictions well, and the Z=6 sample experienced the most mass gain as predicted by the model, reaching approximately 3%.

Unlike FIGS. 18 and 19, each sample in FIG. 20 was modelled by a different mass loss equation, as shown in FIG. 16C. As such, each sample had a distinct value of P_{c}. (equation 5): for Z=3, 4, and 6 P_{c}. equaled 0.5, 0.67, and 0.8, respectively. Larger values of Z resulted in higher P_{c}. values because larger Z networks have a greater number of arms connected to each crosslink, and as such a higher fraction of thioester groups must cleave before crosslinks fully disconnect and a repeat unit leaves the network. Because of this, a Z=3 network will achieve greater mass loss than a Z=6 network when the same probability of thioester groups cleaving, P, is reached. Despite the variation in network structure, the model predictions for all samples yielded a similar value for rate constant k, 0.0039±0.00007 M⁻¹min⁻¹ including standard error, suggesting that changes in the polymer network structure had little effect on the reaction rate constant of thiol-thioester exchange.

### Example 2-8: 3-D Printing Thioesters

To broaden the scope of these thioester-containing CANs toward industrial applications, SLA 3-D printed thioester networks were investigated. As 3-D printed structures may vary in thickness, and thickness impacts characteristic diffusion time and thus the degradation process, the effect of wall thickness in degrading thioester CANs was studied.

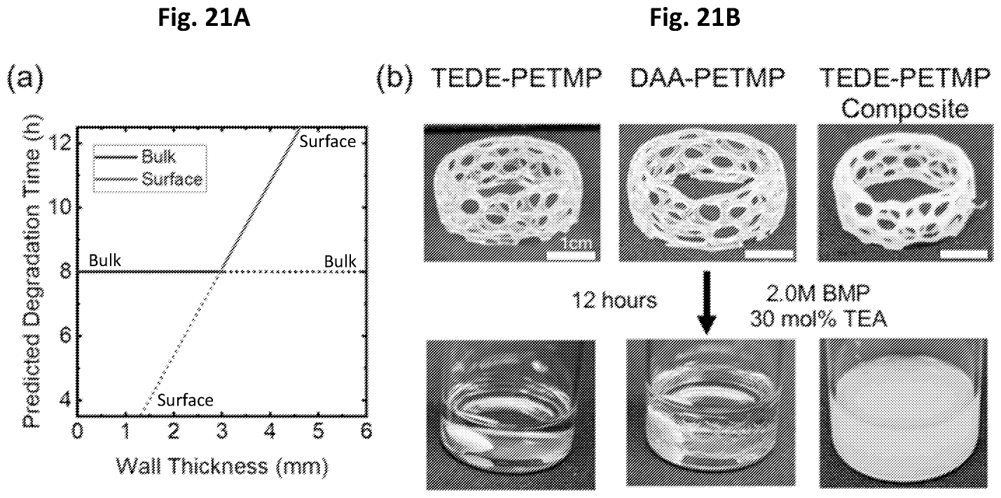

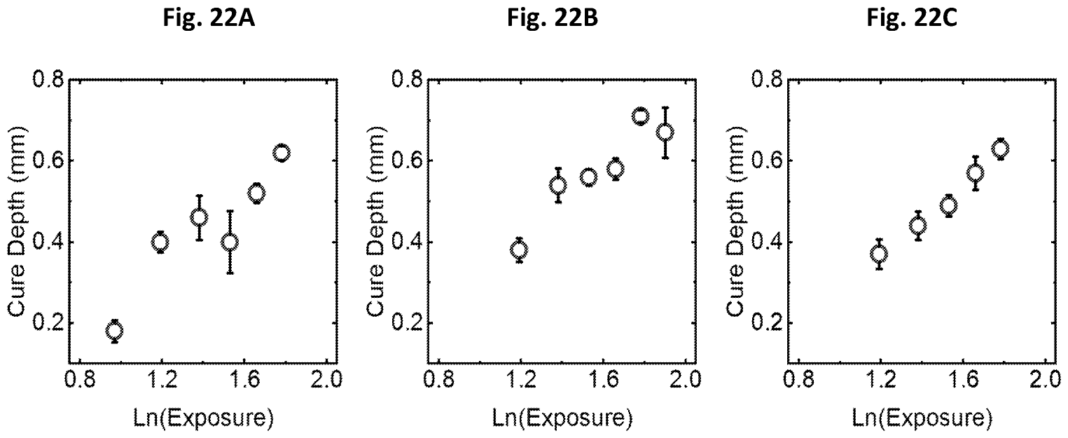

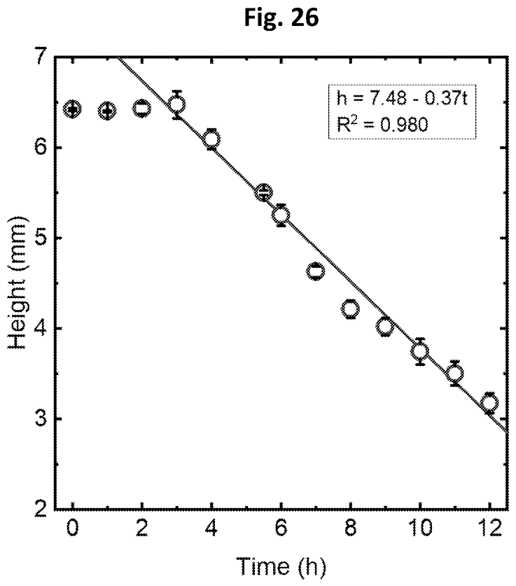

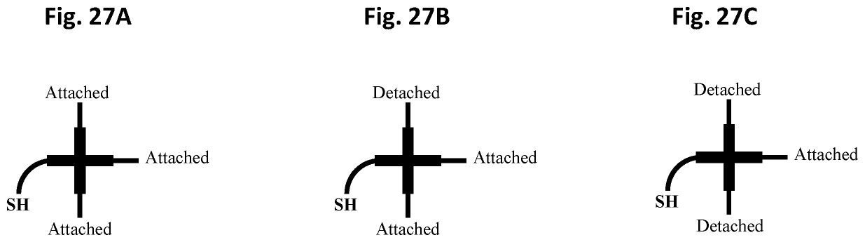

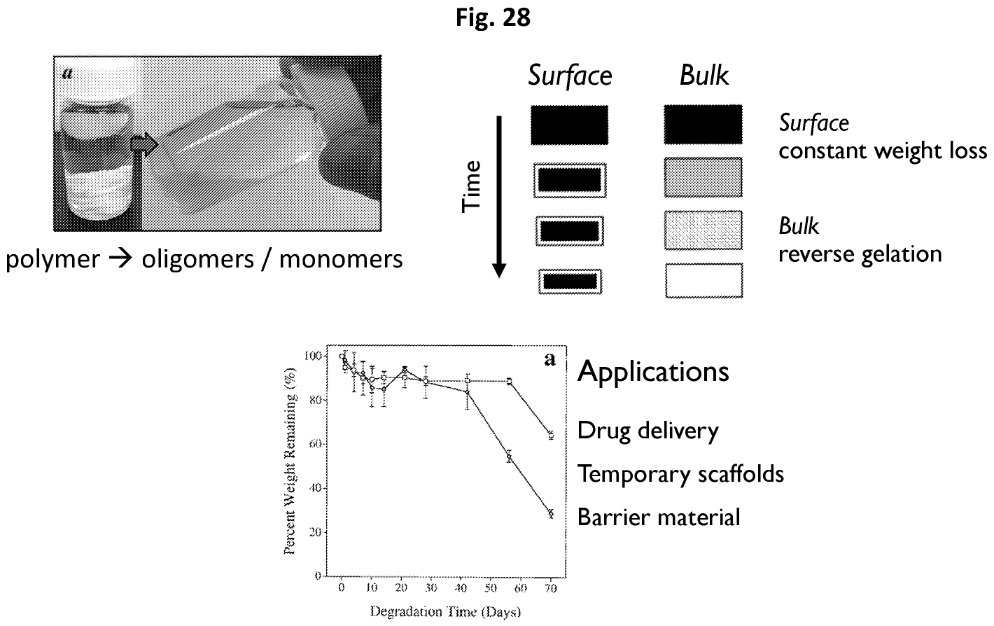

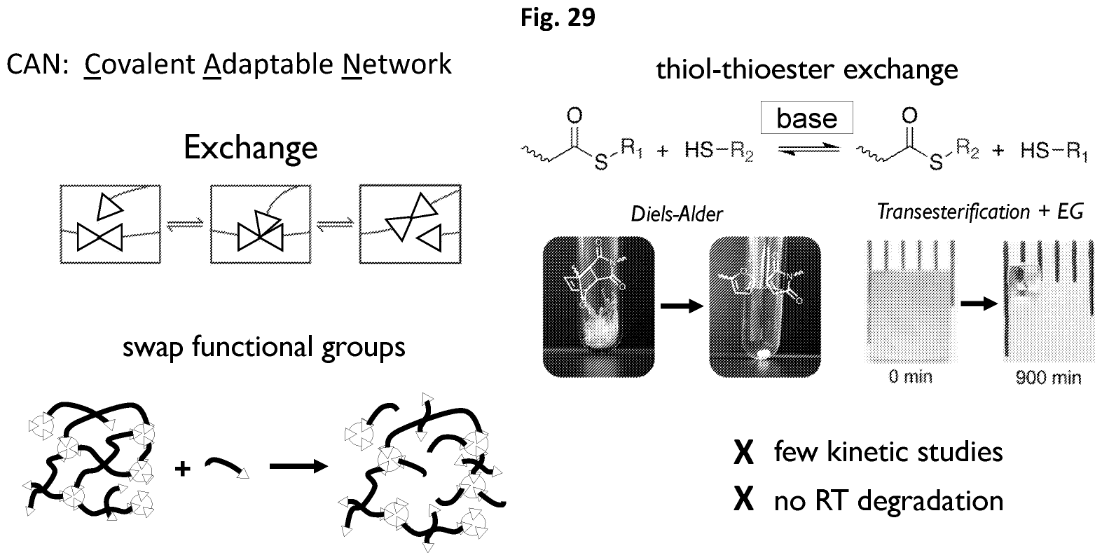

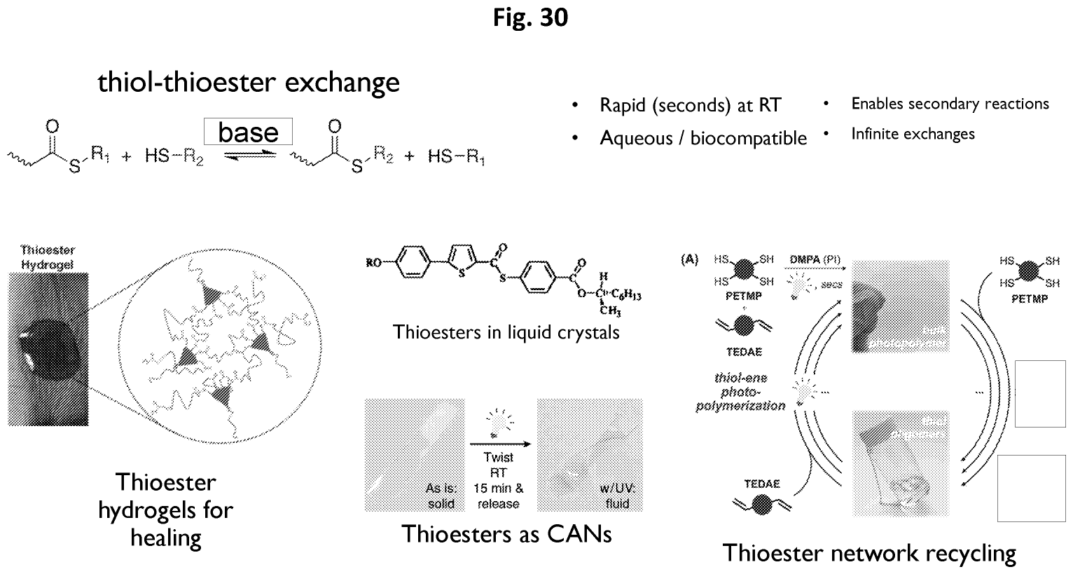

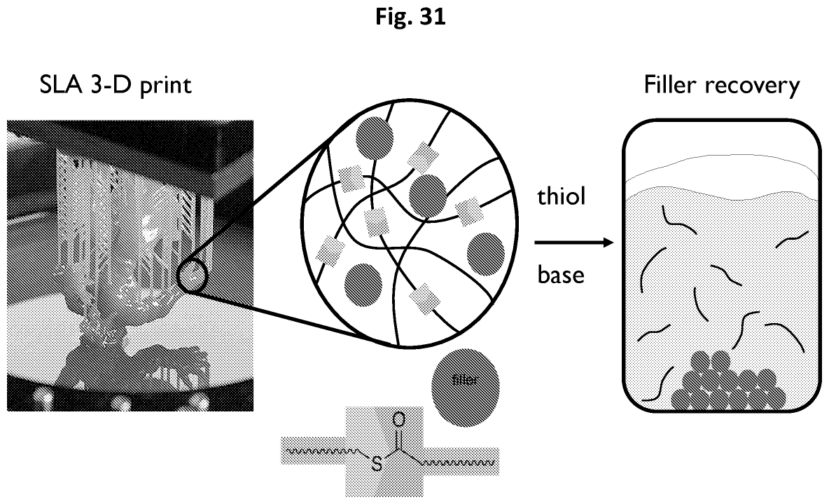

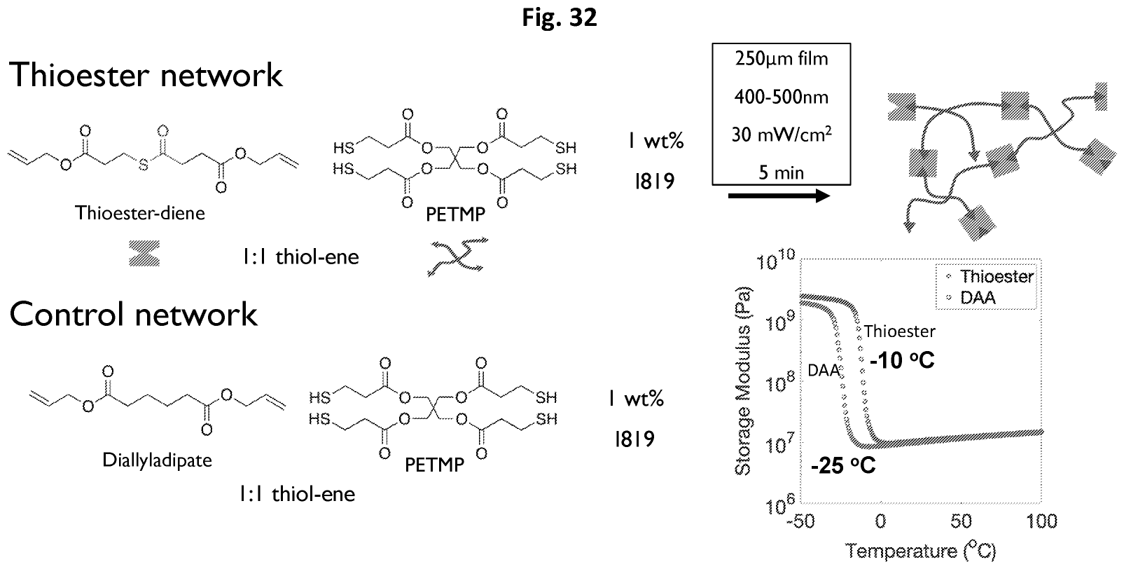

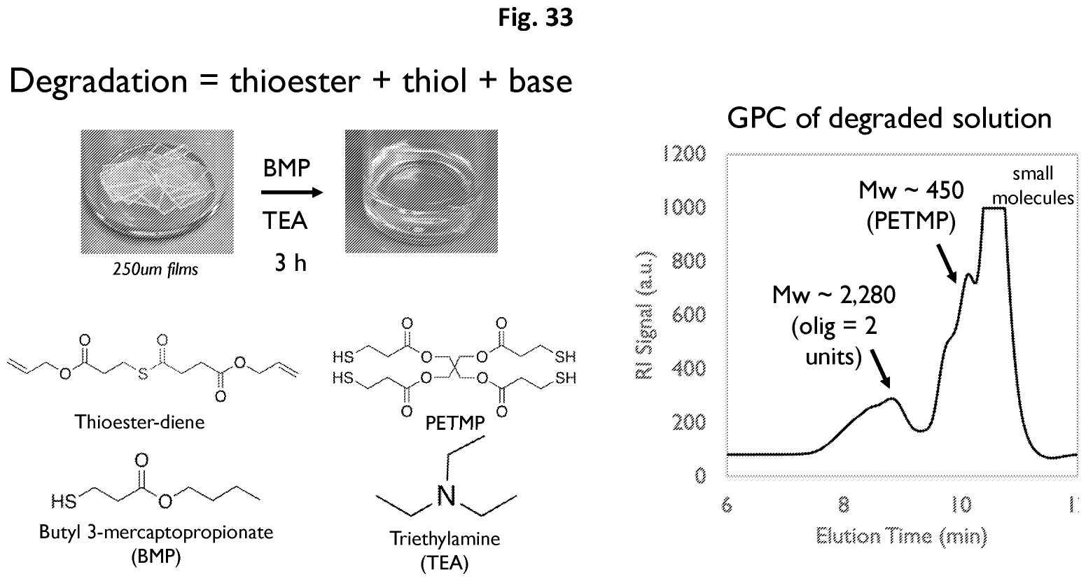

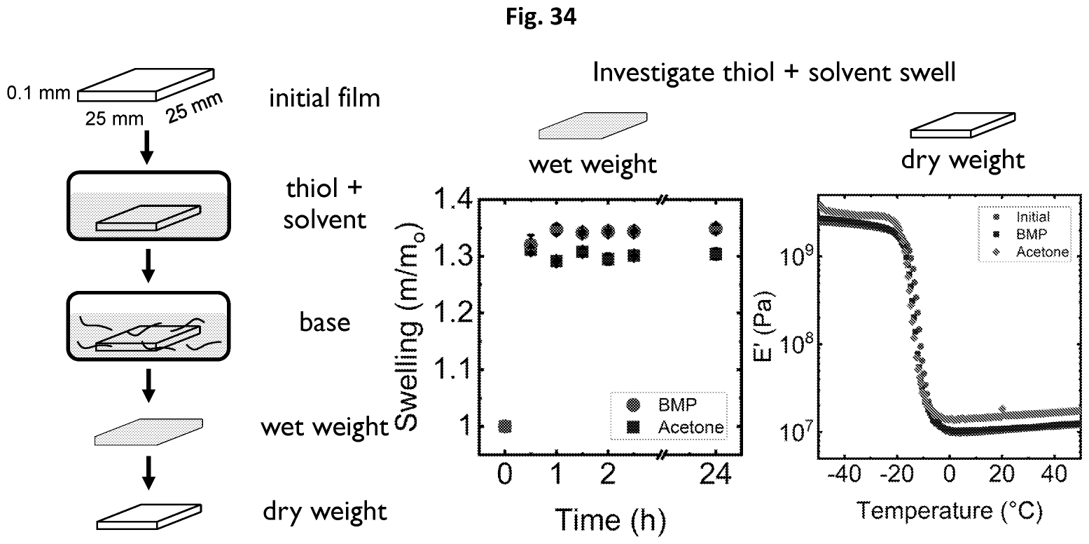

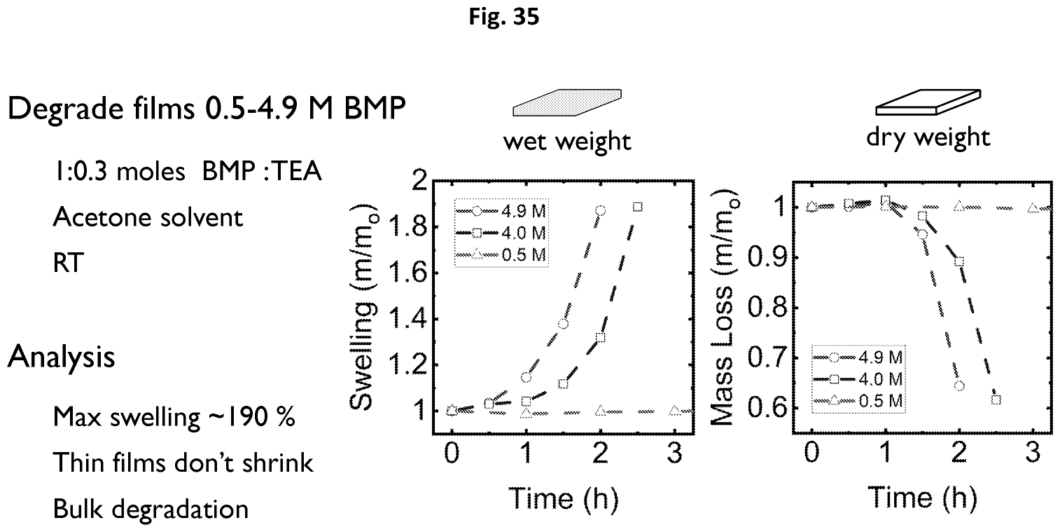

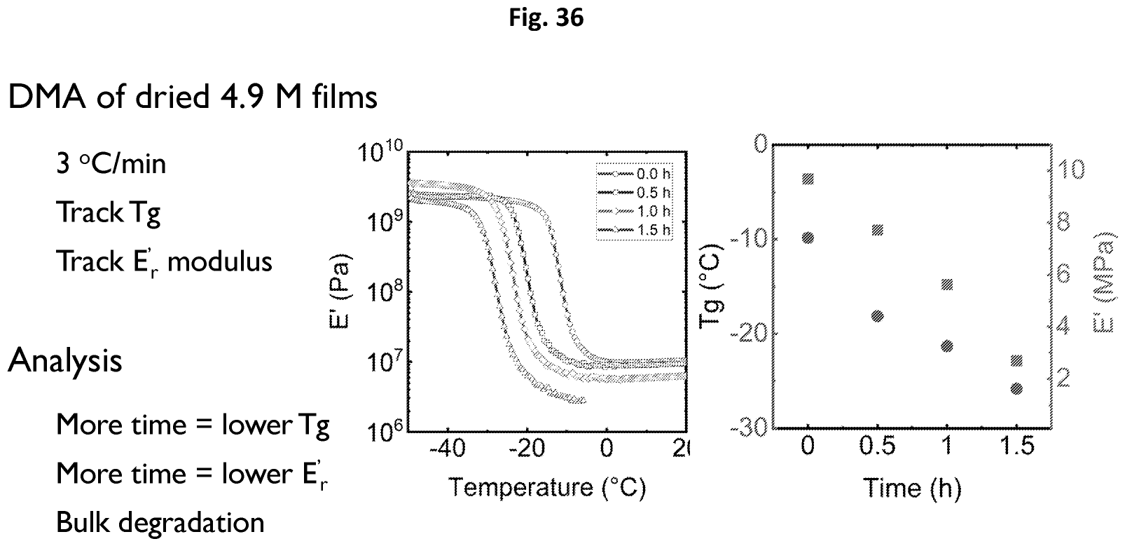

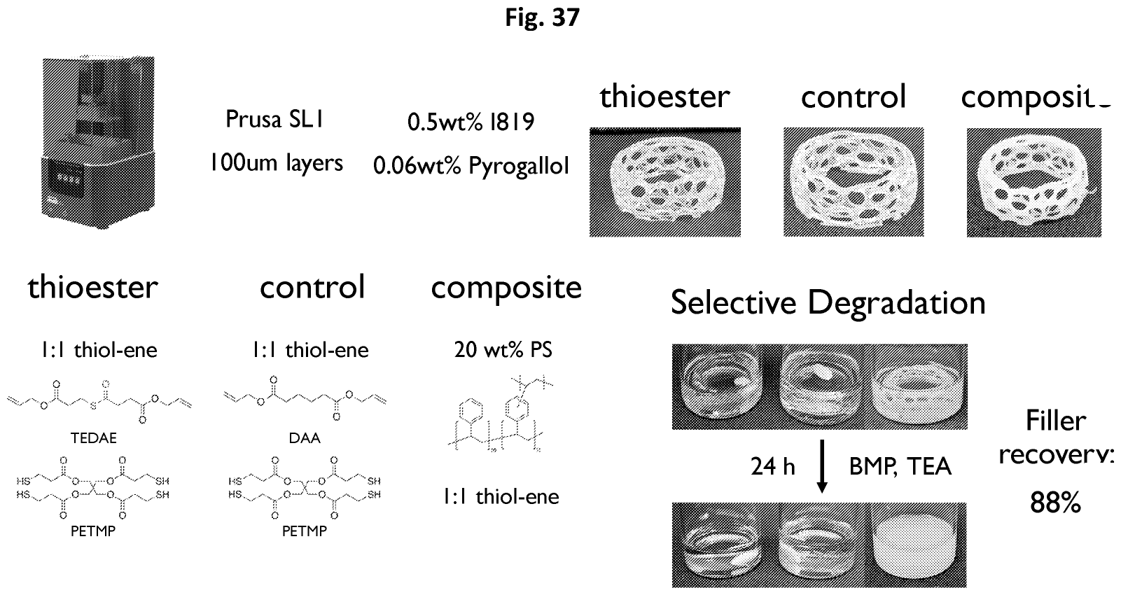

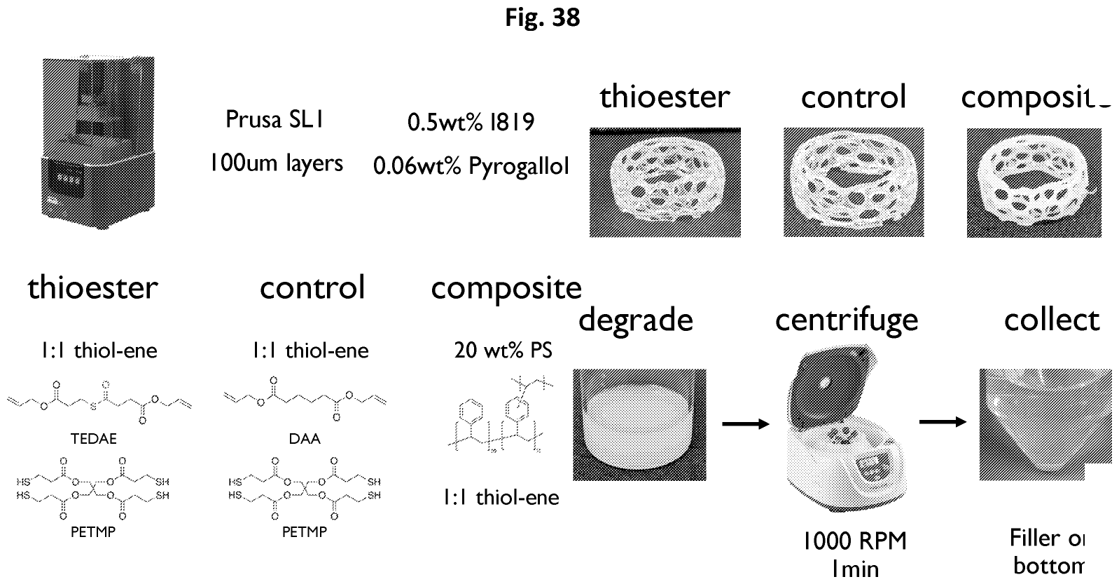

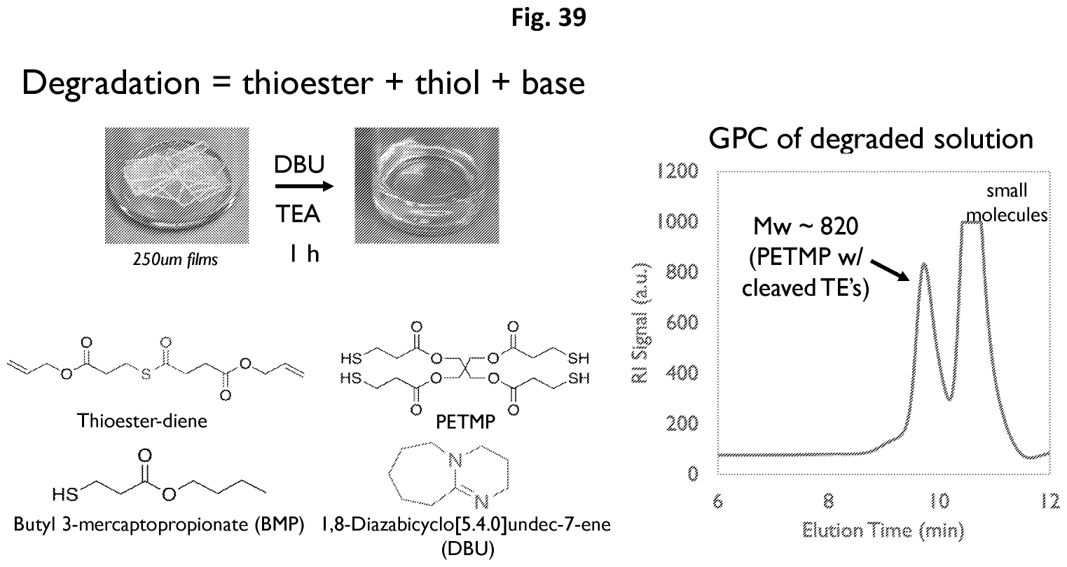

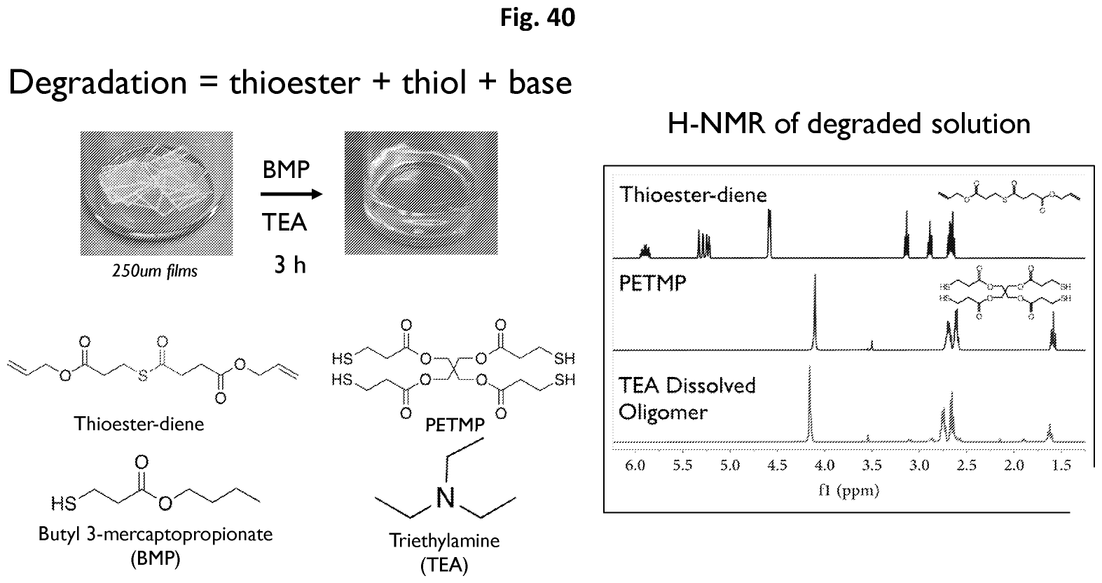

FIG. 21A shows model predictions for how time to achieve complete degradation varied with wall thickness when 3-D printed parts were soaked in 2.0M BMP, 30 mol % TEA degrading solution. Far below the 3 mm wall thickness, bulk degradation dominated as characteristic diffusion time was significantly lower than reaction time. Since bulk degradation occurs simultaneously throughout a polymer network, the time to reach complete degradation was independent of wall thickness and remained a constant 8 hours. Far above 3 mm wall thickness, surface degradation dominated as the characteristic reaction time was then significantly lower than the diffusion time. Using the Hopfenberg model, degradation time in the surface degrading regime was predicted to increase linearly with wall thickness, and this rate of increase was driven by the rate of height change of a 1-D polymer slab. Surface degradation carried out on 5 mm thick, 3-D printed slabs of TEDE-PETMP showed height decreases of 0.37±0.02 mm/hour, meaning that in the surface degrading regime degradation time increased with wall thickness at a rate of 2.7±0.15 hours/mm (FIG. 26). At approximately 3 mm wall thickness, both models converged and network dissolution was a function of both bulk and surface degradation.

Using the degradation regime predictions from FIG. 21A, network dissolution of 3-D printed thioester-containing and 3-D printed thioester-devoid chemistries in the bulk degrading regime were investigated. Rings with a wall thickness of 0.6 mm were SLA 3-D printed to ensure degradation in the bulk degrading regime. FIG. 21B shows how the rings, composed of three different networks, behaved after a 12-hour soak in the degrading solution used for thin film studies (2.0M BMP, 30 mol % TEA). Networks that contained thioester groups readily dissolved, while networks without the thioester groups were unaffected. Thioester composites containing 20 weight % of 6-10 μm poly(styrene-co-divinylbenzene) microspheres degraded similar to neat networks. Centrifuging the degraded composite solution allowed recovery of 91±1.4% of the microspheres, showing efficient recovery of fillers in thioester composites. Unlike composite degradation via other CAN chemistries, thiol-thioester degradation occurred rapidly at room temperature within hours, not days, and this dissolution time may be even further reduced through several means such as using a more basic catalyst (diazabicycloundec-7-ene), a more polar solvent (methanol), a more reactive monothiol (methyl thioglycolate), a lower Z monomer (Z=3), or by increasing the temperature of the reaction above room temperature.

### Example 2-9: Summary of Example 2

The study as described in Example 2 investigated degradation kinetics based on thiol-thioester exchange for thioester-containing networks. By means of a theoretical model, derived from the reaction kinetics and the polymer network structure, mass gain from the thiol molecules adding into the network and net mass loss from crosslinks cleaving were predicted and experimentally verified by mass loss studies. Reaction rate constants, k, used as a fitting parameter for the derived model, were found to range from 0.0039 to 0.0051 M⁻¹min⁻¹ and fit within expected values. Further investigations on exchange kinetics and network structure found that increasing the concentration of free thiol, the ratio of base to thiol, or decreasing monomer functionality sped up the mass loss rate. Lastly, SLA 3-D printed thioester composites showed that thioester-containing CANs selectively degraded to allow recovery of 91% of the filler in a composite, paving the way for thioester-facilitated filler recovery.

### ENUMERATED EMBODIMENTS

The following enumerated embodiments are provided, the numbering of which is not to be construed as designating levels of importance:

Embodiment 1 provides a composition, comprising:
a first monomer of Formula (I):

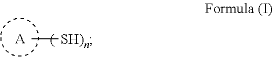

and
a second monomer of Formula (II) selected from the group consisting of:

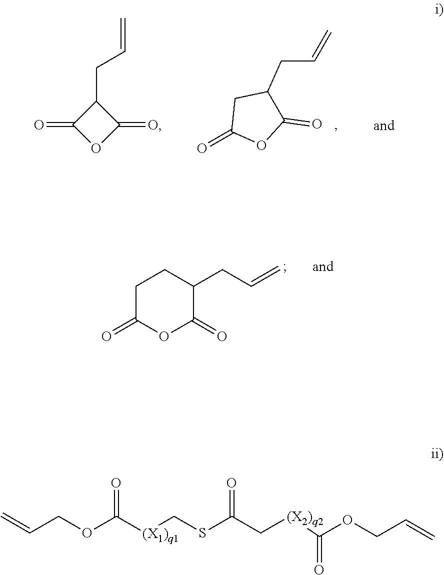

wherein:
   [symbol] is C₃₋₂₀ alkyl, C₃₋₂₀ heteroalkyl, C₃₋₂₀ cycloalkyl, C₆₋₁₄ aryl, or combinations thereof, each of which is optionally substituted by 1 to 5 groups independently selected from the group consisting of F, Cl, Br, I, OR, OC(O)N(R)₂, CN, NO₂, CF₃, OCF₃, R, N(R)₂, SR, SOR, SO₂R, SO₂N(R)₂, and SO₃R, wherein each occurrence of R is independently hydrogen, C₁-C₁₀ alkyl, or C₆₋₁₀ aryl,
n is an integer ranging from 2 to 6;
X₁ is independently at each occurrence —CH₂—, —O—, —OCH₂CH₂—, or —CH₂CH₂O—;
X₂ is independently at each occurrence —CH₂—, —O—, —OCH₂CH₂—, or —CH₂CH₂O—;
q1 is an integer from 1 to 20; and
q2 is an integer from 1 to 20.

Embodiment 2 provides the composition of embodiment 1, wherein, except for the thiol group, the first monomer does not comprise a functional group substantially reactive with the anhydride functional group or the alkene functional group of the second monomer.

Embodiment 3 provides the composition of any one of embodiments 1-2, wherein, except for the anhydride functional group and the alkene functional group, the second monomer does not comprise a functional group substantially reactive with the thiol group of the first monomer.

Embodiment 4 provides the composition of any one of embodiments 1-3, wherein a molar ratio between the first monomer and the second monomer in the composition ranges from about 1:5 to about 5:1.

Embodiment 5 provides the composition of any one of embodiments 1-4, wherein the at least one thiol group of the first monomer and the at least one anhydride functional group of the second monomer are able to form a reversible thioester linkage.

Embodiment 6 provides the composition of any one of embodiments 1-5, wherein the first monomer is at least one selected from the group consisting of:

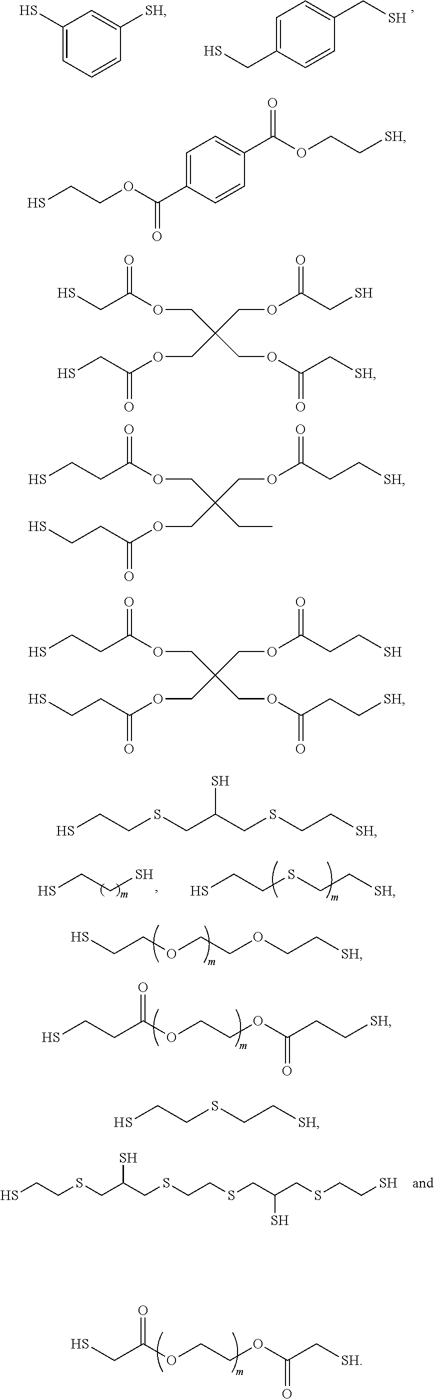

Embodiment 7 provides the composition of any one of embodiments 1-6, wherein the second monomer is

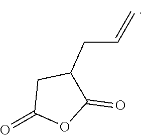

Embodiment 8 provides the composition of any one of embodiments 1-7, further comprising a first catalyst catalyzing a reversible reaction between thiol group of the first monomer and the anhydride functional group of the second monomer.

Embodiment 9 provides the composition of any one of embodiments 1-8, wherein the first catalyst comprises a nucleophilic catalyst.

Embodiment 10 provides the composition of any one of embodiments 1-9, wherein an amount of the first catalyst ranges from about 0.1 mol % to about 20 mol % with respect to a total amount of the first monomer and the second monomer.

Embodiment 11 provides the composition of any one of embodiments 1-10, further comprises a second catalyst catalyzing a reaction between the at least one thiol group of the first monomer and the at least one alkene functional group of the second monomer that forms a thioether linkage.

Embodiment 12 provides the composition of embodiment 11, wherein the second catalyst comprises a radical initiator.

Embodiment 13 provides the composition of any one of embodiments 11-12, wherein the second catalyst comprises a photo initiator.

Embodiment 14 provides the composition of embodiment 13, wherein the photo initiator is at least one selected from the group consisting of: acetophenone, benzophenone, 2-phenylacetophenone, 2,2-dimethoxy-2-phenylacetophenone, Bis(2,4,6-trimethylbenzoyl)-phenylphosphine oxide, 2-Hydroxy-4′-(2-hydroxyethoxy)-2-methylpropiophenone, 2-methyl-(4-methylthienyl)-2-morpholinyl-1 -propan- 1 -one, Diphenyl(2,4,6-trimethylbenzoyl)phosphine oxide, Ethyl (2,4,6-trimethylbenzoyl) phenyl phosphinate, lithium phenyl-2,4,6-trimethylbenzoylphosphinate.

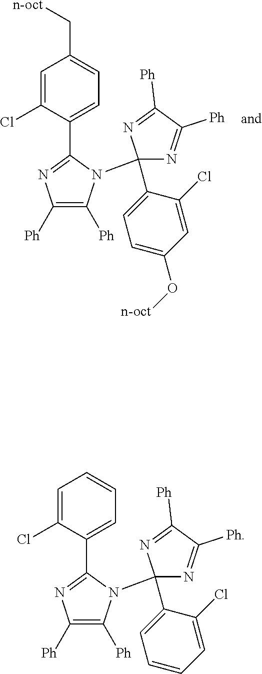

Embodiment 15 provides the composition of any one of embodiments 11-14, wherein an amount of the second catalyst ranges from about 0.01 wt % to about 1 wt % with respect to a total amount of the first monomer and the second monomer.

Embodiment 16 provides the composition of any one of embodiments 1-15, further comprises a radical inhibitor that inhibits a radical in the composition.

Embodiment 17 provides the composition of embodiment 16, wherein an amount of the radical inhibitor ranges from about 0.005 wt % to about 0.5 wt % with respect to a total amount of the first monomer and the second monomer.

Embodiment 18 provides the composition of any one of embodiments 16-17, wherein a weight ratio between the second catalyst and the radical inhibitor ranges from 1:1 to 100:1.

Embodiment 19 provides the composition of any one of embodiments 1-18, wherein a viscosity of the composition is from about 1.5 to about 50 mPa s.

Embodiment 20 provides the composition of any one of embodiments 1-19, further comprising a third monomer, wherein the third monomer represented by Formula (III):

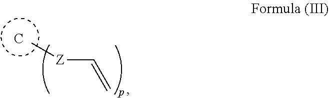

wherein
   [symbol] is C₃₋₂₀ alkyl, C₃₋₂₀ heteroalkyl, C₃₋₂₀ cycloalkyl, C₃₋₂₀ heterocycloalkyl, C₆₋₁₄ aryl, or combinations thereof, each of which is optionally substituted by 1 to 5 groups independently selected from the group consisting of F, Cl, Br, I, OR, OC(O)N(R)₂, CN, NO₂, CF₃, OCF₃, R, N(R)₂, SR, SOR, SO₂R, SO₂N(R)₂, SO₃R, C(O)R, C(O)C(O)R, C(O)CH₂C(O)R, C(O)OR, OC(O)R, C(O)N(R)₂, OC(O)N(R)₂, (CH₂)₀₋₂N(R)C(O)R, (CH₂)₁₋₂COOR, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(O)N(R)₂, N(COR)COR, N(OR)R, C(═NH)N(R)₂, C(O)N(OR)R, and C(═NOR)R;
   each occurrence of R is independently hydrogen, C₁-C₁₀ alkyl, or C₆₋₁₀ aryl;
   Z is a bond, CH₂, or —C(═O)—O*, wherein the O* is attached to the vinyl group; and
   p is an integer ranging from 2 to 10.

Embodiment 21 provides the composition of embodiment 20, wherein, except for the alkene group, the third monomer does not comprise a functional group substantially reactive with the thiol group of the first monomer.

Embodiment 22 provides the composition of any one of embodiments 20-21, wherein the third compound comprises a diallyl compound.

Embodiment 23 provides the composition of any one of embodiments 20-22, wherein the third monomer is at least one selected from the group consisting of:

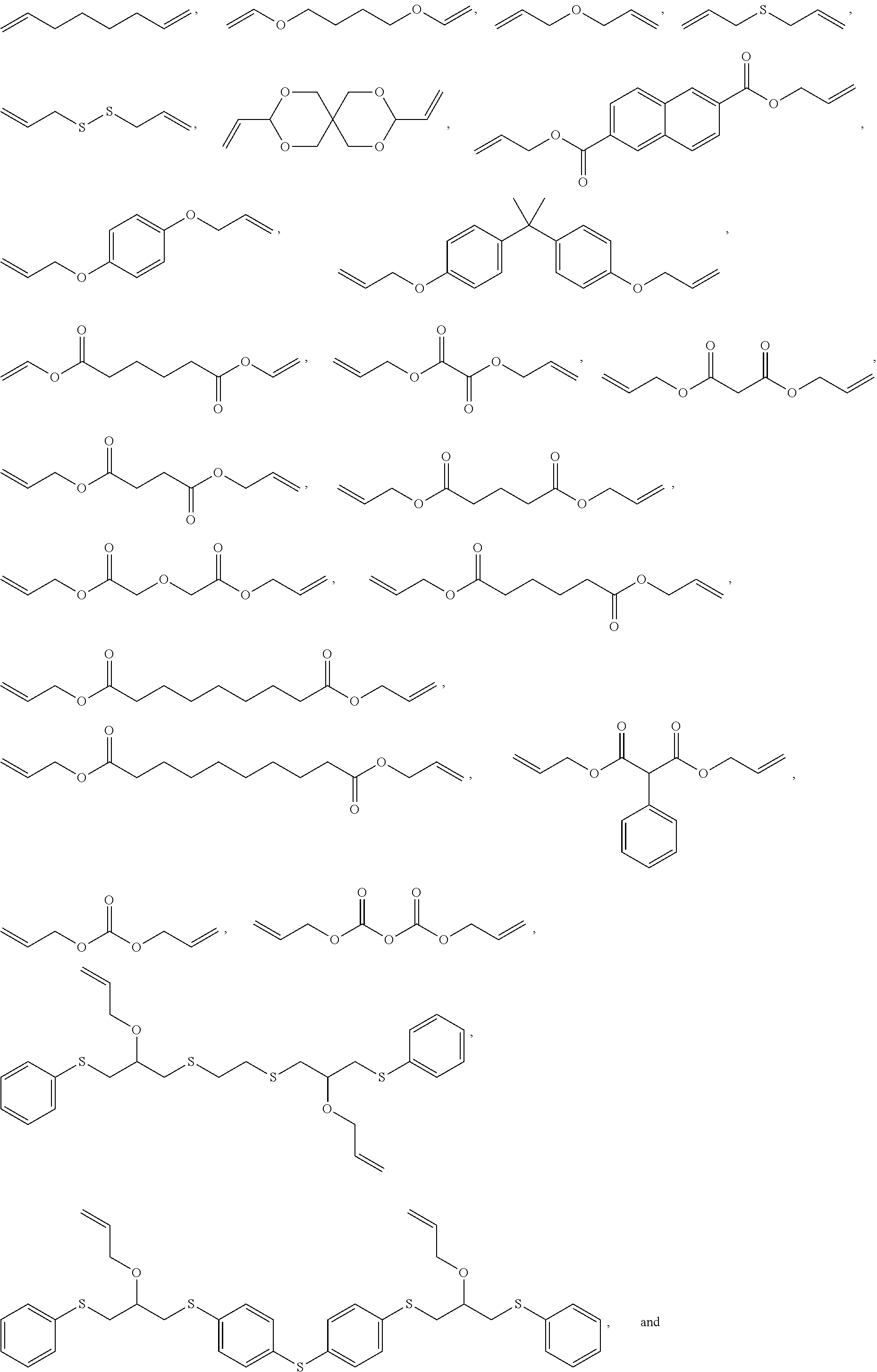

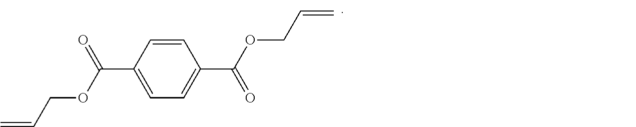 [SMILES: C=CCOC(=O)c1ccc(C(=O)OCC=C)cc1]

Embodiment 24 provides the composition of any one of embodiments 20-23, wherein an amount of the third monomer ranges from about 10 mol % to about 200 mol % with respect to a total amount of the first monomer and the second monomer.

Embodiment 25 provides the composition of any one of embodiments 1-24, further comprises a filler.

Embodiment 26 provides a method of producing a polymer, the method comprising: providing the composition of any one of embodiments 1-25; and curing the composition.

Embodiment 27 provides the method of embodiment 26, wherein curing the composition comprises forming at least one thioether linkage between the at least one thiol group of the first monomer and the at least one alkene functional group of the second monomer.

Embodiment 28 provides the method of any one of embodiments 26-27, wherein curing the composition comprises subjecting the composition to a UV irradiation or a visible light irradiation.

Embodiment 29 provides the methods of any one of embodiment 26-28, wherein curing the composition comprises exposing the composition to a light having wavelength ranging from about 350 nm to about 410 nm.

Embodiment 30 provides the method of any one of embodiments 26-29, wherein curing the composition comprises exposing the composition to a light having an intensity ranging from about 0.1 mW/cm² to about 5 mW/cm².

Embodiment 31 provides the method of any one of embodiments 26-30, wherein curing the composition comprises a 3D printing process.

Embodiment 32 provides the method of embodiment 31, wherein the 3D printing process comprises a stereolithography.

Embodiment 33 provides the method of any one of embodiments 31-32, wherein the 3D printing process comprises a masked stereo-lithography (MSLA).

Embodiment 34: A method of fabricating a polymer object, comprising producing a polymer to a first shape according to the method of any one of embodiments 26-33.

Embodiment 35 provides the method of embodiment 34, further comprising: heating the polymer to 60° C. or higher; and reshape the object to a second shape.

Embodiment 36 provides the method of embodiments 34-35, further comprising subject the object to an acid treatment to fix the shape of the object.

Embodiment 37 provides a polymer formed by the method of any one of embodiments 26-36.

Embodiment 37 provides a method of degrading the polymer or the polymer object of embodiment 36, comprising dissolving the polymer or the polymer object in a solution comprising: a free thiol compound; and a base catalyst.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A composition, comprising:
a first monomer of Formula (I): 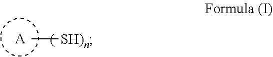
and
a second monomer of Formula (II) selected from the group consisting of: 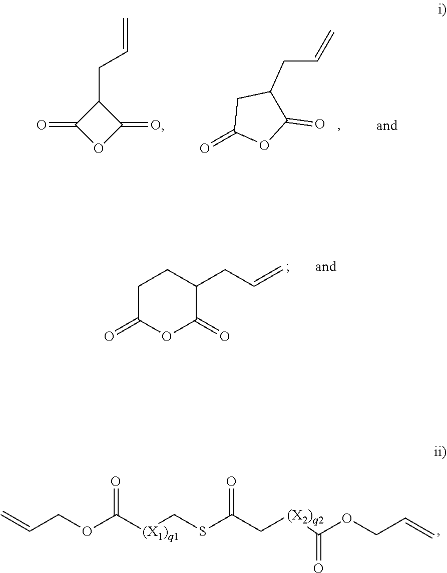
wherein: [symbol]
is C₃₋₂₀ alkyl, C₃₋₂₀ heteroalkyl, C₃₋₂₀ cycloalkyl, C₆₋₁₄ aryl, or combinations thereof, each of which is optionally substituted by 1 to 5 groups independently selected from the group consisting of F, Cl, Br, I, OR, OC(O)N(R)₂, CN, NO₂, CF₃, OCF₃, R, N(R)₂, SR, SOR, SO₂R, SO₂N(R)₂, and SO₃R, wherein each occurrence of R is independently hydrogen, C₁-C₁₀ alkyl, or C₆₋₁₀ aryl,
n is an integer ranging from 2 to 6;
X₁ is independently at each occurrence —CH₂—, —O—, —OCH₂CH₂—, or —CH₂CH₂O—;
X₂ is independently at each occurrence —CH₂—, —O—, —OCH₂CH₂—, or —CH₂CH₂O—;
q1 is an integer from 1 to 20; and
q2 is an integer from 1 to 20.

2. (canceled)

3. (canceled)

4. The composition of claim 1, wherein the composition has a molar ratio between the first monomer and the second monomer of about 1:5 to about 5:1.

5. (canceled)

6. The composition of claim 1, wherein the first monomer is at least one selected from the group consisting of: 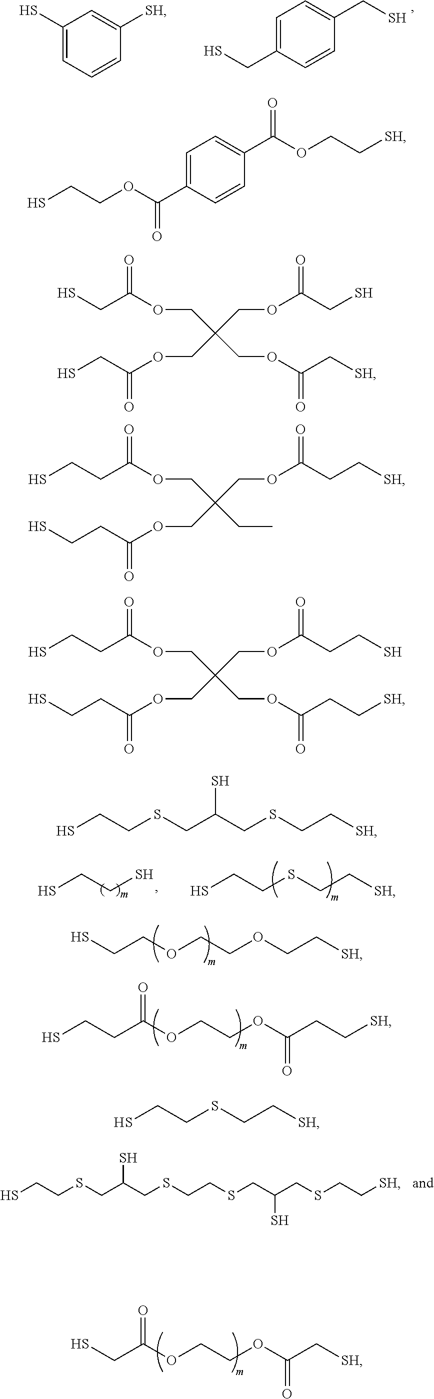
wherein m is an integer from 1 to 20.

7. The composition of claim 1, wherein the second monomer is

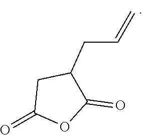

8. The composition of claim 1, wherein at least one of the following applies:
i) the composition further comprises about 0.1 mol % to about 20 mol %, with respect to a total amount of the first monomer and the second monomer, of a first catalyst, wherein the first catalyst is a nucleophilic catalyst;
ii) the composition further comprises about 0.01 wt % to about 1 wt %, with respect to a total amount of the first monomer and the second monomer, of a second catalyst, wherein the second catalyst is a radical initiator or a photoinitiator;
iii) the composition further comprises about 0.005 wt % to about 0.5 wt %, with respect to a total amount of the first monomer and the second monomer, of a radical inhibitor;
iv) the second catalyst and the radical inhibitor have a weight ratio of 1:1 to 100:1; and
v) the composition has a viscosity of about 1.5 to about 50 mPa.

9-19. (canceled)

20. The composition of claim 1, further comprising a third monomer of Formula (III): 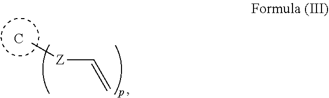
wherein: [symbol]
is C₃₋₂₀ alkyl, C₃₋₂₀ heteroalkyl, C₃₋₂₀ cycloalkyl, C₃₋₂₀ heterocycloalkyl, C₆₋₁₄ aryl, or combinations thereof, each of which is optionally substituted by 1 to 5 groups independently selected from the group consisting of F, Cl, Br, I, OR, OC(O)N(R)₂, CN, NO₂, CF₃, OCF₃, R, N(R)₂, SR, SOR, SO₂R, SO₂N(R)₂, SO₃R, C(O)R, C(O)C(O)R, C(O)CH₂C(O)R, C(O)OR, OC(O)R, C(O)N(R)₂, OC(O)N(R)₂, (CH₂)₀₋₂N(R)C(O)R, (CH₂)₁₋₂COOR, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(O)N(R)₂, N(COR)COR, N(OR)R, C(═NH)N(R)₂, C(O)N(OR)R, and C(═NOR)R;
each occurrence of R is independently hydrogen, C₁-C₁₀ alkyl, or C₆₋₁₀ aryl;
Z is a bond, CH₂, or —C(═O)—O*, wherein the O* is attached to the vinyl group; and
p is an integer ranging from 2 to 10.

21. (canceled)

22. The composition of claim 20, wherein the third compound comprises a diallyl compound.

23. The composition of claim 20, wherein the third monomer is at least one selected from the group consisting of:

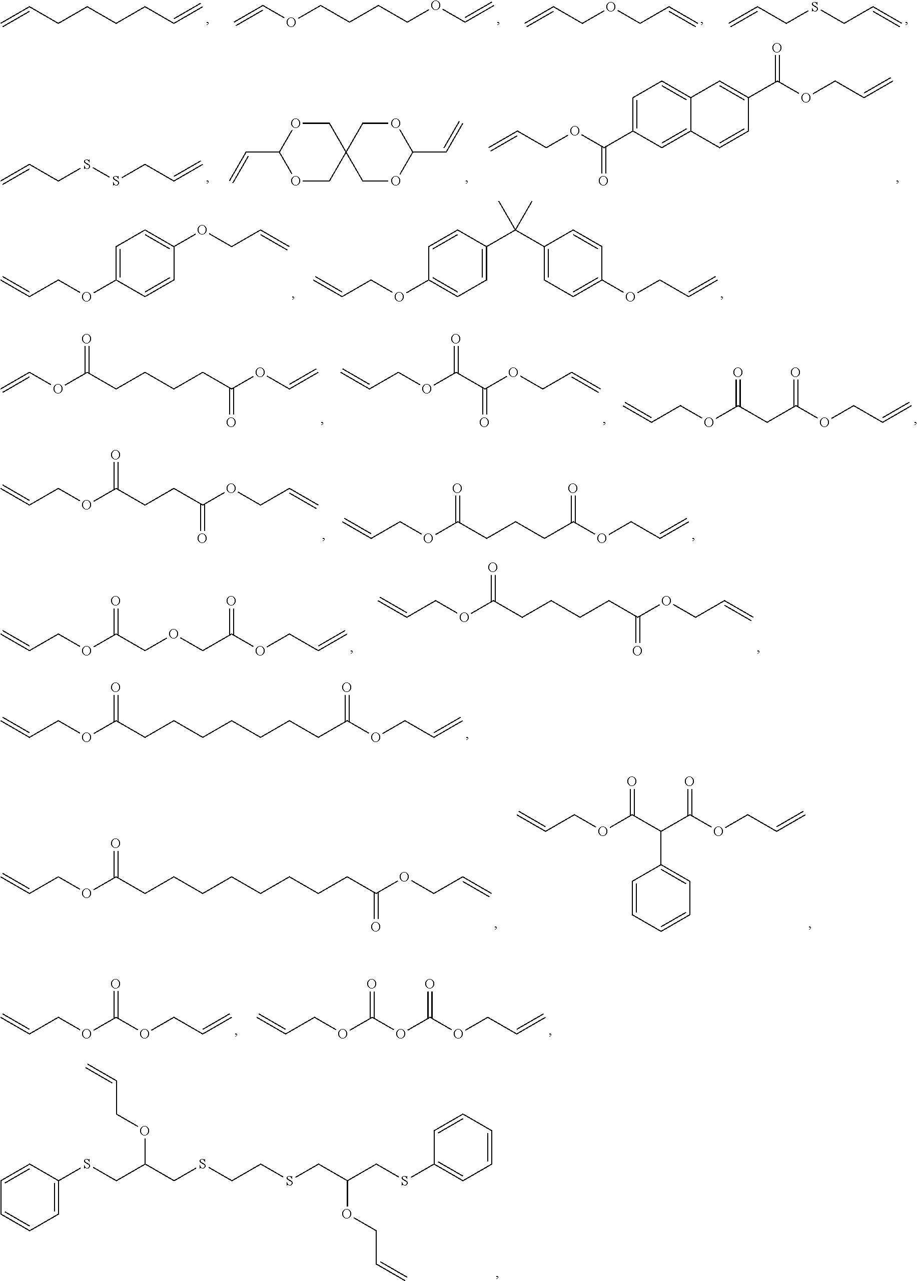

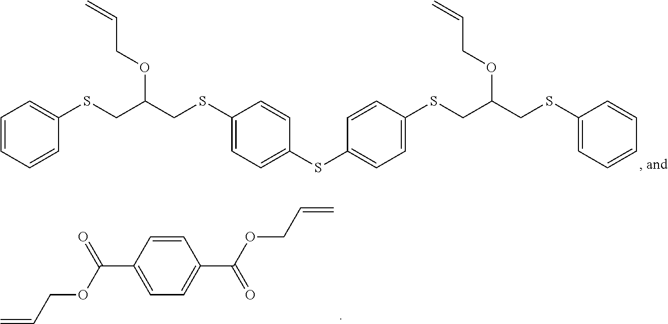

24. The composition of claim 20, wherein an amount of the third monomer ranges from about 10 mol % to about 200 mol % with respect to a total amount of the first monomer and the second monomer.

25. The composition of claim 1, further comprising a filler.

26. A method of producing a polymer, the method comprising:
providing a polymerizable composition comprising:
a first monomer of Formula (I): 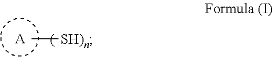
a second monomer of Formula (II) selected from the group consisting of: 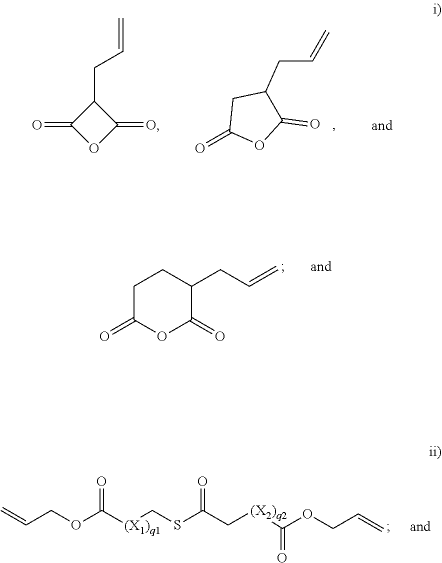
optionally a third monomer of Formula (III): 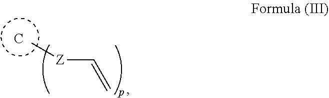
wherein: [symbol]
is C₃₋₂₀ alkyl, C₃₋₂₀ heteroalkyl, C₃₋₂₀ cycloalkyl, C₆₋₁₄ aryl, or combinations thereof, each of which is optionally substituted by 1 to 5 groups independently selected from the group consisting of F, Cl, Br, I, OR, OC(O)N(R)₂, CN, NO₂, CF₃, OCF₃, R, N(R)₂, SR, SOR, SO₂R, SO₂N(R)₂, and SO₃R, wherein each occurrence of R is independently hydrogen, C₁-C₁₀ alkyl, or C₆₋₁₀ aryl; [symbol]
is C₃₋₂₀ alkyl, C₃₋₂₀ heteroalkyl, C₃₋₂₀ cycloalkyl, C₃₋₂₀ heterocycloalkyl, C₆₋₁₄ aryl, or combinations thereof, each of which is optionally substituted by 1 to 5 groups independently selected from the group consisting of F, Cl, Br, I, OR, OC(O)N(R)₂, CN, NO₂, CF₃, OCF₃, R, N(R)₂, SR, SOR, SO₂R, SO₂N(R)₂, SO₃R, C(O)R, C(O)C(O)R, C(O)CH₂C(O)R, C(O)OR, OC(O)R, C(O)N(R)₂, OC(O)N(R)₂, (CH₂)₀₋₂N(R)C(O)R, (CH₂)₁₋₂COOR, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(O)N(R), N(COR)COR, N(OR)R, C(═NH)N(R)₂, C(O)N(OR)R, and C(═NOR)R,
each occurrence of R is independently hydrogen, C₁-C₁₀ alkyl, or C₆₋₁₀ aryl;
Z is a bond, CH₂, or —C(═O)—O*, wherein the O* is attached to the vinyl group;
p is an integer ranging from 2 to 10;
n is an integer ranging from 2 to 6;
X₁ is independently at each occurrence —CH₂—, —O—, —OCH₂CH₂—, or —CH₂CH₂O—;
X₂ is independently at each occurrence —CH₂—, —O—, —OCH₂CH₂—, or —CH₂CH₂O—;
q1 is an integer from 1 to 20;
q2 is an integer from 1 to 20; and
curing the composition to provide the polymer.

27. (canceled)

28. The method of claim 26, wherein curing the composition comprises subjecting the composition to a UV irradiation or a visible light irradiation.

29. (canceled)

30. The method of claim 26, wherein the curing comprises exposing the composition to a light having an intensity of about 0.1 mW/cm² to about 5 mW/cm².

31. The method of claim 26, wherein curing the composition comprises a 3D printing process.

32. The method of claim 31, wherein the 3D printing process comprises a stereolithography.

33. The method of claim 31, wherein the 3D printing process comprises a masked stereo-lithography (MSLA).

34. The method of claim 26, wherein the polymer is a cured polymer object having a first shape.

35. The method of claim 34, further comprising:
heating the polymer object to at least 60° C.; and
reshaping the polymer object into a second shape.

36. The method of claim 34, further comprising subjecting the polymer object to an acid treatment to fix the shape of the object.

37-38. (canceled)

39. The method of claim 26, wherein at least one of the following applies:
i) the polymerizable composition further comprises about 0.1 mol % to about 20 mol %, with respect to a total amount of the first monomer and the second monomer, of a first catalyst, wherein the first catalyst is a nucleophilic catalyst;
ii) the polymerizable composition further comprises about 0.01 wt % to about 1 wt %, with respect to a total amount of the first monomer and the second monomer, of a second catalyst, wherein the second catalyst is a radical initiator or a photoinitiator;
iii) the polymerizable composition further comprises about 0.005 wt % to about 0.5 wt %, with respect to a total amount of the first monomer and the second monomer, of a radical inhibitor;
iv) the second catalyst and the radical inhibitor have a weight ratio of 1:1 to 100:1; and
v) the polymerizable composition has a viscosity of about 1.5 to about 50 mPa s.
